(19) United States
(12) Patent Application Publication
(10) Pub. No.: US 2008/0211825 A1
(43) Pub. Date: Sep. 4, 2008

(54) DISPLAY CONTROL APPARATUS, DISPLAY APPARATUS, DISPLAY CONTROL METHOD, AND DISPLAY PROCESSING METHOD

(75) Inventors: Shinichi SUNAKAWA, Kawasaki-shi (JP); Akihiro TAKAMURA, Fuchu-shi (JP)

Correspondence Address: MORGAN & FINNEGAN, L.L.P., 3 WORLD FINANCIAL CENTER, NEW YORK, NY, 10281-2101, US

(73) Assignee: CANON KABUSHIKI KAISHA, Tokyo (JP)

(21) Appl. No.: 11/870,732

(22) Filed: Oct. 11, 2007

(30) Foreign Application Priority Data
Oct. 12, 2006 (JP) 2006-279196
Oct. 12, 2006 (JP) 2006-279197
Oct. 12, 2006 (JP) 2006-279198

(51) Int. Cl. G09G 5/00

(52) U.S. Cl. 345/581

(57) ABSTRACT

A display control apparatus comprising a division unit configured to divide image data into a plurality of image data, a position information generation unit configured to generate position identification information required to identify positions of the plurality of image data divided by said division unit; and an image data transmission unit configured to transmit, in association with each other, the image data divided by said division unit and the position identification information generated by said position information generation unit for the image data to each of a plurality of display apparatuses configuring a single display screen.

### BACKGROUND OF THE INVENTION

1. Field of the Invention

The present invention relates to a display control apparatus, display apparatus, display control method, and display processing method and, more particularly, to a technique suited to perform one-screen display by combining a plurality of display apparatuses.

2. Description of the Related Art

A commercial multi-screen display apparatus is known as a display system which configures a large screen by combining a plurality of display units, and displays an image on that large screen. This commercial multi-screen display apparatus is implemented for the purpose of an ultra-large screen display apparatus or the like, which is placed on the rooftop of a building, and displays various moving images such as corporate advertisements and the like. A method of configuring the large screen is roughly classified into a method of directly laying pixels and a method of combining a plurality of display units.

The method of combining a plurality of display units will be further explained.

A display panel is configured by stacking a plurality of display units of various systems such as a projector, CRT (Cathode Ray Tube), and the like adjacent to each other. Video content data is divided into images for display assigned to regions of the respective display units after rasterization. In this way, display data for each display unit is generated. The display data is generated in each display unit or by providing a multi-display server.

A case will be explained below wherein the multi-display server generates display data. The multi-display server is connected to a video content supply device, and also to the plurality of display units. The video content data input from the supply device is rasterized in the multi-display server and then divided into images for respective display units, which are transferred to the corresponding display units. The display units display the received data intact to attain display on an ultra-large screen.

The following related arts which generate display data using the multi-display server and display images based on the display data using a plurality of display units are available.

(1) A technique described in Japanese Patent Laid-Open No. 8-328519 is available. With this technique, the multi-display server converts the resolution of image data to obtain the number of pixels that can be displayed on the display units, and the image data which is enlarged in scale by the resolution conversion is clipped in accordance with the plurality of display units that form a multi-display. The multi-display server sends the clipped image data to the corresponding display units. The respective display units display the image data sent from the multi-display server.

(2) A technique described in Japanese Patent Laid-Open No. 2003-316340 is available. With this technique, the multi-display server outputs image data corresponding to the respective display units by appending IDs to the image data. Each display unit fetches image data with its own ID into a frame memory, and displays the fetched image data.

Next, a case will be described below wherein each display unit generates display data. Each display unit inputs video content data, and clips the input data in accordance with its display assigned region. After that, the display unit applies processing such as enlargement/reduction or the like to the clipped data in correspondence with the resolution of the display panel, and then displays the processed data. Note that various configurations such as a configuration in which a server rasterizes compressed data, a configuration in which a server generates and issues control processing commands, and the like have been proposed as a configuration in which each display unit generates display data.

The following techniques that implement a multi-display by generating display data on the side of the display units are available.

(3) A technique described in Japanese Patent Laid-Open No. 2003-280623 is available. With this technique, the multi-display server sends control signals for image data processing including image display region setting data and display image scaling processing data to the respective display units. Each display unit generates its own image data to be displayed by applying the control signal received from the multi-display server.

(4) A technique described in Japanese Patent Laid-Open No. 2001-350458 is available. With this technique, a multi-display server sends image data and display range information to the respective display units. Each display unit clips image data to be included in a display region of its own frame and a neighboring region with reference to the display range information, and displays the clipped image data after it has been converted into a coordinate system of its own frame.

(5) A technique described in Japanese Patent Laid-Open No. 2000-330534 is available. With this technique, each display unit receives a control command for making the display unit display an image at an arbitrary position from a multi-display server, and sequentially executes a series of a plurality of control operations specified by the received control command.

(6) Furthermore, a technique described in Japanese Patent Laid-Open No. 2000-132370 is available. With this technique, each display unit updates only the frame of the display unit that matches an identification ID by identifying a specific identification ID issued from a multi-display server. Note that the multi-display server transmits rendering command packets in place of image information itself after the identification ID used to identify each display unit.

However, with these related arts, large-scale hardware resources are required to attain a large-screen display.

Related arts (1) and (2) require the server to have very high processing capability. The server executes rasterization of data-rendering-image processing-layout-division-transmission. The load on the server becomes heavier as the content has higher image quality and resolution.

With related arts (3) to (6), the load on the server is reduced. However, each display unit requires large-scale hardware resources. Each display unit must receive large-capacity rendering commands to clip an image for display in its own assigned region. For this purpose, each display unit must have a large-capacity buffer memory. Furthermore, if each display unit rasterizes display data in a compressed format, it must comprise a decoder. Moreover, each display unit must also render graphic data which need not apparently be rendered. Therefore, the processing speed upon displaying an image on a large screen drops, and large-scale hardware resources are required to prevent the drop of the processing speed upon displaying an image on a large screen.

### SUMMARY OF THE INVENTION

The present invention provides a technique that can reduce hardware resources required to display an image on a large screen configured using a plurality of display apparatuses.

According to one aspect of the present invention, there is provided a display control apparatus comprising a division unit configured to divide image data into a plurality of image data, a position information generation unit configured to generate position identification information required to identify positions of the plurality of image data divided by the division unit, and an image data transmission unit configured to transmit, in association with each other, the image data divided by the division unit and the position identification information generated by the position information generation unit for the image data to each of a plurality of display apparatuses configuring a single display screen.

According to another aspect of the present invention, there is provided a display apparatus comprising a storage unit configured to store an assigned display region of image data for one frame in a storage medium, an image data input unit configured to input a part of the image data for one frame and position identification information required to identify a position of the part of the image data for one frame from a display control apparatus, a position determination unit configured to determine, based on the position identification information input by the image data input unit, whether or not the part of the image data for one frame input by the image data input unit is included in the assigned display region stored by the storage unit, an image data acceptance unit configured to accept, when the position determination unit determines that the part of the image data for one frame input by the image data input unit is included in the assigned display region stored by the storage unit, the part of the image data for one frame input by the image data input unit, and a display unit configured to display an image of the assigned display region using the part of the image data for one frame accepted by the image data acceptance unit.

According to still another aspect of the present invention, there is provided a display control method comprising the steps of dividing image data into a plurality of image data, generating position identification information required to identify positions of the plurality of image data divided in the dividing step, and transmitting, in association with each other, the image data divided in the dividing step and the position identification information generated in the position identification information generating step for the image data to each of a plurality of display apparatuses configuring a single display screen.

According to yet another aspect of the present invention, there is provided a display processing method comprising the steps of storing an assigned display region of image data for one frame in a storage medium, inputting a part of the image data for one frame and position identification information required to identify a position of the part of the image data for one frame from a display control apparatus, determining, based on the position identification information input in the image data inputting step, whether or not the part of the image data for one frame input in the image data inputting step is included in the assigned display region stored in the storing step, accepting, when it is determined in the position determining step that the part of the image data for one frame input in the image data inputting step is included in the assigned display region stored in the storing step, the part of the image data for one frame input in the image data inputting step, and displaying an image of the assigned display region using the part of the image data for one frame accepted in the image data accepting step.

Further features of the present invention will become apparent from the following description of exemplary embodiments with reference to the attached drawings.

### BRIEF DESCRIPTION OF THE DRAWINGS

FIG. 1 is a schematic block diagram showing an example of the overall arrangement of a multi-display system according to the first embodiment of the present invention.

FIGS. 2A and 2B show a display example in the multi-display system (display units) according to the first embodiment of the present invention.

FIGS. 3A and 3B are views for explaining an example of a method of dividing image content data into small rectangular tile regions according to the first embodiment of the present invention.

FIGS. 4A to 4C show an example of the configuration of an image data packet according to the first embodiment of the present invention.

FIGS. 5A and 5B are block diagrams showing an example of the detailed arrangement of the multi-display system according to the first embodiment of the present invention.

FIG. 6 is a flowchart for explaining an example of the operation of a multi-display server according to the first embodiment of the present invention.

FIG. 7 is a flowchart for explaining an example of the operation of a display unit according to the first embodiment of the present invention.

FIGS. 8A to 8C show a display example in a multi-display system (display units) according to the second embodiment of the present invention.

FIGS. 9A and 9B are block diagrams showing an example of the detailed arrangement of the multi-display system according to the second embodiment of the present invention.

FIGS. 10A to 10D show a display example of a multi-display system (display units) according to the third embodiment of the present invention.

FIGS. 11A to 11E show an example of the configuration of a multi-display packet according to the third embodiment of the present invention.

FIGS. 12A and 12B are block diagrams showing an example of the detailed arrangement of the multi-display system according to the third embodiment of the present invention.

FIGS. 13A and 13B show a display example in a multi-display system (display units) according to the fourth embodiment of the present invention.

FIGS. 14A and 14B are views for explaining an example of a method of dividing image content data into small rectangular tile regions according to the fourth embodiment of the present invention.

FIGS. 15A to 15C show an example of the configuration of an image data packet according to the fourth embodiment of the present invention.

FIGS. 16A and 16B are block diagrams showing an example of the detailed arrangement of the multi-display server according to the fourth embodiment of the present invention.

FIG. 17 is a flowchart for explaining an example of the operation of a multi-display server according to the fourth embodiment of the present invention.

FIG. 18A is a flowchart for explaining an example of a display unit according to the fourth embodiment of the present invention.

FIG. 18B is a flowchart continued from FIG. 18A according to the fourth embodiment of the present invention.

FIGS. 19A to 19C show a display example in a multi-display system (display units) according to the fifth embodiment of the present invention.

FIGS. 20A and 20B are block diagrams showing an example of the detailed arrangement of the multi-display system according to the fifth embodiment of the present invention.

FIGS. 21A to 21D show a display example in a multi-display system (display units) according to the sixth embodiment of the present invention.

FIGS. 22A to 22E show an example of a multi-display packet according to the sixth embodiment of the present invention.

FIGS. 23A and 23B are block diagrams showing an example of the detailed arrangement of the multi-display system according to the sixth embodiment of the present invention.

FIG. 24 is a schematic block diagram showing an example of the overall arrangement of a multi-display system according to the seventh embodiment of the present invention.

FIGS. 25A and 25B show a display example in the multi-display system (display units) according to the seventh embodiment of the present invention.

FIGS. 26A to 26C show an example of the configuration of an image data packet according to the seventh embodiment of the present invention.

FIGS. 27A and 27B are block diagrams showing an example of the detailed arrangement of the multi-display system according to the seventh embodiment of the present invention.

FIG. 28 is a flowchart for explaining an example of the operation of a multi-display server according to the seventh embodiment of the present invention.

FIG. 29 is a flowchart for explaining an example of the operation of a display unit according to the seventh embodiment of the present invention.

FIGS. 30A to 30C show a display example in a multi-display system (display units) according to the eighth embodiment of the present invention.

FIGS. 31A and 31B are block diagrams showing an example of the detailed arrangement of the multi-display system according to the eighth embodiment of the present invention.

FIGS. 32A to 32D show a display example in a multi-display system (display units) according to the ninth embodiment of the present invention.

FIGS. 33A to 33E show an example of the configuration of a multi-display packet according to the ninth embodiment of the present invention.

FIGS. 34A and 34B are block diagrams showing an example of the detailed arrangement of the multi-display system according to the ninth embodiment of the present invention.

### DESCRIPTION OF THE EMBODIMENTS

### First Embodiment

The first embodiment of the present invention will be described in detail hereinafter with reference to the accompanying drawings.

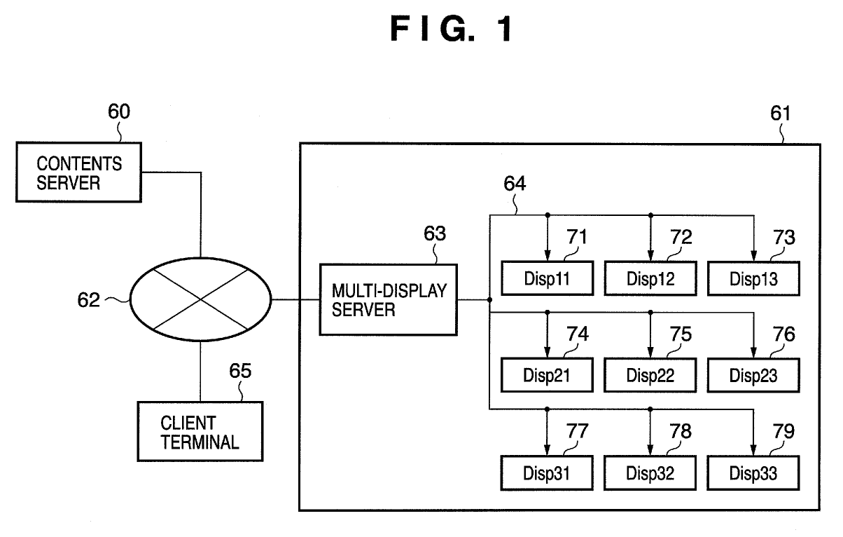

In this embodiment, a multi-display system includes a multi-display server which supplies image content data, and a plurality of display units which display the overall image content by all the units and each of which displays a part of the image content. The image content data is divided into a plurality of regions, and is supplied from the multi-display server to the display units in the form of packet data. Each display unit determines if packet data supplied from the multi-display server corresponds to its own assigned display region. The display unit accepts only packet data of the assigned display region, and reclaims and displays an image based on the accepted packet data. This embodiment will explain such a multi-display system.

<Description of Schematic Arrangement of Multi-Display System (FIG. 1)>

FIG. 1 is a schematic block diagram showing an example of the overall arrangement of the multi-display system.

Referring to FIG. 1, a multi-display system 61 inputs image content data from a contents server 60, and displays the input image content data. A display is made on a screen defined by combining display units (Displ1 to Disp33) 71 to 79 of 3 rows×3 columns.

The contents server 60 delivers image content data to the multi-display system 61 by streaming in response to a request from a client terminal 65. For example, the contents server 60 encodes the image content data to be delivered, so as to reduce a communication bandwidth. That is, original image content data is compressed by an encoding scheme such as MPEG2, H.264, or the like. The compressed image content data is converted into a transport stream of an MPEG2TS format or the like, and the transport stream is transmitted. Arbitrary encoding schemes and stream formats can be used.

The multi-display system 61 receives the image content data delivered from the contents server 60 by streaming, and displays an image based on the received image content data. A communication line 62 is used to transmit the image content data to be delivered by streaming. As the communication line 62, media of various schemes such as a network (e.g., the Internet or the like), device interface (IEEE1394 or the like), and so forth can be used.

In the multi-display system 61, a multi-display server 63 supplies the image content data to the respective display units 71 to 79. A communication path 64 is used to supply the image content data to the respective display units 71 to 79. The communication path 64 includes, for example, a LAN (Local Area Network), WAN (Wide Area Network), or a network such as the Internet or the like. Note that the communication path 64 and communication line 62 may be commonly used.

The display units 71 to 79 receive the image content data supplied from the multi-display server 63. At this time, each of the respective display units 71 to 79 accepts only data of a part that belongs to its own assigned display region. Each of the display units 71 to 79 displays a part of the image content based on the image content data that belongs to its own assigned display region. The display units 71 to 79 include display panels of various systems such as an LCD (Liquid Crystal Display), plasma display, or the like. Note that at least one of the display units 71 to 79 may include a display panel of a system different from the remaining display units. By increasing the display screen size of the display units 71 to 79 or increasing the number of display units to be combined, a display on a larger screen size can be attained.

Various methods of setting the assigned display regions of the display units 71 to 79 are available, and an arbitrary method may be used. As the simplest method, a method of explicitly setting these regions by the user is available. When the user operates switches and the like provided to the display units 71 to 79, the user can set the assigned display region of the display unit having the corresponding switch. Alternatively, for example, the client terminal 65 may transmit information used to instruct the assigned display regions of the display units 71 to 79 to the multi-display server 63, which may set the assigned display regions of the display units 71 to 79.

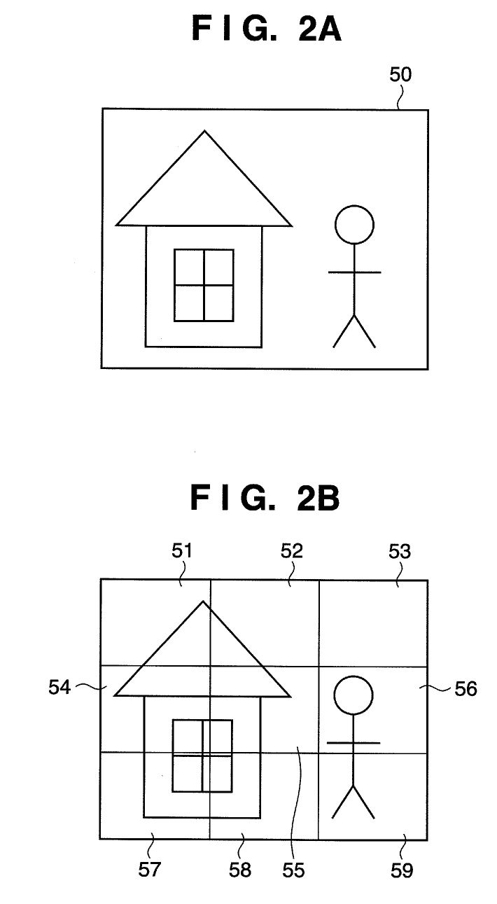

The display units 71 to 79 can be attached to a frame-like guide member. The user fits the display units 71 to 79 into a guide member which can support the display units 71 to 79 arranged in a 3×3 matrix (3 rows×3 columns). Furthermore, the user connects power cables and signal cables to these display units 71 to 79. In this way, the display units 71 to 79 configure a large screen. By assigning identifiers unique to the display units 71 to 79 according to their attached positions, identification of the display units 71 to 79 and specification of their positions can be made. Sensors may be provided to the coupled surfaces of the display units 71 to 79, and the positions of the display units 71 to 79 may be specified based on the detection results of the sensors. For example, sensors are provided in four directions (e.g., top surface, bottom surface, and two side surfaces) where the display units 71 to 79 can be coupled. After the display units 71 to 79 are coupled, they exchange IDs with coupled partners using the sensors. In this manner, by making up the IDs held by the display units 71 to 79, their positions can be specified.

<Display Example of Multi-Display System (FIGS. 2A and 2B)>

FIGS. 2A and 2B show a display example in the multi-display system 61 (display units 71 to 79).

FIG. 2A shows an example of an image content. In FIG. 2A, an image content 50 is configured by a house object and human object.

FIG. 2B shows a display example when the image content 50 is displayed using the display units 71 to 79. Display screens 51 to 59 are those of the display units 71 to 79, respectively. In FIG. 2B, by combining the nine display units 71 to 79, a single display screen of a 3×3 matrix (3 rows×3 columns) is configured.

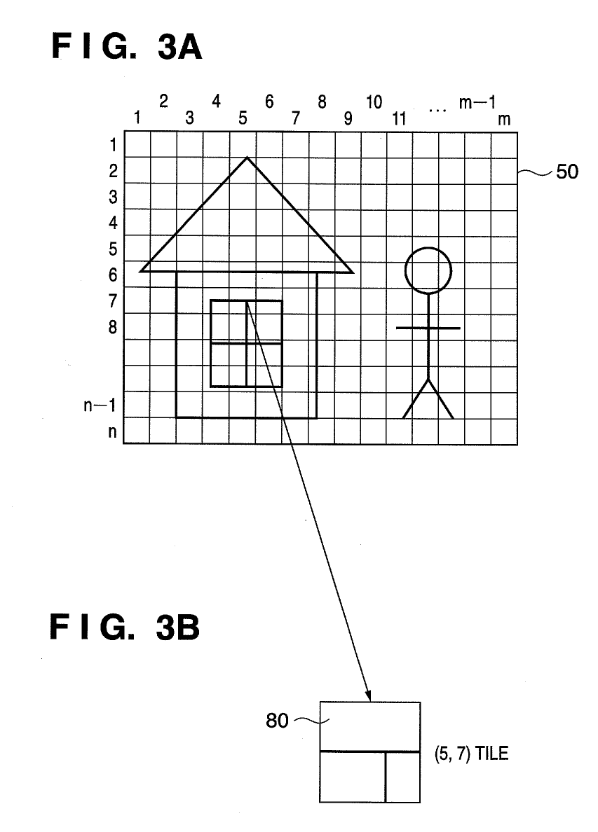

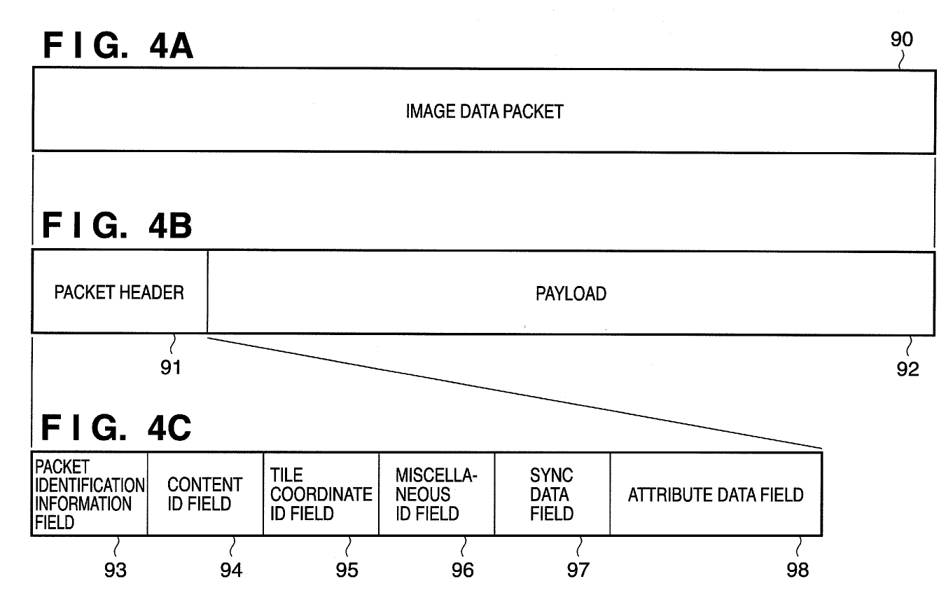

In this manner, FIG. 2B shows an example in which the image content 50 shown in FIG. 2A is displayed on the display screen configured by combining the nine display units 71 to 79. Each of the display units 71 to 79 displays a part of the original image content 50 according to its assigned display region. For example, the display unit 71 displays an image of an upper left part of a roof on the display screen 51, and the display unit 76 displays an image of an upper body part of a person on the display screen 56. Upon combining the display screens 51 to 59 of the display units 71 to 79, as shown in FIG. 2B, the entire original image content 50 can be displayed on one screen.

<Configuration of Image Data Packet (FIGS. 3A to 4C)>

The configuration of an image data packet used in transmission in the multi-display system 61 will be described below. In this embodiment, the image content data is divided into small rectangular tile regions. Each divided image content data is stored in an image data packet. Furthermore, the image data packet is appended with an ID indicating the coordinate position of each rectangular tile.

FIGS. 3A and 3B show an example of the method of dividing the image content data into small rectangular tile regions.

FIG. 3A shows an example of the state of the image content data divided into small rectangular tile regions.

Assume that m (m is a natural number)×n (n is a natural number) meshes are set on the image content 50 in the horizontal and vertical directions. Also, each mesh includes, for example, 16×16 pixels. By dividing the image content 50 along the boundaries of these meshes, m×n rectangular tile regions are generated. Each individual rectangular tile region is identified by a position coordinate ID indicating the position of the mesh of interest.

FIG. 3B shows an example of a part of the image content clipped into a rectangular tile shape. An image 80 of a rectangular tile shape is an image of a region clipped by a mesh located at coordinates (5, 7) of the image content 50. The position coordinate ID of this region is (5, 7).

FIGS. 4A to 4C show an example of the configuration of the image data packet.

FIG. 4A shows an image data packet 90. FIG. 4B shows the configuration of the image data packet 90. As shown in FIG. 4B, the image data packet 90 has a packet header 91 and payload 92. The payload 92 stores the image content data clipped into a rectangular tile shape.

FIG. 4C shows the configuration of the packet header 91. A packet identification information field 93 indicates the type of packet. The packet identification information field 93 stores ID information, which is required to identify whether or not the image data packet 90 of interest is used to make a display on the display units 71 to 79, version information, and the like, as described above. Furthermore, the packet identification information field 93 may also store information required for packet processing such as a packet length, check sum, and the like.

A content ID field 94 stores ID information required to identify an image content. A tile coordinate ID field 95 stores a position coordinate ID required to identify the position of a rectangular tile region. A miscellaneous ID field 96 stores miscellaneous IDs required to identify the rectangular tile region. For example, the miscellaneous ID field 96 stores a frame number and the like. A sync data field 97 stores various time stamps indicating time information such as the processing start time, processing end time, and the like of the image content identified by the ID information stored in the content ID field 94. An attribute data field 98 stores various kinds of attribute information required to process the image content data of the rectangular tile.

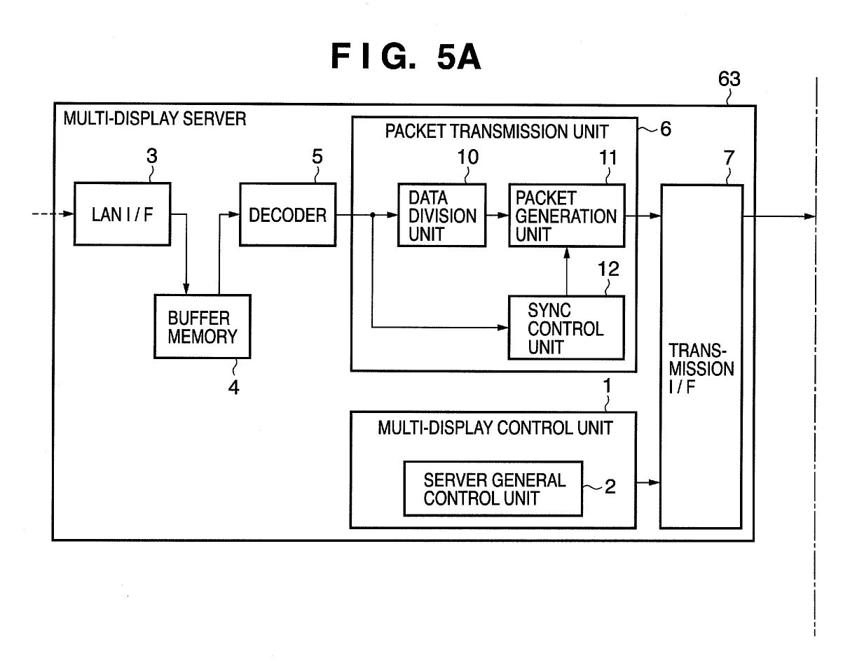

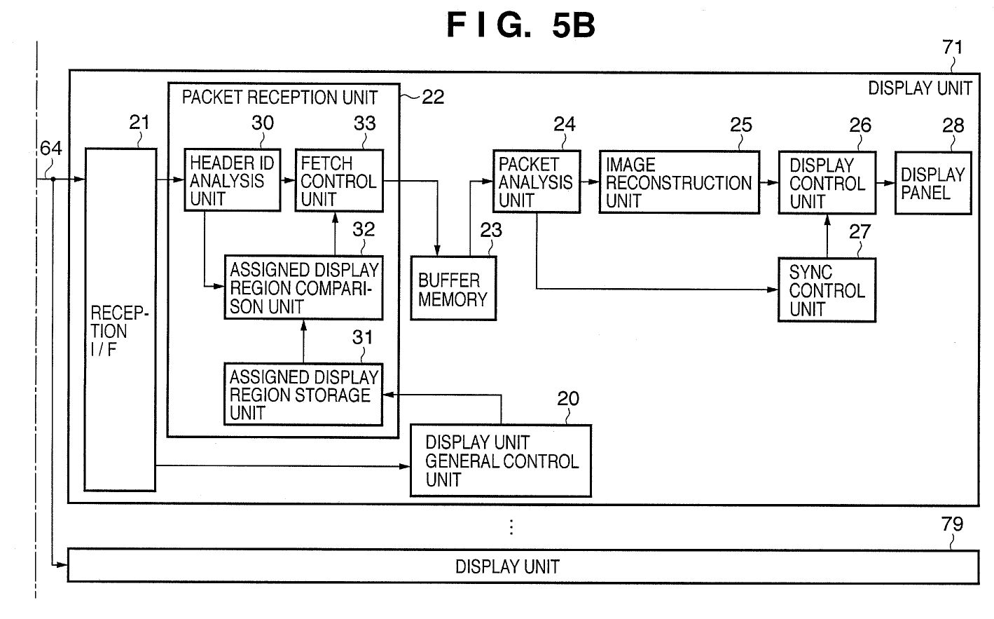

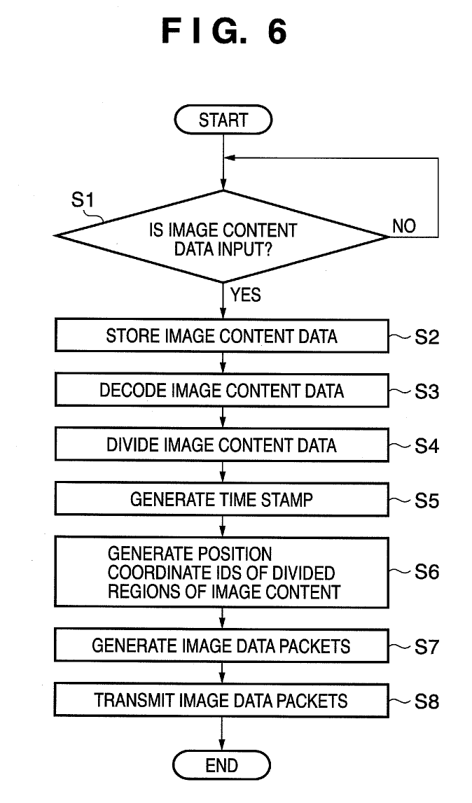

As will be described later, each of the display units 71 to 79 of this embodiment determines with reference to the tile coordinate ID field 95 if each image data packet 90 corresponds to its own assigned display region.

<Internal Arrangement and Operation of Multi-Display Server (FIGS. 5A and 6)>

FIGS. 5A and 5B are block diagrams showing an example of the detailed arrangement of the multi-display system 61. The arrangement of the multi-display server 63 will be described below with reference to FIG. 5A.

Referring to FIG. 5A, the multi-display server 63 decodes data received from the contents server 60, packetizes the decoded data to generate image data packets 90, and transmits these packets to the display units 71 to 79.

A multi-display control unit 1 controls the overall multi-display system 61. The multi-display control unit 1 includes a CPU, memories such as a ROM, RAM, and the like, a bus, various interfaces, and the like. The multi-display control unit 1 controls the overall system when the CPU executes programs stored in the ROM using the RAM and the like. A server general control unit 2 controls respective elements which form the multi-display server 63.

A LAN interface (LAN I/F) 3 inputs image content data from the contents server 60 via the communication line 62. A buffer memory 4 temporarily stores the image content data input from the LAN interface 3. As described above, the image content data transmitted from the contents server 60 is encoded. Hence, a decoder 5 decodes the encoded image content data to reclaim an original image content.

The decoder 5 reads out and decodes the image content data from the buffer memory 4, and outputs the data to the subsequent stage in turn from the decoded part. The decoder 5 supplies time stamp information appended to the image content data (included in a stream) to a sync control unit 12, and the image content data to a packet transmission unit 6.

The packet transmission unit 6 divides and packetizes the image content data to generate image data packets 90, and outputs these packets to a transmission interface (transmission I/F) 7. Details of the packet transmission unit 6 will be described later.

The transmission interface (transmission I/F) 7 transmits the image data packets 90 to the display units 71 to 79. The image data packets 90 are broadcast to the display units 71 to 79 which are connected to the multi-display server 63. The transmission interface 7 independently transmits various control data generated by the multi-display control unit 1 to the display units 71 to 79.

In the packet transmission unit 6, a data division unit 10 divides the image content data so that each divided data has a size (data amount) that can be processed by each of the display units 71 to 79 as destinations of the image content data. Note that the multi-display server 63 can acquire a size (data amount) that can be processed by each of the display units 71 to 79 by, for example, making communications with the display units 71 to 79. In addition, the multi-display server 63 can acquire a size (data amount) that can be processed by each of the display units 71 to 79 from, for example, the contents server 60, client terminal 65, or the like.

In this embodiment, the data division unit 10 divides the image content data into a plurality of rectangular tile regions, so that each divided data has a predetermined data size. More specifically, the data division unit 10 divides the image content data into rectangular tiles, as shown in, for example, FIG. 3A. The sync control unit 12 generates internal sync control data based on time stamp information appended to the original image content data. This sync control data includes time information such as transmission times to the display units 71 to 79, processing start times of the display units 71 to 79, display times of the display units 71 to 79, and the like. The sync control data generated by the sync control unit 12 is stored as time stamps in the sync data field 97 shown in FIG. 4C. Note that the sync control data is not limited to the aforementioned one, and any other kinds of information may be used as the sync control data as long as it is time information that can specify the processing start timings, display timings, and the like in the display units 71 to 79.

A packet generation unit 11 generates an image data packet 90 with the structure shown in FIGS. 4A to 4C. More specifically, the packet generation unit 11 generates a packet by appending the packet header 91 to the image content data of each rectangular tile. The packet header 91 stores the position coordinate ID of the rectangular tile region, time stamps, and the like.

With the aforementioned arrangement of the multi-display server 63, the original image content data received from the contents server 60 is packetized to generate image data packets 90, which can be transmitted to the display units 71 to 79.

An example of the operation of the multi-display server 63 will be described below with reference to the flowchart of FIG. 6.

In step S1, the server general control unit 2 waits until the LAN interface 3 inputs image content data transmitted from the contents server 60. If the LAN interface 3 inputs the image content data, the process advances to step S2. After the process reaches step S2, the server general control unit 2 temporarily stores the image content data input to the LAN interface 3 in the buffer memory 4.

In step S3, the decoder 5 decodes the encoded image content data to reclaim an original image content.

In step S4, the data division unit 10 divides the image content data into a plurality of rectangular tiles.

In step S5, the sync control unit 12 generates time stamps for the respective image content data divided in step S4 based on the time stamp information appended to the original image content data.

In step S6, the packet generation unit 11 generates the position coordinate IDs of the respective image content data (i.e., the divided regions of the image content) divided in step S4.

In step S7, the packet generation unit 11 appends the header information generated in steps S5, S6, and the like to the respective image content data divided in step S4 to generate image data packets 90. As described above, each image content data divided in step S4 is stored in the payload 92. The time stamps generated in step S5 are stored in the sync data field 97. The position information ID generated in step S6 is stored in the tile coordinate ID field 95.

In step S8, the server general control unit 2 instructs the transmission interface 7 to transmit the image data packets 90 and the like generated in step S7. In this way, the image data packets 90 and the like are transmitted to the display units 71 to 79. Note that the control data generated by the server general control unit 2 is also transmitted from the transmission interface 7 to the display units 71 to 79, as described above.

<Internal Arrangement and Operation of Display Unit (FIGS. 5B and 7)>

The arrangement of each of the display units 71 to 79 will be described below with reference to FIG. 5B. Note that the display units 71 to 79 have the same arrangement. Hence, the arrangement of only the display unit 71 will be explained, and a description of the arrangement of the remaining display units 72 to 79 will not be given.

Referring to FIG. 5B, the display unit 71 determines if the image data packets 90 transmitted from the display server 63 correspond to its own assigned display region. The display unit 71 accepts (receives) only the image data packets 90 of its own assigned display region, and reclaims and displays a part of the image content.

A display unit general control unit 20 controls components which form the display unit 71. The display unit general control unit 20 includes, for example, a CPU, memories such as a ROM, RAM, and the like, various interfaces, and so forth. The display unit general control unit 20 controls the overall display unit 71 when the CPU executes programs recorded in the ROM using the RAM and the like.

A reception interface (reception I/F) 21 inputs the image data packets 90 transmitted from the multi-display server 63. The reception interface (reception I/F) 21 also inputs not only the image data packets 90 but also control data and the like generated by the multi-display control unit 1.

A packet reception unit 22 determines if the image data packets 90 correspond to its own assigned display region, and accepts (receives) only the image data packets 90 corresponding to its own assigned display region. Details of the packet reception unit 22 will be described later.

A buffer memory 23 temporarily stores the image data packet 90 received by the packet reception unit 22. A packet analysis unit 24 extracts the image content data (data in each payload 92) divided into rectangular tiles from the image data packets 90. The packet analysis unit 24 sorts processes for the image content data divided into rectangular tiles in accordance with information in each packet header 91.

An image reconstruction unit 25 reclaims a part of the original image content by combining the image content data divided into rectangular tiles.

A display control unit 26 performs drive control of a display panel 28. The display control unit 26 outputs the image content data divided into rectangular tiles to the display panel 28 in synchronism with, for example, drive signals such as a horizontal sync signal, vertical sync signal, data transfer clocks, and the like. Note that the image content data divided into rectangular tiles are stored in a memory such as a VRAM or the like (not shown), are read out in synchronism with the drive signal timings, and are output to the display panel 28.

A sync control unit 27 controls the display control unit 26 based on the time stamps stored in the sync data field 97 of each image data packet 90 so that a part corresponding to its own assigned display region of the image content is displayed at the designated time. The display panel 28 displays a part of the image content corresponding to its own assigned display region. As the display panel 28, as described above, for example, a display device of an arbitrary system such as an LCD, plasma display, projection type display, and the like may be used.

The arrangement of the packet reception unit 22 will be described in detail below. As described above, the packet reception unit 22 determines if the image data packets 90 correspond to its own assigned display region, and accepts (receives) only the image data packets 90 corresponding to the assigned display region based on the determining result.

An assigned display region storage unit 31 stores the coordinate ID range of rectangular tiles so as to identify its own assigned display region. The assigned display region can be set by an arbitrary method, as described above.

A header ID analysis unit 30 extracts ID information of the packet header 91 from each incoming image data packet 90. The header ID analysis unit 30 confirms (verifies) the ID information stored in the packet identification information field 93 and that stored in the content ID field 94, and then extracts the position coordinate ID stored in the tile coordinate ID field 95.

An assigned display region comparison unit 32 determines if the position coordinate ID stored in the tile coordinate ID field 95 of each incoming image data packet 90 is included in the coordinate ID range stored in the assigned display region storage unit 31. If the position coordinate ID stored in the tile coordinate ID field 95 of the incoming image data packet 90 is included in the coordinate ID range stored in the assigned display region storage unit 31, the assigned display region comparison unit 32 instructs a fetch control unit 33 to fetch that image data packet 90. On the other hand, if the position coordinate ID stored in the tile coordinate ID field 95 of the incoming image data packet 90 is not included in the coordinate ID range stored in the assigned display region storage unit 31, the assigned display region comparison unit 32 discards that image data packet 90 without accepting it.

Note that the boundaries of the assigned display regions of the display units 71 to 79 are often different from those of rectangular tile regions. In this case, both of the two display units on the two sides of the boundary receive the image data packets 90 of the boundary part of their assigned display regions. In such a case, these two display units extract only assigned display regions and discard unnecessary parts after they receive the image data packets 90.

The fetch control unit 33 receives (fetches) the image data packets 90 designated by the fetch instruction from the assigned display region comparison unit 32, and stores them in the buffer memory 23.

A simple practical example of control in the display unit 71 will be described below. For example, the multi-display system 61 is configured using the nine display units 71 to 79, as shown in FIG. 1. Then, assume that the image content 50 is displayed on the 3×3 display screens 51 to 59 at a resolution (1920×1080 pixels) of a high-resolution image, as shown in FIG. 2B.

If the size of each rectangular tile region is 16×16 pixels, the image content data (frame) is divided into 120×68 rectangular tile regions. Each of the display units 71 to 79 displays 40×23 rectangular tile regions assigned to each display unit.

In this case, the assigned display regions of the display units 71 to 79 are as follows.

The assigned display region of the display unit 71 is defined by regions (0, 0) to (39, 22), that of the display unit 72 is defined by (40, 0) to (79, 22), and that of the display unit 75 is defined by (40, 23) to (79, 45). The assigned display region storage unit 31 of the display unit 75 stores (40, 23) to (79, 45) as the coordinate ID range of rectangular tiles. Therefore, the assigned display region comparison unit 32 of the display unit 75 can compare this coordinate ID and the position coordinate ID stored in the tile coordinate ID field 95 of each incoming image data packet 90. For example, if the position coordinate ID stored in the tile coordinate ID field 95 is (45, 30) the assigned display region comparison unit 32 determines that the incoming image data packet 90 corresponds to the assigned display region; if it is (10, 40), the unit 32 determines that the image data packet 90 falls outside the assigned display region.

By configuring the display units 71 to 79 as described above, the display units accept (receive) only the image data packets 90 corresponding to their assigned display regions, and can reclaim and display the image content.

An example of the operation of the display unit 71 will be described below with reference to the flowchart of FIG. 7.

In step S1, the display unit general control unit 20 waits until the reception interface 21 inputs an image data packet 90 transmitted from the multi-display server 63. If the reception interface 21 inputs the image data packet 90, the process advances to step S12. The assigned display region comparison unit 32 determines if the position coordinate ID stored in the tile coordinate ID field 95 of the image data packet 90 determined to be input in step S11 is included in the coordinate ID range stored in the assigned display region storage unit 31. In other words, the assigned display region comparison unit 32 determines if the input image data packet 90 corresponds to its own assigned display region.

As a result of determining, if the position coordinate ID stored in the tile coordinate ID field 95 of the image data packet 90 is not included in the coordinate ID range stored in the assigned display region storage unit 31, the process advances to step S19 (to be described later). If the position coordinate ID stored in the tile coordinate ID field 95 of the incoming image data packet 90 is included in the coordinate ID range stored in the assigned display region storage unit 31, the process advances to step S13.

After the process reaches step S13, the assigned display region comparison unit 32 instructs the fetch control unit 33 to fetch that image data packet 90. In response to this instruction, the fetch control unit 33 fetches the image data packet 90 determined to be input in step S11.

The fetch control unit 33 then checks in step S14 if a display region (rectangular tile region) obtained from the image data packet 90 determined to be input in step S11 includes a boundary of its own assigned display region. As a result of determining, if the display region (rectangular tile region) obtained from the image data packet 90 includes the boundary of its own assigned display region, the process advances to step S20 (to be described later). On the other hand, if the display region (rectangular tile region) obtained from the image data packet 90 does not include any boundary of its own assigned display region, the process advances to step S15.

After the process reaches step S15, the fetch control unit 33 temporarily stores the image data packet 90 fetched in step S13 in the buffer memory 23.

Next, the display unit general control unit 20 determines in step S16 if the fetch control unit 33 has fetched all image data packets 90 which belong to its own assigned display region. As a result of determining, if the fetch control unit 33 has not fetched all image data packets which belong to its own assigned display region yet, the process returns to step S11 to wait until the next image data packet 90 is input.

On the other hand, if the fetch control unit 33 has fetched all image data packets 90 which belong to its own assigned display region, the process advances to step S17. After the process reaches step S17, the image reconstruction unit 25 combines the image content data of rectangular tiles included in the plurality of image data packets 90 fetched in step S13.

In step S18, the display control unit 26 displays the image content combined in step S17 under the control of the display timings by the sync control unit 27.

If it is determined in step S12 that the position coordinate ID stored in the tile coordinate ID field 95 of the incoming image data packet 90 is not included in the coordinate ID range stored in the assigned display region storage unit 31, the process advances to step S19. After the process reaches step S19, the assigned display region comparison unit 32 discards the image data packet 90 which is determined to be input in step S11 without accepting (receiving) it.

On the other hand, if it is determined in step S14 that the display region obtained from the image data packet 90 includes the boundary of its own assigned display region, the process advances to step S20. After the process reaches step S20, the fetch control unit 33 deletes data of a region other than its own assigned display region of the display region obtained from the image data packet 90 fetched in step S13.

As described above, according to this embodiment, the multi-display server 63 divides the original image content data into a plurality of rectangular tile regions, and generates position coordinate IDs indicating the positions of the divided rectangular tile regions in the image content. The multi-display server 63 generates image data packets 90 that associate images of the divided rectangular tile regions and their position coordinate IDs, and transmits them to the display units 71 to 79. Each of the display units 71 to 79 accepts (receives) an image data packet 90 of interest only when the position coordinate ID included in that image data packet 90 is included in the coordinate ID range indicating its own assigned display region. Each of the display units 71 to 79 displays an image corresponding to the assigned display region of the image content using the accepted (received) image data packets 90.

As described above, according to this embodiment, each of the display units 71 to 79 receives only image data packets 90 which belong to its own assigned display region, and displays an image using the received packets. Therefore, the multi-display server 63 as a sending device need not execute any special layout processing or the like in correspondence with the receiving display apparatuses. The display units 71 to 79 as receiving devices need not execute any image clipping processing or the like. As a result, a large-screen display can be attained by fewer hardware resources than the conventional system. Since the sending device need not distribute the destinations of the image content data, the arrangements (the number, layout, and the like) of the display units 71 to 79 can be easily changed.

In the example described in this embodiment, the communication path 64 which interconnects the display units 71 to 79 comprises a wired network. Alternatively, the communication path 64 may interconnect the display units 71 to 79 in a bus format. Also, the communication path 64 can adopt arbitrary transmission systems. Furthermore, the communication path 64 may comprise a wireless communication path as long as the bandwidth required to display the image content can be assured.

In the example described in this embodiment, the display units 71 to 79 are physically coupled. However, the display units 71 to 79 need not be physically coupled. The display units 71 to 79 may be equipped at neighboring positions, and may transmit data via wireless communications.

### Second Embodiment

The second embodiment of the present invention will be described in detail hereinafter.

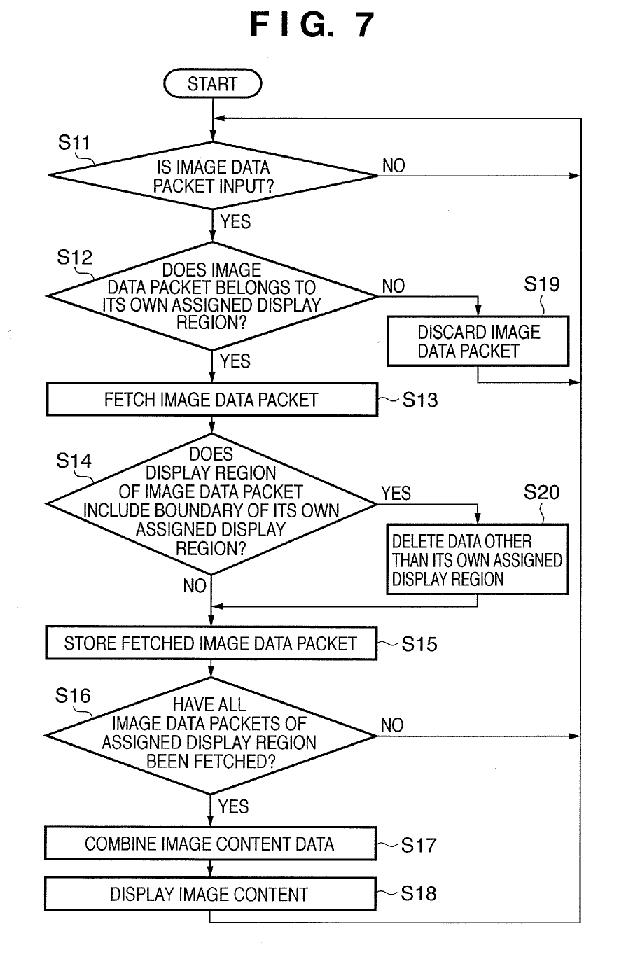

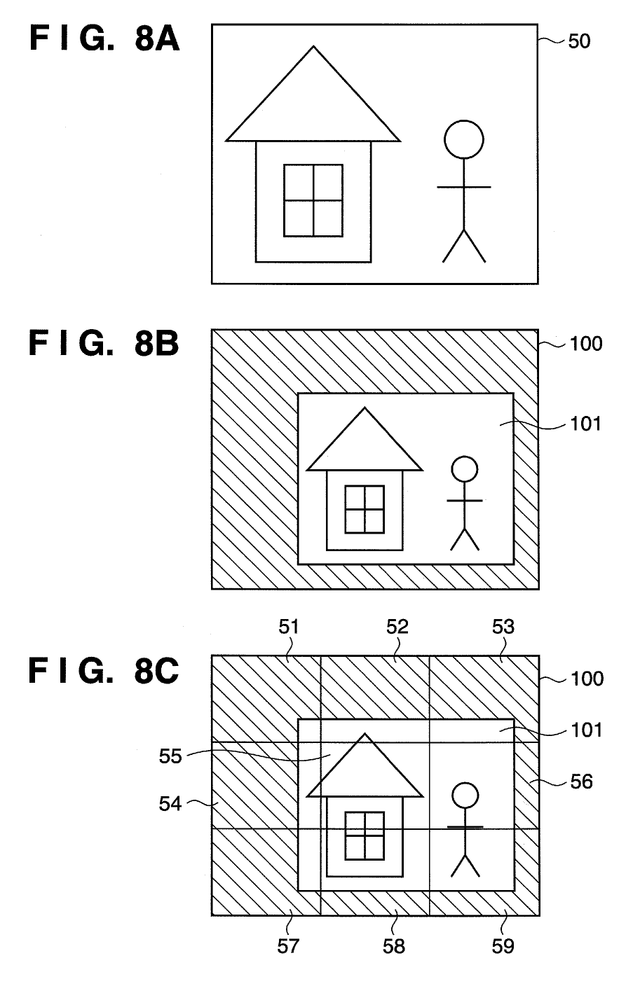

In the first embodiment, the case has been explained wherein the image content 50 is displayed on the entire screen defined by the display screens 51 to 59 of the display units 71 to 79. By contrast, this embodiment will explain a case wherein the image content 50 is displayed on some of the display screens 51 to 59 of the display units 71 to 79. More specifically, in this embodiment, the multi-display server 63 designates a layout of an image content. Each of the display units 71 to 79 calculates its own assigned display region using the designated layout, and determines if image data packets 90 belong to the calculated assigned display region. In this manner, in this embodiment, some steps of the software processing required to display the image contents are different from the first embodiment. Therefore, the same reference numerals denote the same components and processes as those in FIGS. 1 to 7 of the first embodiment, and a detailed description thereof will not be repeated.

<Display Example of Multi-Display System (FIGS. 8A to 8C)>

FIGS. 8A to 8C show a display example in the multi-display system 61 (display units 71 to 79). In this embodiment, the image content is laid out and displayed at a position designated by the multi-display server 63 based on a user's instruction.

FIG. 8A shows an example of an image content. As in FIG. 2A, the image content 50 is configured by a house object and human object.

FIG. 8B shows a layout example of the image content 50. FIG. 8B exemplifies a case wherein a contents window 101 that displays the image content 50 in a reduced scale is laid out near the lower right corner of a display screen 100.

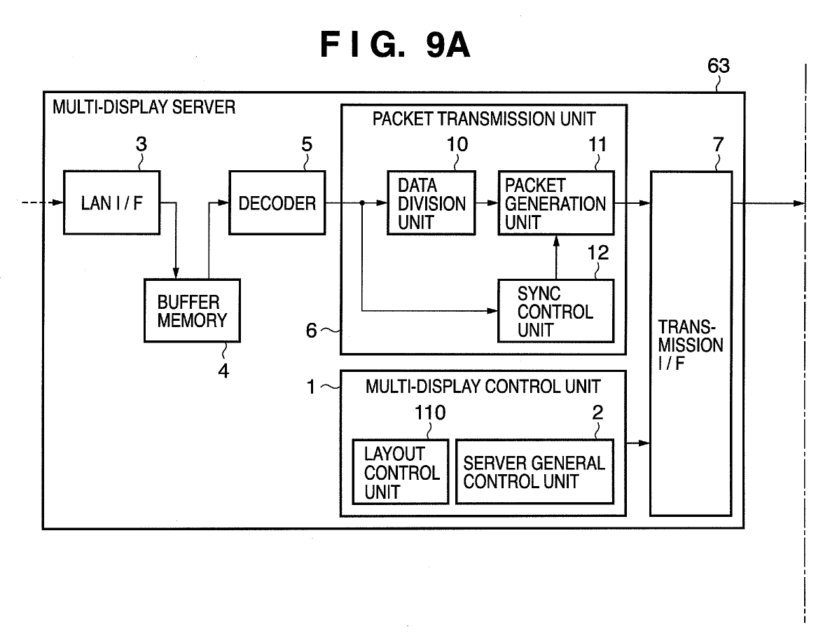

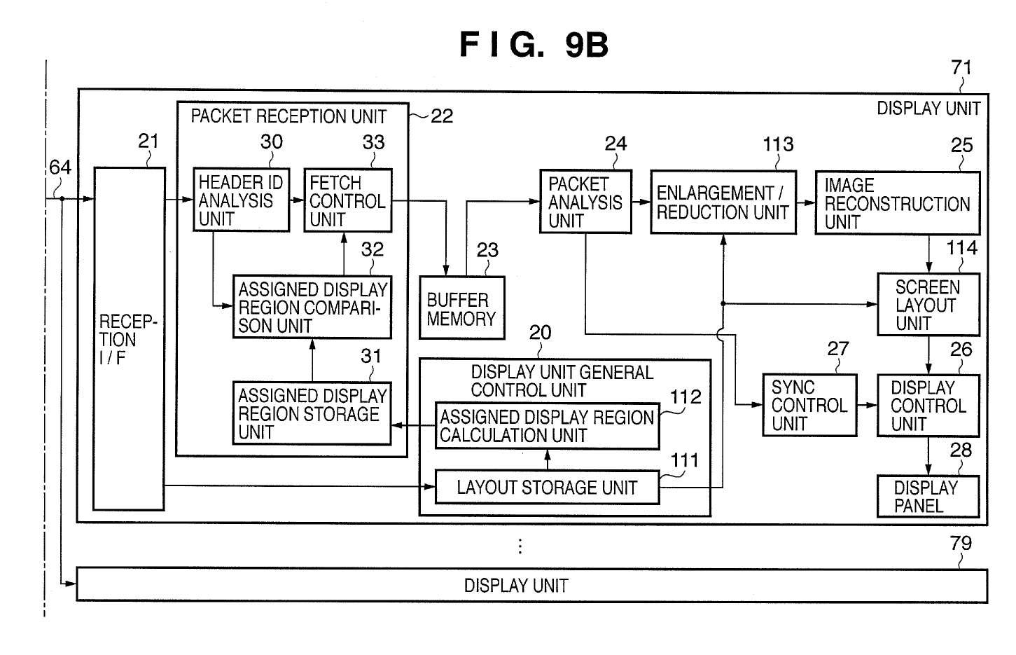

FIG. 8C shows a display example when the image content 50 is displayed using the display units 71 to 79. The display screens 51 to 59 are those of the display units 71 to 79, respectively. As in the first embodiment, in FIG. 8C, by combining the display screens 51 to 59 of the nine display units 71 to 79, a single display screen of a 3×3 matrix (3 rows×3 columns) is configured. FIG. 8C shows an example in which the image content 50 is displayed on the display screen configured by combining the nine display units 71 to 79 in this way according to the layout example shown in FIG. 8B. Each of the display units 71 to 79 displays a part of the original image content 50 according to its assigned display region. In this case, the assigned display regions of the display units 71 to 79 change depending on the layout designated by the multi-display server 63. For example, in FIG. 8C, only an upper left portion of the contents window 101 is the assigned display region of the display unit 71. In this manner, by combining the display screens 51 to 59 of the display units 71 to 79, as shown in FIG. 8C, and laying out and displaying the image content 50 according to the layout, the entire original image content 50 is displayed.

<Internal Arrangement and Operation of Multi-Display Server (FIG. 9A)>

FIGS. 9A and 9B are block diagrams showing an example of the detailed arrangement of the multi-display system 61. The arrangement of the multi-display server 63 will be described below with reference to FIG. 9A.

Referring to FIG. 9A, the multi-display server 63 decodes data received from the contents server 60, packetizes the decoded data, and transmits generated packets to the display units 71 to 79.

The multi-display control unit 1 which controls the overall multi-display system 61 includes a layout control unit 110 in addition to the server general control unit 2 shown in FIG. 5A. The layout control unit 110 inputs and stores layout instruction information of the image content (layout instruction command) from the user (e.g., the client terminal 65 or contents server 60). The layout control unit 110 transmits the layout instruction information of the image content to the display units 71 to 79 using the transmission interface 7. The layout instruction information of the image content includes, e.g., the position coordinates of a region where the image content is laid out. In this case, the layout control unit 110 can set upper left coordinates (Xmin, Ymin) and lower right coordinates (Xmax, Ymax) of the reduced-scale image of the contents window 101 displayed on the display screen 100 shown in FIGS. 8B and 8C as the layout instruction information of the image content. Also, the layout control unit 110 may set the upper left coordinates of the contents window 101 displayed on the display screen 100 in FIGS. 8B and 8C and a screen reduction scale as the layout instruction information of the image content.

When laying out the image content 50 after rotation or deformation, the layout control unit 110 transmits parameters required to attain such rotation or deformation to the display units 71 to 79 as the layout instruction information of the image content. When rotating the image content 50, the layout control unit 110 can set, e.g., a rotation angle as the layout instruction information of the image content. When deforming the image content 50, the layout control unit 110 can set, e.g., vertical and horizontal reduction scales or a matrix of Affine transformation as the layout instruction information of the image content 50.

As for the operation of the multi-display server 63, in the flowchart shown in FIG. 6, the layout control unit 110 inputs and stores layout instruction information of the image content before the process of step S8 (e.g., before the process of step S1). The layout control unit 110 then transmits the stored layout instruction information of the image content to the display units 71 to 79 before the process of step S8 (e.g., before step S1). The example of other operations of the multi-display server 63 is the same as that shown in FIG. 6, and a repetitive description thereof will be avoided.

In the following description, the instruction information for a layout of the image content will be referred to as layout instruction information as needed.

<Internal Arrangement and Operation of Display Units 71 to 79 (FIG. 9B)>

The arrangement of each of the display units 71 to 79 will be described below with reference to FIG. 9B. Note that the display units 71 to 79 have the same arrangement. Hence, the arrangement of only the display unit 71 will be explained, and a description of the arrangement of the remaining display units 72 to 79 will not be given.

Referring to FIG. 9B, the display unit 71 calculates its own assigned display region based on the layout instruction information transmitted from the multi-display server 63. The display unit 71 determines if a display target region of an image data packet 90 transmitted from the multi-display server 63 falls within the calculated assigned display region. The display unit 71 accepts (receives) only image data packets 90 that belong to its own assigned display region, and reclaims and displays a part of the image content 50.

The display unit general control unit 20 controls components which form the display unit 71. In this embodiment, the display unit general control unit 20 includes a layout storage unit 111 and assigned display region calculation unit 112.

The layout storage unit 111 stores the layout instruction information transmitted from the layout control unit 110 of the multi-display server 63. The assigned display region calculation unit 112 calculates its own assigned display region based on the layout instruction information stored in the layout storage unit 111, and stores the calculation result in the assigned display region storage unit 31 to update its own assigned display region. In this way, the assigned display region calculated by the assigned display region calculation unit 112 is obtained by correcting that stored in the assigned display region storage unit 31 in the first embodiment in accordance with the contents of the layout instruction information. More specifically, the assigned display region storage unit 31 stores the coordinate ID range of rectangular tiles which belong to its own assigned display region.

The header ID analysis unit 30 extracts ID information of the packet header 91 from each incoming image data packet 90.

The assigned display region comparison unit 32 determines if the position coordinate ID stored in the tile coordinate ID field 95 of each incoming image data packet 90 is included in the coordinate ID range stored in the assigned display region storage unit 31. If the position coordinate ID stored in the tile coordinate ID field 95 of the incoming image data packet 90 is included in the coordinate ID range stored in the assigned display region storage unit 31, the assigned display region comparison unit 32 instructs the fetch control unit 33 to fetch that image data packet 90. On the other hand, if the position coordinate ID stored in the tile coordinate ID field 95 of the incoming image data packet 90 is not included in the coordinate ID range stored in the assigned display region storage unit 31, the assigned display region comparison unit 32 discards that image data packet 90 without accepting it. When the boundaries of the assigned display regions of the display units 71 to 79 are different from those of rectangular tile regions, both of the two display units on the two sides of the boundary extract only assigned display regions and discard unnecessary parts as in the first embodiment.

The buffer memory 23 temporarily stores the image data packet 90 received by the packet reception unit 22. The packet analysis unit 24 extracts the image content data (each payload 92) divided into rectangular tiles from the image data packets 90. The packet analysis unit 24 sorts processes for the image content data divided into rectangular tiles in accordance with information in each packet header 91.

An enlargement/reduction unit 113 applies enlargement processing or reduction processing to the image content data of rectangular tiles in accordance with the layout instruction information stored in the layout storage unit 111. The image reconstruction unit 25 reclaims a part of the original image content by combining the image content data of rectangular tiles. A screen layout unit 114 generates display data so that the image content combined by the image reconstruction unit 25 is laid out at the position according to the layout instruction information stored in the layout storage unit 111. The display control unit 26 displays the display data generated by the screen layout unit 114 on the display panel 28 under the control of the sync control unit 27.

A simple practical example of control in the display unit 71 will be described below. For example, assume that the multi-display system 61 is configured using the nine display units 71 to 79, as shown in FIG. 1, and a high-resolution image (1920×1080 pixels) is displayed on the 3×3 display screens 51 to 59, as shown in FIG. 8C.

If the size of each rectangular tile region is 16×16 pixels, the image content data (frame) is divided into 120×68 rectangular tile regions. Each of the display units 71 to 79 displays 40×23 rectangular tile regions assigned to each display unit. In this case, the assigned display regions of the display units 71 to 79 are as follows.

The assigned display region of the display unit 71 is defined by regions (0, 0) to (39, 22), that of the display unit 72 is defined by (40, 0) to (79, 22), and that of the display unit 75 is defined by (40, 23) to (79, 45). The assigned display region storage unit 31 of the display unit 75 stores (40, 23) to (79, 45) as the coordinate ID range of rectangular tiles. Therefore, the assigned display region comparison unit 32 of the display unit 75 can compare this coordinate ID and the position coordinate ID stored in the tile coordinate ID field 95 of each incoming image data packet 90. For example, if the position coordinate ID stored in the tile coordinate ID field 95 is (45, 30) the assigned display region comparison unit 32 determines that the incoming image data packet 90 corresponds to the assigned display region; if it is (10, 40), the assigned display region comparison unit 32 determines that the image data packet 90 falls outside the assigned display region.

As for the operations of the display units 71 to 79, in the flowchart shown in FIG. 7, the layout storage unit 111 stores the layout instruction information transmitted from the layout control unit 110 of the multi-display server 63 before step S14. Furthermore, the display assigned region calculation unit 112 calculates the coordinate ID range that represents its own assigned display region based on the layout instruction information stored in the layout storage unit 111 before step S14. The assigned display region calculation unit 112 updates its own assigned display region by storing the calculation result in the assigned display region storage unit 31. The assigned display region comparison unit 32 determines in step S14 if the position coordinate ID stored in the tile coordinate ID field 95 of the image data packet 90 which is determined to be input in step S11 is included in the coordinate ID range calculated by the assigned display region calculation unit 112.

Between steps S16 and S17, the enlargement/reduction unit 113 applies enlargement or reduction processing to the image content data of a rectangular tile in accordance with the layout instruction information stored in the layout storage unit 111.

Between steps S17 and S18, the screen layout unit 114 executes processing for generating display data so that the image content combined by the image reconstruction unit 25 is laid out at the position according to the layout instruction information stored in the layout storage unit 111.

In step S18, the display control unit 26 displays the display data generated by the screen layout unit 114 on the display panel 28 under the control of the sync control unit 27.

Other operations of the display units 71 to 79 are the same as those shown in FIG. 7, and a repetitive description thereof will be avoided.

By configuring the display units 71 to 79 as described above, each of the display units 71 to 79 can accept (receive) only image data packets 90 within its assigned display region according to the designated layout, and can reclaim and display the image content according to the designated layout.

As described above, in this embodiment, the multi-display server 63 generates layout instruction information that instructs a layout of the image content and transmits the generated information to the display units 71 to 79. Each of the display units 71 to 79 calculates the coordinate ID range that represents the assigned display region of the image content based on the layout instruction information. Each of the display units 71 to 79 accepts (receives) an image data packet 90 of interest only when the position coordinate ID included in that image data packet 90 is included in the calculated coordinate ID range. Each of the display units 71 to 79 displays an image corresponding to the assigned display region of the image content using the accepted (received) image data packets 90.

Therefore, in addition to the effects described in the first embodiment, the layout upon displaying the image content can be freely set.

In the example described in this embodiment, the image content data transmitted from the contents server 60 is a single image stream. Alternatively, a plurality of image streams may be transmitted, and a plurality of image contents may be displayed on the single display screen 100. In this case, the second to n-th image contents (n is a natural number equal to or larger than 2) can be laid out in the first image content (picture-in-picture display can be attained). Alternatively, the second to n-th image contents can be laid out around the first image content (side-by-side display can be attained).

This embodiment can also adopt various modifications described in the first embodiment.

### Third Embodiment

The third embodiment of the present invention will be described in detail hereinafter. The second embodiment has exemplified the case wherein the display units 71 to 79 display the image content after layout in accordance with the layout instruction information (layout commands) transmitted from the multi-display server 63. By contrast, this embodiment will exemplify a case wherein layout commands are also packetized and packets including the layout commands are transmitted from the multi-display server 63 to the display units 71 to 79.

Note that a layout command packet that packetizes the layout instruction information stores layout commands together for respective coordinate regions (rectangular tile regions). A packet header of the layout command packet includes a field indicating a range of regions to which the layout commands are to be applied.

Each of display units 71 to 79 determines if a region to which a layout command packet transmitted from the multi-display server 63 is applied is included in its own assigned display region. Each of the display units 71 to 79 accepts (receives) layout command packets to be applied to its own assigned display region, and lays out the image content based on the accepted layout command packets.

As described above, in this embodiment, some steps of software processing required to lay out the image content are mainly different from the first and second embodiments. Therefore, the same reference numerals denote the same components and processes as those in FIGS. 1 to 9 of the first and second embodiments, and a detailed description thereof will not be repeated.

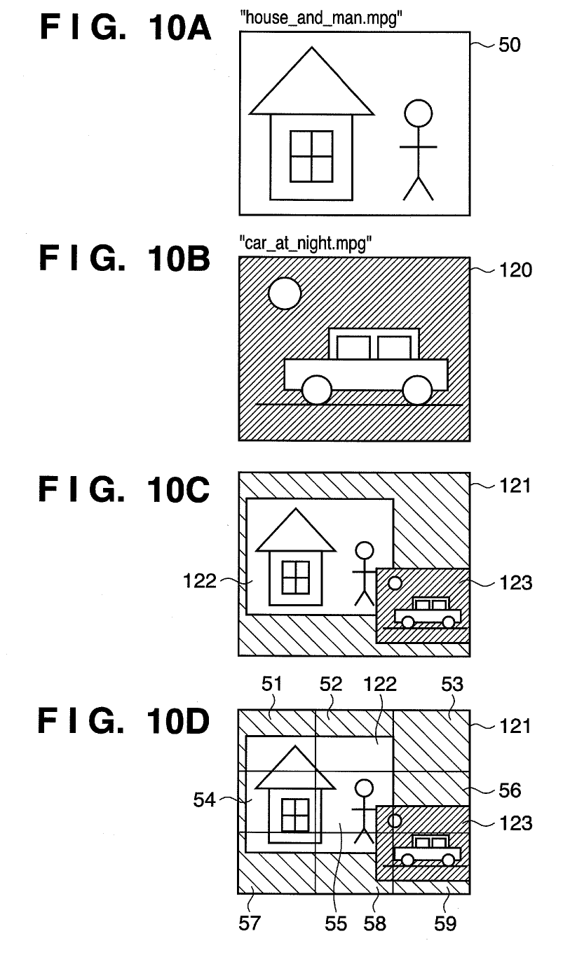

FIGS. 10A to 10D show a display example in the multi-display system 61 (display units 71 to 79). In this embodiment, a plurality of image contents are laid out and displayed at designated positions.

FIGS. 10A and 10B show examples of image contents. The image content 50 shown in FIG. 10A is configured by a house object and human object as in FIGS. 2A and 8A, and has a file name “house_and_man.mpg”. On the other hand, an image content 120 shown in FIG. 10B is configured by a car object, road object, and moon object, and has a file name “car_at_night.mpg”.

FIG. 10C shows a layout example of the image contents 50 and 120. FIG. 10C exemplifies a case wherein contents windows 122 and 123 which respectively display the image contents 50 and 120 in a reduced scale are displayed on a display screen 121.

FIG. 10D shows a display example when the image contents 50 and 120 are displayed using the display units 71 to 79. The display screens 51 to 59 are those of the display units 71 to 79, respectively. As in the first and second embodiments, in FIG. 10D, by combining the nine display units 71 to 79, a single display screen of a 3×3 matrix (3 rows×3 columns) is configured.

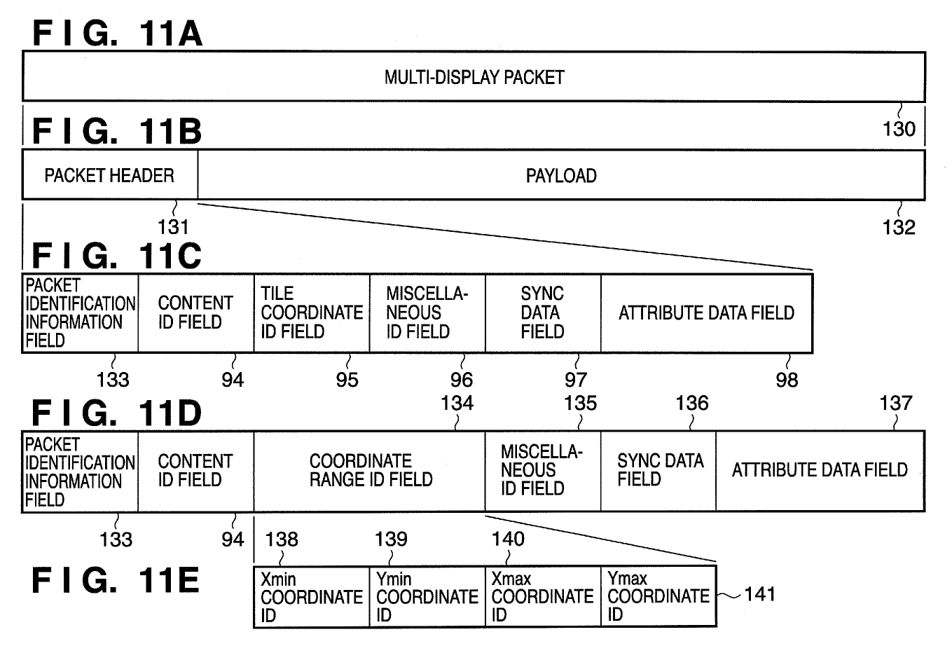

In this case, the display assigned regions of the display units 71 to 79 change depending on the layout designated by the multi-display server 63. For example, in FIG. 10D, only an upper left portion of the contents window 122 is the assigned display region of the display unit 71.

<Configuration of Multi-Display Packet (FIGS. 11A to 11E)>

FIGS. 11A to 11E show an example of the configuration of a multi-display packet. The configuration of a packet used in transmission in the multi-display system 61 will be described below with reference to FIGS. 11A to 11E. The multi-display packet of this embodiment is configured by two types of packets, i.e., an image data packet and layout command packet. The layout command packet stores layout commands for respective coordinate regions (rectangular tile regions). A packet header of this packet includes a field indicating the range of rectangular tile regions which undergo layout based on the layout commands.

FIG. 11A shows a multi-display packet 130. FIG. 11B is a view for explaining the configuration of the multi-display packet 130. As shown in FIG. 11B, the multi-display packet 130 has a packet header 131 and payload 132. The payload 132 stores image content data of a rectangular tile or layout commands.

FIG. 11C shows an example of the header configuration of the image data packet. In this header configuration, the contents of the packet identification information field are different from the image data packet 90 described in the first and second embodiments. Referring to FIG. 11C, a packet identification information field 133 stores ID information required to identify whether or not a packet of interest is a multi-display packet, version information, and the like. Furthermore, the packet identification information field 133 also stores ID information required to identify whether a packet of interest is an image data packet or layout command packet. Since FIG. 11C shows the header configuration of an image data packet, the packet identification information field 133 shown in FIG. 11C stores ID information used to identify that the packet of interest is an image data packet.

FIG. 11D shows an example of the header configuration of a layout command packet. A packet identification information field 133 shown in FIG. 11D stores ID information used to identify that the packet of interest is a layout command packet.

The content ID field 94 stores ID information required to identify the image content 50 or 120. A coordinate range ID field 134 stores ID information required to identify the range of target rectangular tile regions of the layout commands. A miscellaneous ID field 135 stores miscellaneous IDs required to identify the range of the rectangular tile regions. For example, the miscellaneous ID field 135 stores a frame number and the like. A sync data field 136 stores various time stamps indicating time information such as the processing start time, processing end time, and the like of the image content 50 or 120 identified by the ID information stored in the content ID field 94. An attribute data field 137 stores various kinds of attribute information required to process the range of the rectangular tile regions.

FIG. 11E shows an example of the configuration of the coordinate range ID field 134. As shown in FIG. 11E, the coordinate range ID field 134 is configured by four fields; an Xmin coordinate ID field 138, Ymin coordinate ID field 139, Xmax coordinate ID field 140, and Ymax coordinate ID field 141, which respectively store the IDs of corresponding rectangular tile regions. In this way, a plurality of rectangular tile regions can be designated.

A simple practical example of the layout command packet will be described below. For example, the multi-display system 61 is configured using the nine display units 71 to 79, as shown in FIG. 10D. Then, assume that the image contents 50 and 120 are displayed on the 3×3 display screens 51 to 59 at a resolution (1920×1080 pixels) of a high-resolution image, as shown in FIG. 10D. Furthermore, assume that an instruction to lay out the contents window 122 on pixels (50, 100) to (1250, 800), and the contents window 123 on pixels (1000, 500) to (1919, 900) is issued as layout commands.

The layout command packet combines commands for respective rectangular tile regions, and is divided into, e.g., two packets. The divided first layout command packet is generated to include a layout instruction of the contents window 122, and the second layout command packet is generated to include a layout instruction of the contents window 123.

The coordinate range IDs are determined as follows. If the size of each rectangular tile region is 16×16 pixels, the image content data (frame) is divided into 120×68 rectangular tile regions. The contents window 122 includes the range of rectangular tile regions (3, 6) to (78, 50), and the contents window 123 includes the range of rectangular tile regions (62, 31) to (119, 56). Therefore, as ID information values to be stored in the coordinate range ID field 134 of the first layout command packet, the Xmin coordinate ID field 138 stores “3”, the Ymin coordinate ID field 139 stores “6”, the Xmax coordinate ID field 140 stores “78”, and the Ymax coordinate ID field 141 stores “50”.

As a result, parameters of the layout command packets can be generated as follows.

First layout command packet:

Packet header:
Coordinate range IDs:
Xmin coordinate ID: 3
Ymin coordinate ID: 6
Xmax coordinate ID: 78
Ymax coordinate ID: 50
Payload:
<video x =“50” y=“100” width=“1200” height=“700”

xlink:href=“house_and_man.mpg”/>

Second layout command packet:

Packet header:
Coordinate range IDs:
Xmin coordinate ID: 62
Ymin coordinate ID: 31
Xmax coordinate ID: 119
Ymax coordinate ID: 56
Payload:
<video x =“1000” y=“500” width=“920” height=“400”

xlink:href=“car_at_night.mpg”/>

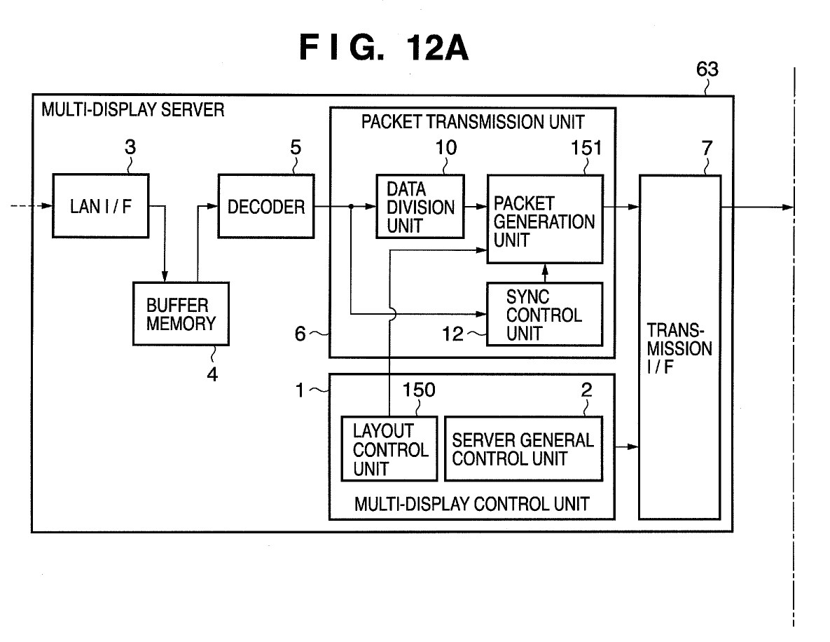

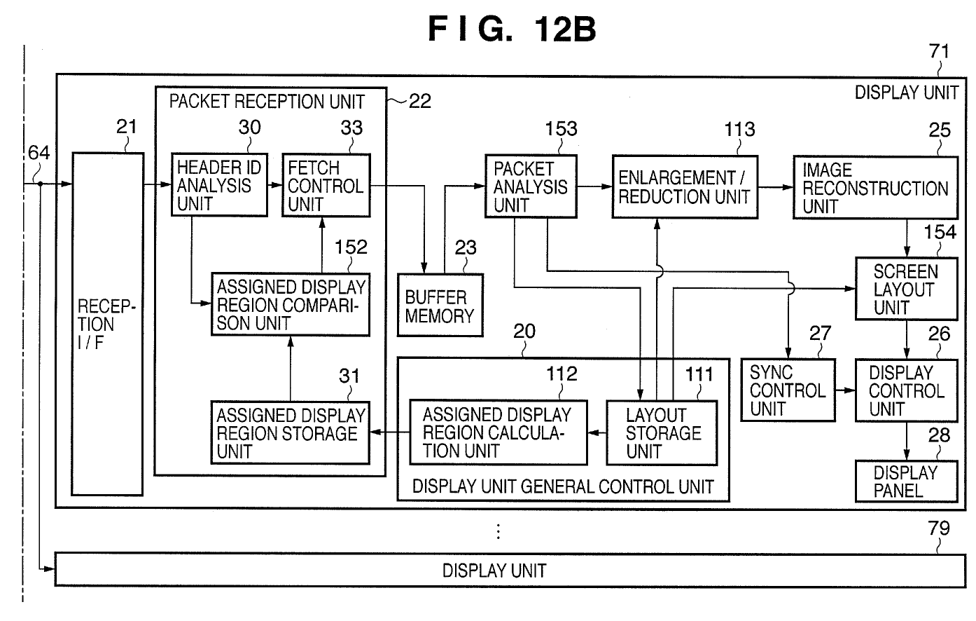

By configuring the layout command packets as described above, each of the display units 71 to 79 can determine if the layout command packet corresponds to its own assigned display region by referring to only the coordinate range IDs. That is, each of the display units 71 to 79 need only receive the layout command packet of the assigned display region and execute layout processing.

<Internal Arrangement and Operation of Multi-Display Server (FIG. 12A)>

FIGS. 12A and 12B are block diagrams showing an example of the detailed arrangement of the multi-display system 61. The arrangement of the multi-display server 63 will be described below with reference to FIG. 12A.

Referring to FIG. 12A, the multi-display server 63 divides the layout instruction into those for respective coordinate regions (rectangular tile regions), and packetizes and transmits them. In the multi-display server 63 of this embodiment, the operations of the layout control unit 150 and a packet generation unit 151 are different compared to the multi-display server 63 of the second embodiment shown in FIG. 9A. The layout control unit 150 combines layout commands for respective coordinate regions (rectangular tile regions), and outputs them to the packet generation unit 151. A coordinate region (rectangular tile region) is set to be an arbitrary size.

The packet generation unit 151 generates a multi-display packet 130 with the configuration shown in FIGS. 11A to 11E. The packet generation unit 151 generates image data packets in case of image content data, and layout command packets in case of layout commands. The decoder 5 and packet transmission unit 6 are configured to parallelly process a plurality of image contents. In this case, the decoder 5 and packet transmission unit 6 may time-divisionally process respective image contents, or a plurality of decoders 5 and packet transmission units 6 may be equipped to execute parallel processes.

Upon transmitting multi-display packets 130 from the multi-display server 63 to the display units 71 to 79, the packet generation unit 151 generates multi-display packets 130 associated with layout commands first, and transmits them to the display units 71 to 79. After that, after layout settings are done in the display units 71 to 79, the packet generation unit 151 begins to transmit multi-display packets 130 associated with data of image contents.

As for the operation of the multi-display server 63, the following processes are executed before the process of step S8 (e.g., before the process of step S1) in the flowchart shown in FIG. 6. The layout control unit 150 inputs the layout instruction information of image contents, and combines them for respective coordinate regions (rectangular tile regions). The packet generation unit 151 packetizes the layout commands combined for respective coordinate regions (rectangular tile regions) by the layout control unit 150 to generate multi-display packets 130 associated with the layout commands. The transmission interface 7 then transmits the multi-display packets 130 associated with the layout commands to the display units 71 to 79. Then, the processes in steps S1 to S8 in FIG. 6 are executed to transmit multi-display packets 130 associated with the data of the image contents to the display units 71 to 79.

<Internal Arrangement and Operation of Display Unit (FIG. 12B)>

The arrangement of each of the display units 71 to 79 will be described below with reference to FIG. 12B. Note that the display units 71 to 79 have the same arrangement. Hence, the arrangement of only the display unit 71 will be explained, and a description of the arrangement of the remaining display units 72 to 79 will not be given.

Referring to FIG. 12B, the display unit 71 inputs a layout instruction as layout command packets, and executes the layout processing of the display screen based on the input layout command packets. Upon input of the layout command packets, the display unit 71 determines if the target region of each layout command packet falls within its own assigned display region, and accepts (receives) only the layout command packets within its own assigned display region.

In FIG. 12B, in the display unit 71 of this embodiment, the operations of an assigned display region comparison unit 152, a packet analysis unit 153, and a screen layout unit 154 are different compared to the display unit 71 of the second embodiment shown in FIG. 9B.

The assigned display region comparison unit 152 determines if each layout command packet and image data packet belong to its own assigned display region. As for the layout command packet, the assigned display region comparison unit 152 determines if the application target region of the layout command packet falls within the assigned display region assigned to its own unit. That is, the assigned display region comparison unit 152 determines if the value of the coordinate range ID field 134 in the layout command packet is included in the coordinate ID range set in the assigned display region storage unit 31, as described in the first embodiment. As for the image data packet, the assigned display region comparison unit 152 determines if the position coordinate ID stored in the tile coordinate ID field 95 of the image data packet is included in the coordinate ID range calculated (corrected) by the assigned display region calculation unit 112 based on the layout command packet.

The packet analysis unit 153 extracts data of the multi-display packet 130 from the buffer memory 23. The packet analysis unit 153 sorts the processes for the extracted data of the multi-display packet 130 in accordance with the information in the packet header 131. If the multi-display packet 130 is a layout command packet, the packet analysis unit 153 outputs the data of the multi-display packet 130 to the layout storage unit 111. The layout storage unit 111 stores layout instruction information based on the layout command packet.

On the other hand, if the multi-display packet 130 is an image data packet, the packet analysis unit 153 outputs the data of the multi-display packet 130 to the enlargement/reduction unit 113.

The screen layout unit 154 generates display data that lays out the contents windows 122 and 123 at the positions according to the layout instruction information stored in the layout storage unit 111. In this case, when the contents windows 122 and 123 overlap each other, the screen layout unit 154 executes overlapping or overwrite processing with a transparency or the like in accordance with the layout instruction information stored in the layout storage unit 111.

The enlargement/reduction unit 113, image reconstruction unit 25, display unit general control unit 20, and packet reception unit 22 are configured to parallelly execute the processes for the plurality of contents windows 122 and 123. In this case, the enlargement/reduction unit 113, image reconstruction unit 25, display unit general control unit 20, and packet reception unit 22 may time-divisionally process the contents windows 122 and 123. Furthermore, a plurality of enlargement/reduction units 113, image reconstruction units 25, display unit general control units 20, and packet reception units 22 may be equipped to execute parallel processes.

With the above arrangement, each of the display units 71 to 79 receives only the layout command packets within its own assigned display region, and can lay out and display the screen based on the received layout command packets.

As for the operations of the display units 71 to 79, the reception interface 21 receives layout command packets before step S14 in the flowchart shown in FIG. 7. The assigned display region comparison unit 152 determines if the application target region of each input layout command packet is included in its own assigned display region. This determining process is attained based on the value of the coordinate range ID field 134 in the layout command packet, and the coordinate ID range stored in the assigned display region storage unit 31.

The fetch control unit 33 accepts (receives) only layout command packets to be applied to its own assigned display region, and discards other layout command packets. After that, the packet analysis unit 153 analyzes the accepted (received) layout command packets, and stores layout commands in the layout storage unit 111 based on the analysis result. Furthermore, the assigned display region calculation unit 112 calculates its own assigned display region based on the layout commands stored in the layout storage unit 111, and rewrites the coordinate IDs of rectangular tiles stored in the assigned display region storage unit 31.

The assigned display region comparison unit 152 determines in step S14 if the position coordinate ID stored in the tile coordinate ID field 95 of the image data packet determined to be input in step S11 is included in the rewritten coordinate IDs of the rectangular tiles.

Between steps S16 and S17, the enlargement/reduction unit 113 applies enlargement processing or reduction processing to image content data of rectangular tiles in accordance with the layout instruction information stored in the layout storage unit 111.

Furthermore, between steps S17 and S18, the screen layout unit 154 executes processing for generating display data that lays out the image content combined by the image reconstruction unit 25 at the position according to the layout instruction information stored in the layout storage unit 111.

In step S18, the display control unit 26 displays the display data generated by the screen layout unit 154 on the display panel 28 under the control of the sync control unit 27.

Other operations of the display units 71 to 79 are the same as those shown in FIG. 7, and a repetitive description thereof will be avoided.

In this embodiment, the multi-display server 63 generates layout command packets by packetizing the layout instruction information (layout commands) that instructs the layout of image contents, and transmits them to the display units 71 to 79. Each of the display units 71 to 79 calculates the assigned display region of the image contents based on the layout command packets. Each of the display units 71 to 79 accepts (receives) a given image data packet only when the position coordinate ID included in that image data packet is included in the calculated assigned display region of the image contents. Each of the display units 71 to 79 displays an image corresponding to the assigned display region of the image content using the accepted (received) image data packets.

As described above, since the image content data and layout commands are transmitted using packet communications of the same communication scheme, the image content data and layout commands can be handled by the same packet processing system. Therefore, in addition to the effects described in the second embodiment, the interface can be simplified.

In this embodiment, layout command packets are divisionally generated for respective contents. However, layout commands may be packetized without being divided. In such case, each of the display units 71 to 79 may accept (receive) all layout command packets, and may extract and process only commands corresponding to its own assigned display region.

Also, each image data packet may include layout commands. For example, the layout commands may be described in the miscellaneous ID field 96 in the image data packet. In this way, a reception failure of image data packets can be prevented when the multi-display packets associated with layout commands are delayed.

This embodiment can also adopt various modifications described in the first and second embodiments.

### Fourth Embodiment

The fourth embodiment of the present invention will be described in detail hereinafter.

The multi-display system 61 of this embodiment has the same arrangement as that of the multi-display system shown in FIG. 1. In this embodiment, image content data is divided into a plurality of packet data, which are supplied from the multi-display server to the display units. Each display unit determines if each packet data supplied from the multi-display server belongs to its own assigned display region. Each display unit accepts the packet data (image data packets and image processing instruction packets) of its own assigned display region based on this determining result, and reclaims and displays, on the screen, an image which has undergone image processing based on the accepted packet data. This embodiment will explain such multi-display system. In the description of this embodiment, the same reference numerals as those in FIGS. 1 to 12 denote the same components and processes as in the first to third embodiment, and a detailed description thereof will not be repeated.

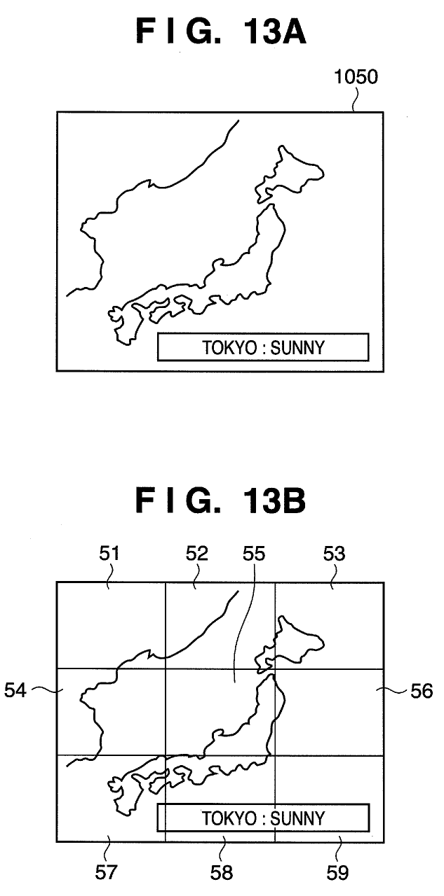

In the multi-display system 61, the display server 63 supplies image content data and image processing instruction data to the display units 71 to 79. The communication path 64 is used to supply the image content data and image processing instruction data to the display units 71 to 79.

<Display Example of Multi-Display System (FIGS. 13A and 13B)>

FIGS. 13A and 13B show a display example in the multi-display system 61 (display units 71 to 79).

FIG. 13A shows an example of an image content. Referring to FIG. 13A, an image content 1050 is configured by a weather chart object and a text data object for the weather chart.

FIG. 13B shows a display example when the image content 1050 is displayed using the display units 71 to 79. The display screens 51 to 59 are those of the display units 71 to 79, respectively. In FIG. 13B, by combining the nine display units 71 to 79, a single display screen of a 3×3 (3 rows×3 columns) matrix is configured.

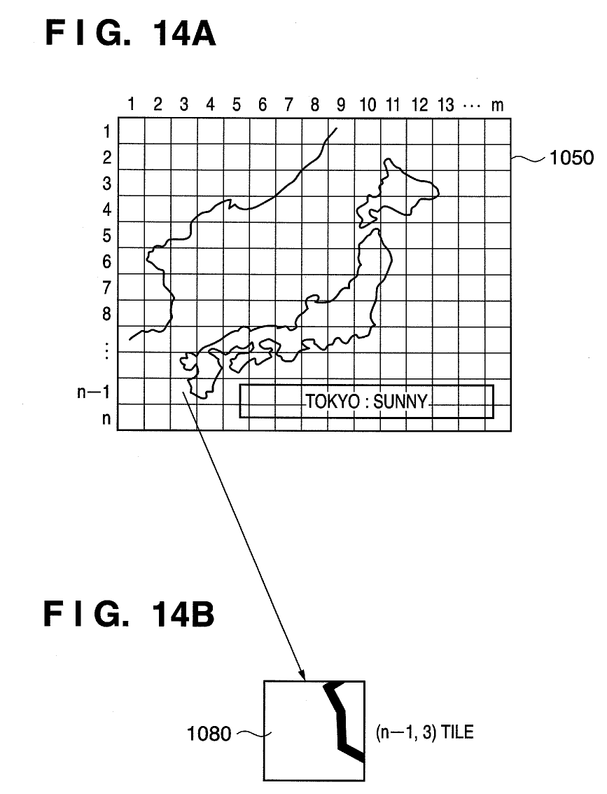

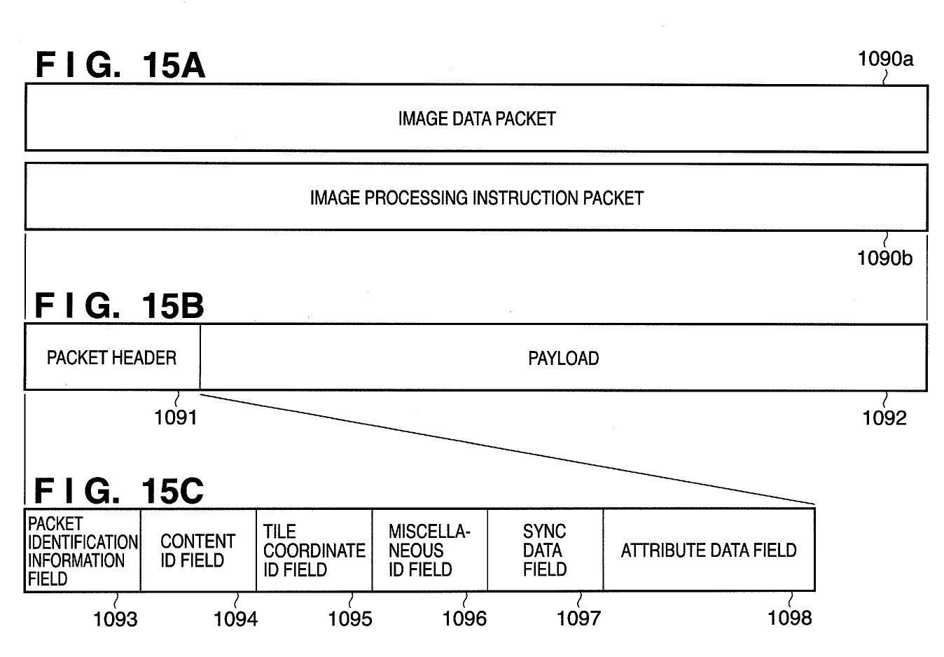

In this manner, FIG. 13B shows an example in which the image content 1050 is displayed on the display screen configured by combining the nine display units 71 to 79. Each of the display units 71 to 79 displays a part of the original image content 1050 according to its own assigned display region. For example, the display unit 73 displays, on the display screen 53, an east part from the center of Hokkaido of the weather chart, and the display unit 79 displays, on the display screen 59, a right half image of the text data. By combining the display screens 51 to 59 of the display units 71 to 79, as shown in FIG. 13B, the entire original image content 1050 is displayed on one screen.

<Configuration of Image Data Packet (FIGS. 14A to 15C)>

The configuration of an image data packet used in transmission in the multi-display system 61 will be described below. In this embodiment, the image content data is divided into small rectangular tile regions. Each divided image content data is stored in an image data packet. Furthermore, the image data packet is appended with an ID indicating the position of each rectangular tile.

FIGS. 14A and 14B show an example of the method of dividing the image content data into small rectangular tile regions.

FIG. 14A shows an example of the state of the image content data divided into small rectangular tile regions.

Assume that m (m is a natural number)×n (n is a natural number) meshes are set on the image content 1050 in the horizontal and vertical directions. Also, each mesh includes, e.g., 16×16 pixels. By dividing the image content 1050 along the boundaries of these meshes, m×n rectangular tile regions are generated. Each individual rectangular tile region is identified by a position coordinate ID indicating the position of the mesh of interest.

FIG. 14B shows an example of a part of the image content clipped into a rectangular tile shape. An image 1080 of a rectangular tile shape is an image of a region clipped by a mesh located at coordinates (n−1, 3) of the image content 1050. The position coordinate ID of this region is (n−1, 3).

FIGS. 15A to 15C show an example of the configuration of the image data packet and image processing instruction packet. In FIGS. 15A to 15C, a case will be exemplified below wherein the image data packet and image processing instruction packet store the same data items.

FIG. 15A shows an image data packet 1090a or image processing instruction packet 1090b. FIG. 15B shows the configuration of the image data packet 1090a or image processing instruction packet 1090b. As shown in FIG. 15B, the image data packet 1090a or image processing instruction packet 1090b has a packet header 1091 and payload 1092. In case of the image data packet 1090a, the payload 1092 stores the image content data clipped into a rectangular tile shape. On the other hand, in case of the image processing instruction packet 1090b, the payload 1092 stores an image processing instruction command for each rectangular tile region. The image processing instruction command may be that which instructs to apply edge emphasis to text data, or that which instructs to apply saturation enhancement processing to graphic image data.

FIG. 15C shows the configuration of the packet header 1091. A packet identification information field 1093 indicates the type of packet. The packet identification information field 1093 stores ID information, which is required to identify whether or not the self packet is an image data packet, image processing instruction packet, or another packet, version information, and the like. Furthermore, the packet identification information field 1093 may also store information required for packet processing such as a packet length, check sum, and the like.

A content ID field 1094 stores ID information required to identify an image content. For example, the content ID field 1094 stores “1” for the content of the weather chart, and “2” for the text data of the weather chart.

A tile coordinate ID field 1095 stores a position coordinate ID required to identify the position of a rectangular tile region. A miscellaneous ID field 1096 stores miscellaneous IDs required to identify the rectangular tile region. For example, the miscellaneous ID field 1096 stores a frame number and the like. A sync data field 1097 stores various time stamps indicating time information such as the processing start time, processing end time, and the like of the image content identified by the ID information stored in the content ID field 1094. An attribute data field 1098 stores various kinds of attribute information required to process the image content data of the rectangular tile.

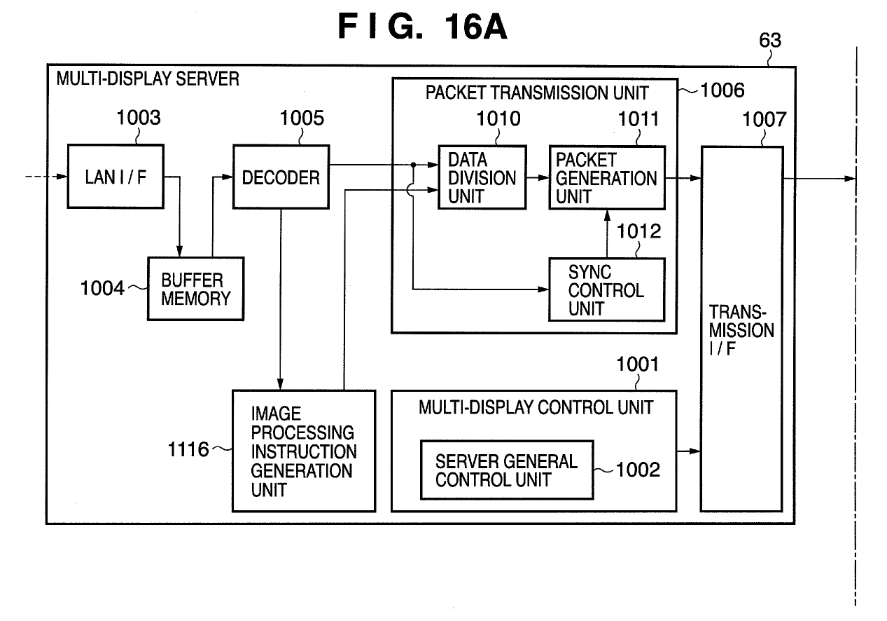

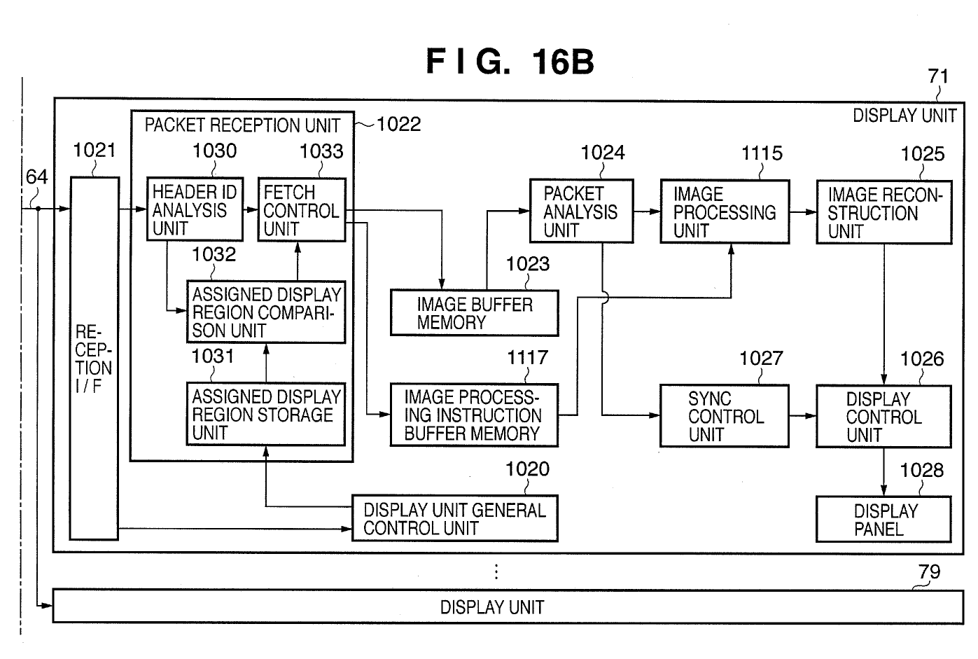

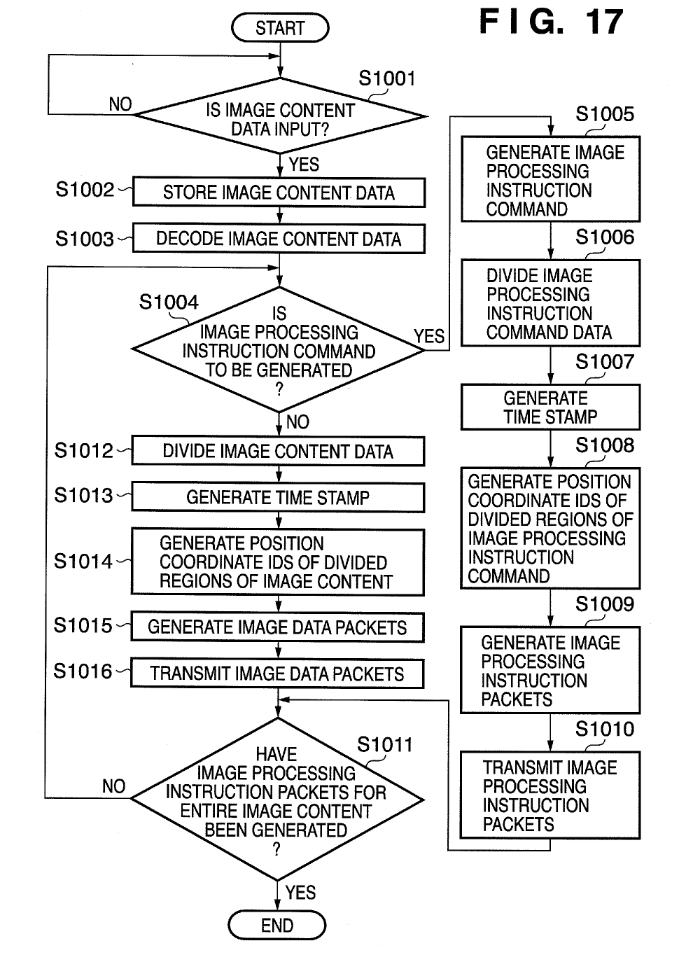

As will be described later, each of the display units 71 to 79 determines with reference to the tile coordinate ID field 1095 if each image data packet 1090a or image processing instruction packet 1090b corresponds to its own assigned display region.

<Internal Arrangement and Operation of Multi-Display Server (FIGS. 16A and 17)>

FIGS. 16A and 16B are block diagrams showing an example of the detailed arrangement of the multi-display system 61. The arrangement of the multi-display server 63 will be described below with reference to FIG. 16A.

Referring to FIG. 16A, the multi-display server 63 decodes image data received from the contents server 60, packetizes the decoded data to generate image data packets 1090a, and transmits these packets to the display units 71 to 79. Also, the multi-display server 63 packetizes image processing instruction data to generate image processing instruction packets 1090b, and transmits these to the display units 71 to 79.

A multi-display control unit 1001 controls the overall multi-display system 61. The multi-display control unit 1001 includes a CPU, memories such as a ROM, RAM, and the like, a bus, various interfaces, and the like. The multi-display control unit 1001 controls the overall system when the CPU executes programs stored in the ROM using the RAM and the like. A server general control unit 1002 controls respective elements which form the multi-display server 63.

A LAN interface (LAN I/F) 1003 inputs image content data from the contents server 60 via a communication line 62. A buffer memory 1004 temporarily stores the image content data input from the LAN interface 1003. As described above, the image content data transmitted from the contents server 60 is encoded. Hence, a decoder 1005 decodes the encoded image content data to reclaim an original image content.

The decoder 1005 reads out and decodes the image content data from the buffer memory 1004, and outputs the data to the subsequent stage in turn from the decoded part. The decoder 1005 supplies time stamp information appended to the image content data (included in a stream) to a sync control unit 1012. An image processing instruction generation unit 1116 generates image processing instruction commands according to the contents of a stream which is being decoded by the decoder 1005. The image processing instruction generation unit 1116 generates image processing instruction commands that instruct to apply saturation enhancement processing to the content of the weather chart, and generates those which instruct to apply edge emphasis to the content of the text data of the weather chart.

A packet transmission unit 1006 divides and packetizes the image content data or image processing instruction commands to generate image data packets 1090a or image processing instruction packets 1090b, and outputs these packets to a transmission interface (transmission I/F) 1007. Details of the packet transmission unit 1006 will be described later.

The transmission interface (transmission I/F) 1007 transmits the image data packets 1090a or image processing instruction packets 1090b to the display units 71 to 79. The image data packets 1090a or image processing instruction packets 1090b are broadcast to the display units 71 to 79 which are connected to the multi-display server 63. The transmission interface 1007 independently transmits various control data generated by the multi-display control unit 1001 to the display units 71 to 79.

In the packet transmission unit 1006, a data division unit 1010 divides the image content data and image processing instruction command data so that each divided data has a size (data amount) that can be processed by each of the display units 71 to 79 as destinations of the image content data. Note that the multi-display server 63 can acquire a size (data amount) that can be processed by each of the display units 71 to 79 by, e.g., making communications with the display units 71 to 79. In addition, the multi-display server 63 can acquire a size (data amount) that can be processed by each of the display units 71 to 79 from, e.g., the contents server 60, client terminal 65, or the like.

In this embodiment, the data division unit 1010 divides the image content data and image processing instruction command data into a plurality of rectangular tile regions, so that each divided data has a predetermined data size. By dividing the image content data and image processing instruction command data into a plurality of rectangular tile regions, the size of a RAM required for the image processing in each of the display units 71 to 79 to be described later can be reduced. More specifically, the data division unit 1010 divides the image content data into rectangular tiles, as shown in, e.g., FIG. 14A. Upon dividing the image processing instruction command data, data including the instruction contents of image processing for the content data included in respective rectangular tile regions are generated for respective rectangular tile regions. For example, the image 1080 of a rectangular tile is a part of the weather chart. Therefore, the data division unit 1010 outputs image processing instruction commands for the content of the weather chart to a packet generation unit 1011 as the image processing instruction command data for the image 1080 of the rectangular tile.

The sync control unit 1012 generates internal sync control data based on time stamps appended to the original image content data. This sync control data includes time information such as transmission times to the display units 71 to 79, processing start times of the display units 71 to 79, display times of the display units 71 to 79, and the like. The sync control data generated by the sync control unit 1012 is stored as time stamps in the sync data field 1097 shown in FIG. 15C. Note that the sync control data is not limited to the aforementioned one, and any other kinds of information may be used as the sync control data as long as it is time information that can specify the processing start timings, display timings, and the like in the display units 71 to 79.

The packet generation unit 1011 generates an image data packet 1090a or image processing instruction packet 1090b with the structure shown in FIGS. 15A to 15C. The packet generation unit 1011 generates a packet by appending the packet header 1091 to the image content data or image processing instruction command data of each rectangular tile. The packet header 1091 stores the position coordinate ID of the rectangular tile region, time stamps (sync information), and the like.

With the aforementioned arrangement of the multi-display server 63, the original image content data is packetized to generate image data packets 1090a and image processing instruction packets 1090b, which can be transmitted to the display units 71 to 79.

Note that the decoder 1005 and packet transmission unit 1006 are configured to parallelly process a plurality of image contents. In this case, the decoder 1005 and packet transmission unit 1006 may time-divisionally process the respective image contents, or a plurality of decoders 1005 and packet transmission units 1006 may be equipped to execute parallel processes.

An example of the operation of the multi-display server 63 will be described below with reference to the flowchart of FIG. 17.

In step S1001, the server general control unit 1002 waits until the LAN interface 1003 inputs image content data transmitted from the contents server 60. If the LAN interface 1003 inputs the image content data, the process advances to step S1002. After the process reaches step S1002, the server general control unit 1002 temporarily stores the image content data input to the LAN interface 1003 in the buffer memory 1004.

In step S1003, the decoder 1005 decodes the encoded image content data to reclaim an original image content.

The image processing instruction generation unit 1116 determines in step S1004 whether or not to generate image processing instruction commands according to the contents of a stream which is being decoded by the decoder 1005. As a result of determining, if image processing instruction commands are not generated, the process advances to step S1012 to be described later. On the other hand, if image processing instruction commands are to be generated, the process advances to step S1005.

After the process reaches step S1005, the image processing instruction generation unit 1116 generates image processing instruction commands according to the contents of a stream which is being decoded by the decoder 1005 in step S1003.

In step S1006, the data division unit 1010 divides the image processing instruction command data into a rectangular tile region. That is, the data division unit 1010 generates the image processing instruction commands for each rectangular tile region.

In step S1007, the sync control unit 1012 generates time stamps for the image processing command data divided in step S1006 based on the time stamp information appended to the original image content data.

In step S1008, the packet generation unit 1011 generates a position coordinate ID of the image processing instruction command data divided in step S1006 (i.e., the divided region of the image processing instruction commands).

In step S1009, the packet generation unit 1011 appends header information generated in steps S1007, S1008, and the like to the image processing instruction command data divided in step S1006 to generate an image processing instruction packet 1090b. As described above, the image processing instruction command data divided in step S1006 is stored in the payload 1092. The time stamps generated in step S1007 are stored in the sync data field 1097. The position information ID generated in step S1008 is stored in the tile coordinate ID field 1095.

In step S1010, the server general control unit 1002 instructs the transmission interface 1007 to transmit the image processing instruction packet 1090b generated in step S1009. In this way, the image processing instruction packet 1090b is transmitted to the display units 71 to 79.

The packet generation unit 1011 determines in step S1011 if the image processing packets for the entire image content input in step S1001 are generated. As a result of determining, if image processing instruction packets 1090b for the entire image content are not generated yet, the process returns to step S1004. On the other hand, if the image processing instruction packets 1090b for the entire image content are generated, the processing ends.

If it is determined in step S1004 that image processing instruction commands are not generated, the process advances to step S1012. After the process reaches step S1012, the data division unit 1010 divides the image content data into a plurality of rectangular tiles.

In step S1013, the sync control unit 1012 generates time stamps for the respective image content data divided in step S1012 based on the time stamp information appended to the original image content data.

In step S1014, the packet generation unit 1011 generates the position coordinate IDs of the respective image content data (i.e., the divided regions of the image content) divided in step S1012.

In step S1015, the packet generation unit 1011 appends the header information generated in steps S1013, S1014, and the like to the respective image content data divided in step S1012 to generate image data packets 1090a. As described above, each image content data divided in step S1012 is stored in the payload 1092. The time stamps generated in step S1013 are stored in the sync data field 1097. The position information ID generated in step S1014 is stored in the tile coordinate ID field 1095.

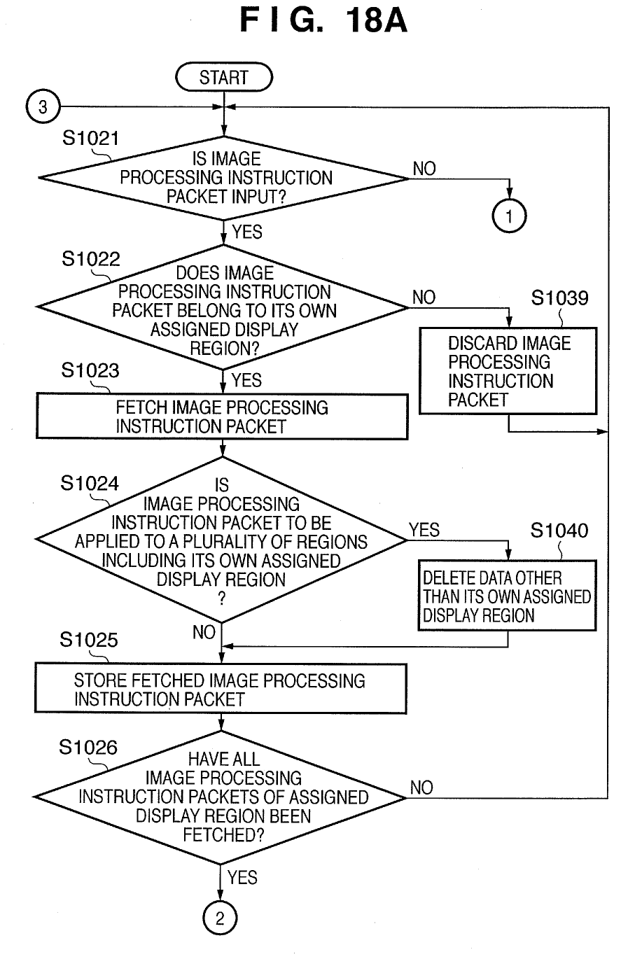

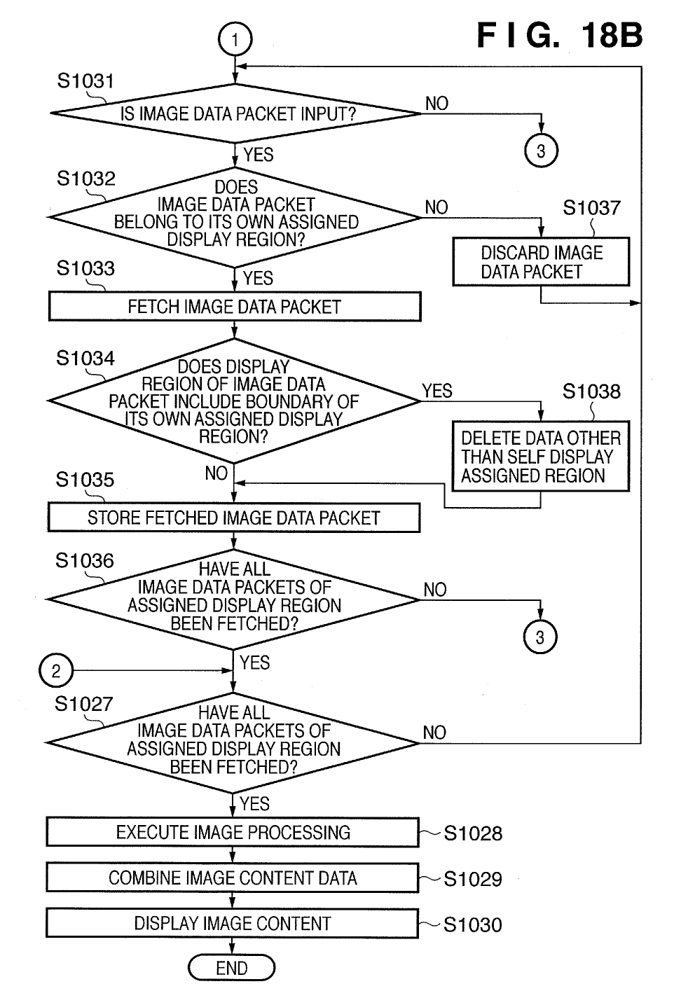

In step S1016, the server general control unit 1002 instructs the transmission interface 1007 to transmit the image data packets 1090a and the like generated in step S1015. In this way, the image data packets 1090a are transmitted to the display units 71 to 79. Then, the process advances to step S1011. Note that the control data generated by the server general control unit 1002 is also transmitted from the transmission interface 1007 to the display units 71 to 79.

<Internal Arrangement and Operation of Display Units 71 to 79 (FIGS. 16B, 18A and 18B)>

The arrangement of each of the display units 71 to 79 will be described below with reference to FIG. 16B. Note that the display units 71 to 79 have the same arrangement. Hence, the arrangement of only the display unit 71 will be explained, and a description of the arrangement of the remaining display units 72 to 79 will not be given.

Referring to FIG. 16B, the display unit 71 determines if the image data packets 1090a transmitted from the display server 63 correspond to its own assigned display region. The display unit 71 applies image processing to only the image data packets 1090a of its own assigned display region based on this determining result, and reclaims and displays a part of the image content.

A display unit general control unit 1020 controls components which form the display unit 71. The display unit general control unit 1020 includes, e.g., a CPU, memories such as a ROM, RAM, and the like, various interfaces, and so forth. The display unit general control unit 1020 controls the overall display unit 71 when the CPU executes programs recorded on the ROM using the RAM and the like.

A reception interface (reception I/F) 1021 inputs data transmitted from the multi-display server 63. More specifically, the reception interface 1021 inputs the image data packets 1090a and image processing instruction packets 1090b. The reception interface (reception I/F) 1021 inputs not only the image data packets 1090a and image processing instruction packets 1090b but also control data and the like generated by the multi-display control unit 1001.

A packet reception unit 1022 determines if an image data packet 1090a corresponds to its own assigned display region. If the image data packet 1090a corresponds to its own assigned display region, the packet reception unit 1022 writes that image data packet 1090a in an image buffer memory 1023. The packet reception unit 1022 determines if an image processing instruction packet 1090b corresponds to its own assigned display region. If the image processing instruction packet 1090b corresponds to its own assigned display region, the packet reception unit 1022 writes that image processing instruction packet 1090b in an image processing instruction buffer memory 1117. Details of the packet reception unit 1022 will be described later.

The image buffer memory 1023 temporarily stores the image data packet 1090a received by the packet reception unit 1022. The image processing instruction buffer memory 1117 temporarily stores the image processing instruction packet 1090b received by the packet reception unit 1022. A packet analysis unit 1024 extracts the image content data (data in each payload 1092) divided into rectangular tiles from the image data packets 1090a. The packet analysis unit 1024 sorts processes for the image content data divided into rectangular tiles in accordance with information in each packet header 1091.

An image processing unit 1115 receives image processing instruction commands corresponding to the image content data divided into rectangular tiles from the image processing instruction buffer memory 1117. The image processing unit 1115 applies image processing according to the image processing instruction commands to the image content data divided into rectangular tiles. Upon application of the image processing by dividing the entire frame into rectangles, the size of a memory which is required for the image processing and is used to refer to neighboring pixels can be reduced compared to a case in which the image processing is done without dividing the entire frame.

An image reconstruction unit 1025 reclaims a part of the original image content by combining the image content data of rectangular tiles that have undergone the image processing.

A display control unit 1026 performs drive control of a display panel 1028. The display control unit 1026 outputs the image content data divided into rectangular tiles to the display panel 1028 in synchronism with, e.g., drive signals such as a horizontal sync signal, vertical sync signal, data transfer clocks, and the like. Note that the image content data divided into rectangular tiles are stored in a memory such as a VRAM or the like (not shown), are read out in synchronism with the drive signal timings, and are output to the display panel 1028.

A sync control unit 1027 controls the display control unit 1026 based on the time stamps stored in the sync data field 1097 of each image data packet 1090a so that a part corresponding to its own assigned display region of the image content is displayed at the designated time. The display panel 1028 displays a part of the image content corresponding to its own assigned display region. As the display panel 1028, as described above, for example, a display device of an arbitrary system such as an LCD, plasma display, projection type display, and the like may be used.

The arrangement of the packet reception unit 1022 will be described in detail below. As described above, the packet reception unit 1022 determines if the image data packets 1090a or image processing instruction packets 1090b correspond to its own assigned display region. The packet reception unit 1022 accepts (receives) only the packets corresponding to the assigned display region, and stores the image data packets 1090a in the image buffer memory 1023 and the image processing instruction packets 1090b in the image processing instruction buffer memory 1117.

An assigned display region storage unit 1031 stores the coordinate ID range of rectangular tiles so as to identify its own assigned display region. The assigned display region can be set by an arbitrary method, as described above.

A header ID analysis unit 1030 extracts ID information of the packet header 1091 from each incoming image data packet 1090a or image processing instruction packet 1090b. The header ID analysis unit 1030 confirms (verifies) the ID information stored in the packet identification information field 1093 and that stored in the content ID field 1094, and then extracts the position coordinate ID stored in the tile coordinate ID field 1095.

An assigned display region comparison unit 1032 determines if the position coordinate ID stored in the tile coordinate ID field 1095 of each incoming image data packet 1090a or image processing instruction packet 1090b is included in the coordinate ID range stored in the assigned display region storage unit 1031. If the position coordinate ID stored in the tile coordinate ID field 1095 of the incoming image data packet 1090a is included in the coordinate ID range stored in the assigned display region storage unit 1031, the assigned display region comparison unit 1032 executes the following processes. That is, the assigned display region comparison unit 1032 instructs a fetch control unit 1033 to write that image data packet 1090a in the image buffer memory 1023. On the other hand, if the position coordinate ID stored in the tile coordinate ID field 1095 of the incoming image data packet 1090a is not included in the coordinate ID range stored in the assigned display region storage unit 1031, the assigned display region comparison unit 1032 discards that image data packet 1090a without accepting it.

If the position coordinate ID stored in the tile coordinate ID field 1095 of the incoming image processing instruction packet 1090b is included in the coordinate ID range stored in the assigned display region storage unit 1031, the assigned display region comparison unit 1032 executes the following processes. That is, the assigned display region comparison unit 1032 instructs the fetch control unit 1033 to write that image processing instruction packet 1090b in the image processing instruction buffer memory 1117. On the other hand, if the position coordinate ID stored in the tile coordinate ID field 1095 of the incoming image processing instruction packet 1090b is not included in the coordinate ID range stored in the assigned display region storage unit 1031, the assigned display region comparison unit 1032 discards that image processing instruction packet 1090b without accepting it.

Note that the boundaries of the assigned display regions of the display units 71 to 79 are often different from those of rectangular tile regions. In this case, both of the two display units on the two sides of the boundary receive the image data packets 1090a or image processing instruction packets 1090b of the boundary part of their assigned display regions. In such case, these two display units extract only assigned display regions and discard unnecessary parts after they receive the image data packets 1090a or image processing instruction packets 1090b.

The fetch control unit 1033 receives (fetches) the image data packets 1090a designated by the fetch instruction from the assigned display region comparison unit 1032, and stores them in the image buffer memory 1023. Also, the fetch control unit 1033 receives (fetches) the image processing instruction packets 1090b designated by the fetch instruction from the assigned display region comparison unit 1032, and stores them in the image processing instruction buffer memory 1117.

A simple practical example of control in the display unit 71 will be described below. For example, the multi-display system 61 is configured using the nine display units 71 to 79, as shown in FIG. 1. Then, assume that the image content 1050 is displayed on the 3×3 display screens 51 to 59 at a resolution (1920×1080 pixels) of a high-resolution image, as shown in FIG. 13B.

If the size of each rectangular tile region is 16×16 pixels, the image content data (frame) is divided into 120×68 rectangular tile regions. Each of the display units 71 to 79 displays 40×23 rectangular tile regions assigned to each display unit. In this case, the assigned display regions of the display units 71 to 79 are as follows.

The assigned display region of the display unit 71 is defined by regions (0, 0) to (39, 22), that of the display unit 72 is defined by (40, 0) to (79, 22), and that of the display unit 75 is defined by (40, 23) to (79, 45). The assigned display region storage unit 1031 of the display unit 75 stores (40, 23) to (79, 45) as the coordinate ID range of rectangular tiles. Therefore, the assigned display region comparison unit 1032 of the display unit 75 can compare this coordinate ID and the position coordinate ID stored in the tile coordinate ID field 1095 of each incoming image data packet 1090a. For example, if the position coordinate ID stored in the tile coordinate ID field 1095 is (45, 30), the assigned display region comparison unit 1032 determines that the incoming image data packet 1090a corresponds to the assigned display region; if it is (10, 40), the unit 1032 determines that the image data packet 1090a falls outside the assigned display region.

By configuring the display units 71 to 79 as described above, the display units accept (receive) only the packets (image data packets 1090a and image processing instruction packets 1090b) corresponding to their assigned display regions, and can reclaim and display the image content.

An example of the operation of the display unit 71 will be described below with reference to the flowcharts of FIGS. 18A and 18B.

The display unit general control unit 1020 determines in step S1021 if the reception interface 1021 inputs an image processing instruction packet 1090b transmitted from the multi-display server 63. As a result of determining, if the reception interface 1021 does not input any image processing instruction packet 1090b, the process advances to step S1031 in FIG. 18B to be described later.

On the other hand, if the reception interface 1021 inputs an image processing instruction packet 1090b, the process advances to step S1022. The assigned display region comparison unit 1032 determines if the position coordinate ID stored in the tile coordinate ID field 1095 of the image processing instruction packet 1090b determined to be input in step S1021 is included in the coordinate ID range stored in the assigned display region storage unit 1031. In other words, the assigned display region comparison unit 1032 determines if the input image processing instruction packet 1090b corresponds to its own assigned display region.

As a result of determining, if the position coordinate ID stored in the tile coordinate ID field 1095 of the image processing instruction packet 1090b is not included in the coordinate ID range stored in the assigned display region storage unit 1031, the process advances to step S1039 (to be described later). If the position coordinate ID stored in the tile coordinate ID field 1095 of the image processing instruction packet 1090b is included in the coordinate ID range stored in the assigned display region storage unit 1031, the process advances to step S1023.

After the process reaches step S1023, the assigned display region comparison unit 1032 instructs the fetch control unit 1033 to fetch that image processing instruction packet 1090b. In response to this instruction, the fetch control unit 1033 fetches the image processing instruction packet 1090b determined to be input in step S1021. The fetch control unit 1033 then determines in step S1024 if a display region (rectangular tile regions) for which execution of image processing is instructed by the image processing instruction packet 1090b determined to be input in step S1021 corresponds to a plurality of display regions including its own assigned display region. That is, the fetch control unit 1033 determines if a display region (rectangular tile regions) for which execution of image processing is instructed by the image processing instruction packet 1090b determined to be input in step S1021 includes the boundary of its own assigned display region.

As a result of determining, if a display region for which execution of image processing is instructed by the image processing instruction packet 1090b determined to be input in step S1021 corresponds to a plurality of display regions including its own assigned display region, the process advances to step S1040 (to be described later). On the other hand, if a display region for which execution of image processing is instructed by the image processing instruction packet 1090b does not correspond to a plurality of display regions including its own assigned display region but corresponds to only its own assigned display region, the process advances to step S1025.

After the process reaches step S1025, the fetch control unit 1033 temporarily stores the image processing instruction packet 1090b fetched in step S1023 in the image processing instruction buffer memory 1117.

Next, the display unit general control unit 1020 determines in step S1026 if the fetch control unit 1033 has fetched all image processing instruction packets 1090b which belong to its own assigned display region. As a result of determining, if the fetch control unit 1033 has not fetched all image processing instruction packets 1090b which belong to its own assigned display region yet, the process returns to step S1021 to determine if the next image processing instruction packet 1090b is input.

On the other hand, if the fetch control unit 1033 has fetched all image processing instruction packets 1090b which belong to its own assigned display region, the process advances to step S1027. After the process reaches step S1027, the display unit general control unit 1020 determines if the fetch control unit 1033 has fetched all image data packets 1090a which belong to its own assigned display region. As a result of determining, if the fetch control unit 1033 has not fetched all image data packets 1090a which belong to its own assigned display region yet, the process advances to step S1031 to be described later.

On the other hand, if the fetch control unit 1033 has fetched all image data packets 1090a which belong to its own assigned display region, since all the image data packets 1090a and image processing instruction packets 1090b which belong to its own assigned display region have been fetched, the process advances to step S1028.

After the process reaches step S1028, the image processing unit 1115 executes image processing according to the image processing instruction commands included in the image processing instruction packets 1090b to the image content data of rectangular tiles included in the image data packets 1090a.

In step S1029, the image reconstruction unit 1025 combines the image content data of rectangular tiles that have undergone the image processing in step S1028.

In step S1030, the display control unit 1026 displays, on the display panel 1028, the image content combined in step S1029 under the control of the display timings by the sync control unit 1027.

If it is determined in step S1021 in FIG. 18A that the reception interface 1021 does not input any image processing instruction packet 1090b, the process advances to step S1031 in FIG. 18B. After the process reaches step S1031, the display unit general control unit 1020 determines if the reception interface 1021 inputs an image data packet 1090a transmitted from the multi-display server 63. As a result of determining, if the reception interface 1021 does not input any image data packet 1090a transmitted from the multi-display server 63, the process returns to step S1021 in FIG. 18A described above.

On the other hand, if the reception interface 1021 inputs an image data packet 1090a from the multi-display server 63, the process advances to step S1032. The assigned display region comparison unit 1032 determines if the position coordinate ID stored in the tile coordinate ID field 1095 of the image data packet 1090a determined to be input in step S1031 is included in the coordinate ID range stored in the assigned display region storage unit 1031. In other words, the assigned display region comparison unit 1032 determines if the input image data packet 1090a corresponds to its own assigned display region.

As a result of determining, if the position coordinate ID stored in the tile coordinate ID field 1095 of the image data packet 1090a is not included in the coordinate ID range stored in the assigned display region storage unit 1031, the process advances to step S1037 (to be described later). On the other hand, if the position coordinate ID stored in the tile coordinate ID field 1095 of the image data packet 1090a is included in the coordinate ID range stored in the assigned display region storage unit 1031, the process advances to step S1033.

After the process reaches step S1033, the assigned display region comparison unit 1032 instructs the fetch control unit 1033 to fetch that image data packet 1090a. In response to this instruction, the fetch control unit 1033 fetches the image data packet 1090a determined to be input in step S1031.

Next, the fetch control unit 1033 determines in step S1034 if a display region (rectangular tile region) obtained from the image data packet 1090a determined to be input in step S1031 includes the boundary of its own assigned display region. As a result of determining, if a display region (rectangular tile region) obtained from the image data packet 1090a includes the boundary of its own assigned display region, the process advances to step S1038 (to be described later). On the other hand, if a display region (rectangular tile region) obtained from the image data packet 1090a does not include any boundary of its own assigned display region, the process advances to step S1035.

After the process reaches step S1035, the fetch control unit 1033 temporarily stores the image data packet 1090a fetched in step S1033 in the image buffer memory 1023.

Next, the display unit general control unit 1020 determines in step S1036 if the fetch control unit 1033 has fetched all image processing instruction packets 1090b which belong to its own assigned display region. As a result of determining, if the fetch control unit 1033 has not fetched all image processing instruction packets 1090b which belong to its own assigned display region yet, the process returns to step S1021 in FIG. 18A to determine if the next image data packet 1090a is input.

On the other hand, if the fetch control unit 1033 has fetched all image processing instruction packets 1090b which belong to its own assigned display region, the process advances to step S1027 described above. The display unit general control unit 1020 then determines if the fetch control unit 1033 has fetched all image data packets 1090a which belong to its own assigned display region.

If it is determined in step S1032 that the position coordinate ID stored in the tile coordinate ID field 1095 of the incoming image data packet 1090a is not included in the coordinate ID range stored in the assigned display region storage unit 1031, the process advances to step S1037. After the process reaches step S1037, the assigned display region comparison unit 1032 discards the image data packet 1090a which is determined to be input in step S1031 without accepting (receiving) it.

If it is determined in step S1034 that the display region (rectangular tile region) obtained from the image data packet 1090a includes the boundary of its own assigned display region, the process advances to step S1038. After the process reaches step S1038, the fetch control unit 1033 deletes data of a region other than its own assigned display region of the display region obtained from the image data packet 1090a fetched in step S1033.

If it is determined in step S1022 that the position coordinate ID stored in the tile coordinate ID field 1095 of the incoming image processing instruction packet 1090b is not included in the coordinate ID range stored in the assigned display region storage unit 1031, the process advances to step S1039. After the process reaches step S1039, the assigned display region comparison unit 1032 discards the image processing instruction packet 1090b which is determined to be input in step S1021 without accepting (receiving) it.

If it is determined in step S1024 that a display region for which execution of image processing is instructed by the image processing instruction packet 1090b corresponds to a plurality of display regions including its own assigned display region, the process advances to step S1040. After the process reaches step S1040, the fetch control unit 1033 deletes data for a region other than its own assigned display region of data of the image processing instruction commands in the image processing instruction packet 1090b fetched in step S1023.

In this embodiment, the multi-display server 63 divides the original image content data into a plurality of rectangular tile regions, and generates position coordinate IDs indicating the positions of the divided rectangular tile regions in the image content. The multi-display server 63 generates image data packets 1090a that associate images of the divided rectangular tile regions and their position coordinate IDs, and transmits them to the display units 71 to 79. Also, the multi-display server 63 generates image processing instruction commands for a plurality of rectangular tile regions, and generates position coordinate IDs indicating regions to which these image processing instruction commands are to be applied. The multi-display server 63 generates image processing instruction packets 1090b that associate the image processing instruction commands and the position coordinate IDs for the image processing instruction commands, and transmits them to the display units 71 to 79.

Each of the display units 71 to 79 accepts (receives) an image data packet 1090a and image processing instruction packet 1090b only when the position coordinate IDs included in these image data packet 1090a and image processing instruction packet 1090b are included in the coordinate ID range indicating its own assigned display region. Each of the display units 71 to 79 applies image processing based on the image processing commands included in the image processing instruction packets 1090b to the image content data included in the accepted (received) image data packets 1090a. Then, each of the display units 71 to 79 displays the image content that has undergone the image processing.

As described above, each of the display units 71 to 79 receives only image data packets 1090a and image processing instruction packets 1090b which belong to its own assigned display region, applies image processing for respective rectangular tile regions, and displays data of the image content. Therefore, the sending device need not execute any special layout processing or the like in correspondence with the receiving display apparatuses. The receiving devices need not execute any image clipping processing or the like. As a result, a large-screen display can be attained by hardware resources fewer than the conventional system. Since the sending device need not distribute the destinations of the image content data, the arrangements (the number, layout, and the like) of the display units 71 to 79 can be easily changed. Also, the size of a memory which is required for the image processing and is used to refer to neighboring pixels can be reduced compared to a case wherein image processing is executed without dividing the entire frame.

### Fifth Embodiment

The fifth embodiment of the present invention will be described in detail hereinafter.

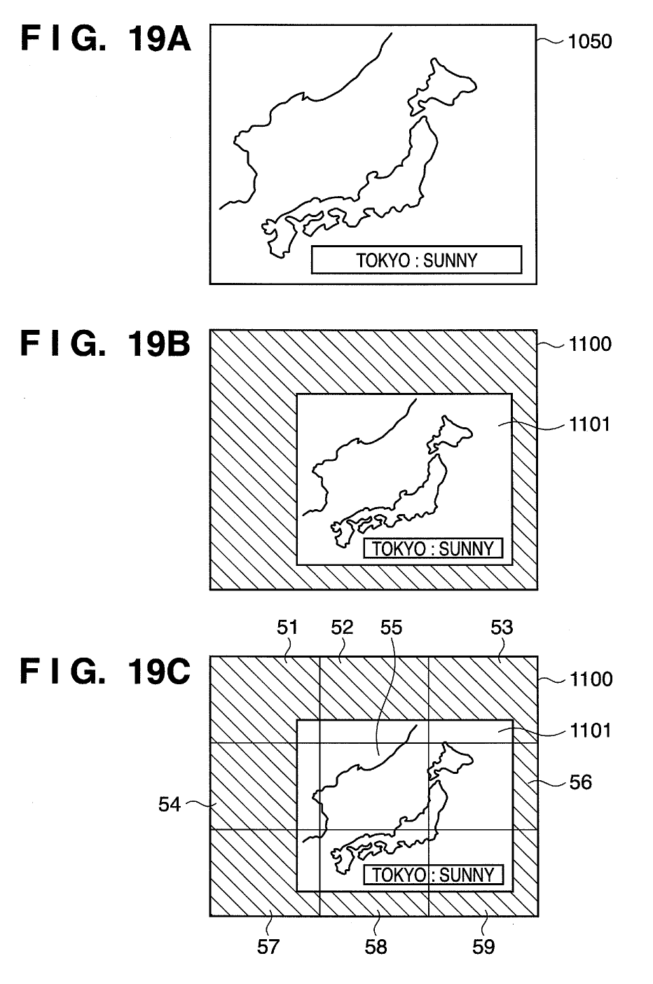

In the fourth embodiment, the case has been explained wherein the image content 1050 is displayed on the entire screen defined by the display screens 51 to 59 of the display units 71 to 79. By contrast, this embodiment will explain a case wherein the image content 1050 is displayed on some of the display screens 51 to 59 of the display units 71 to 79. More specifically, in this embodiment, the multi-display server 63 designates a layout of an image content. Each of the display units 71 to 79 calculates its own assigned display region using the designated layout, and determines if image data packets 1090a belong to the calculated assigned display region. In this manner, in this embodiment, some steps of the software processing required to display the image contents are different from the fourth embodiment. Therefore, the same reference numerals denote the same components and processes as those in FIGS. 13 to 18 of the fourth embodiment, and a detailed description thereof will not be repeated.

<Display Example of Multi-Display System (FIGS. 19A to 19C)>

FIGS. 19A to 19C show a display example in the multi-display system 61 (display units 71 to 79). In this embodiment, the image content is laid out and displayed at a position designated by the multi-display server 63 based on a user's instruction.

FIG. 19A shows an example of an image content. As in FIG. 13A, the image content 1050 is configured by a weather chart object and a text data object for the weather chart.

FIG. 19B shows a layout example of the image content 1050. FIG. 19B exemplifies a case wherein a contents window 1101 that displays the image content 1050 in a reduced scale is laid out near the lower right corner of a display screen 1100.

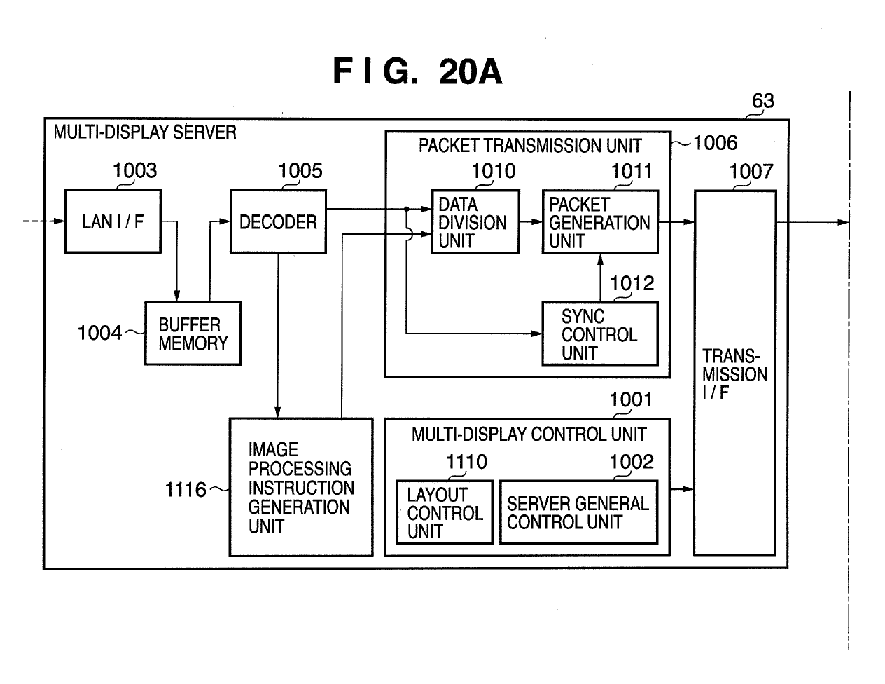

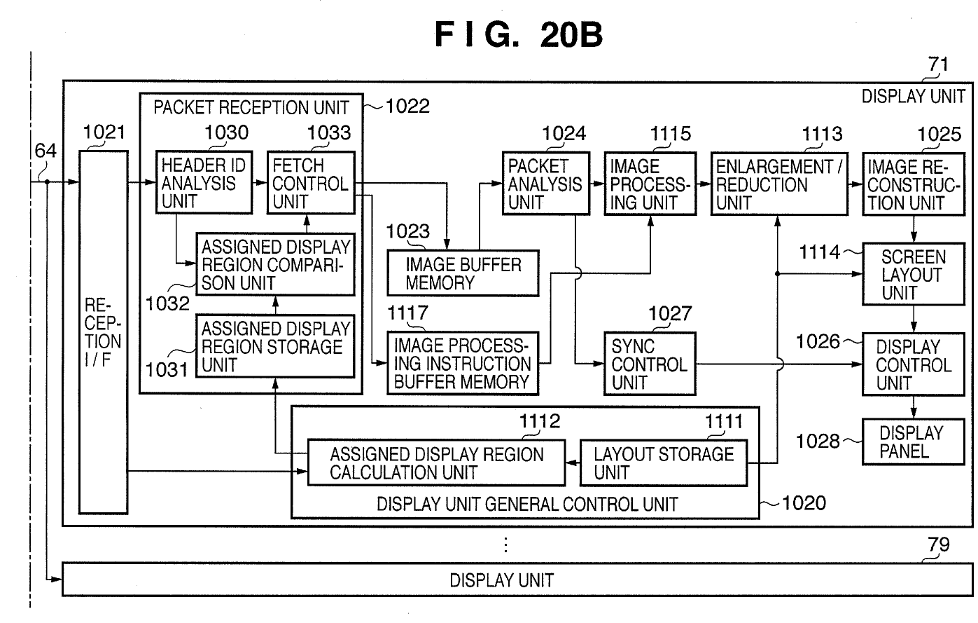

FIG. 19C shows a display example when the image content 1050 is displayed using the display units 71 to 79. The display screens 51 to 59 are those of the display units 71 to 79, respectively. As in the fourth embodiment, in FIG. 19C, by combining the nine display units 71 to 79, a single display screen of a 3×3 matrix (3 rows×3 columns) is configured. FIG. 19C shows an example in which the image content 1050 is displayed on the display screen configured by combining the nine display units 71 to 79 in this way according to the layout example shown in FIG. 19B. Each of the display units 71 to 79 displays a part of the original image content 1050 according to its assigned display region. In this case, the assigned display regions of the display units 71 to 79 change depending on the layout designated by the multi-display server 63. For example, in FIG. 19C, only an upper left portion of the contents window 1101 is the assigned display region of the display unit 71. In this manner, by combining the display screens 51 to 59 of the display units 71 to 79, as shown in FIG. 19C, and laying out and displaying the image content 1050 according to the layout, the entire original image content 1050 is displayed.

<Internal Arrangement and Operation of Multi-Display Server (FIG. 20A)>

FIGS. 20A and 20B are block diagrams showing an example of the detailed arrangement of the multi-display system 61. The arrangement of the multi-display server 63 will be described below with reference to FIG. 20A.

Referring to FIG. 20A, the multi-display server 63 decodes data received from the contents server 60, packetizes the decoded data, and transmits generated packets to the display units 71 to 79.

The multi-display control unit 1001 which controls the overall multi-display system 61 includes a layout control unit 1110 in addition to the server general control unit 1002 shown in FIG. 16A. The layout control unit 1110 inputs and stores layout instruction information of the image content (layout instruction command) from the user (e.g., the client terminal 65 or contents server 60). The layout control unit 1110 transmits the layout instruction information to the display units 71 to 79 using the transmission interface 1007. The layout instruction information of the image content includes, e.g., the position coordinates of a region where the image content is laid out. In this case, the layout control unit 1110 can set upper left coordinates (Xmin, Ymin) and lower right coordinates (Xmax, Ymax) of the reduced-scale image of the contents window 1101 displayed on the display screen 1100 shown in FIGS. 19B and 19C as the layout instruction information of the image content. Also, the layout control unit 1110 may set the upper left coordinates of the contents window 1101 displayed on the display screen 1100 in FIGS. 19B and 19C and the size of the contents window 1101 as the layout instruction information of the image content.

As for the operation of the multi-display server 63, in the flowchart shown in FIG. 17, the layout control unit 1110 inputs and stores layout instruction information of the image content before the process of step S1010 or S1016 (e.g., before the process of step S1001). The layout control unit 1110 then transmits the stored layout instruction information of the image content to the display units 71 to 79 before the process of step S1010 or S1016 (e.g., before step S1001). The example of other operations of the multi-display server 63 is the same as that shown in FIG. 17, and a repetitive description thereof will be avoided.

In the following description, the instruction information for a layout of the image content will be referred to as layout instruction information as needed.

<Internal Arrangement and Operation of Display Unit (FIG. 20B)>

The arrangement of each of the display units 71 to 79 will be described below with reference to FIG. 20B. Note that the display units 71 to 79 have the same arrangement. Hence, the arrangement of only the display unit 71 will be explained, and a description of the arrangement of the remaining display units 72 to 79 will not be given.

Referring to FIG. 20B, the display unit 71 calculates its own assigned display region based on the layout instruction information transmitted from the multi-display server 63. The display unit 71 determines if image data packets 1090a transmitted from the multi-display server 63 belong to the calculated assigned display region. The display unit 71 applies image processing to only the image data packets 1090a which belong to its own assigned display region, and reclaims and displays a part of the image content.

The display unit general control unit 1020 controls components which form the display unit 71. In this embodiment, the display unit general control unit 1020 newly includes a layout storage unit 1111 and assigned display region calculation unit 1112.

The layout storage unit 1111 stores the layout instruction information transmitted from the layout control unit 1110 of the multi-display server 63. The assigned display region calculation unit 1112 calculates its own assigned display region based on the layout instruction information stored in the layout storage unit 1111, and stores the calculation result in the assigned display region storage unit 1031. In this way, the assigned display region calculated by the assigned display region calculation unit 1112 is obtained by correcting that stored in the assigned display region storage unit 1031 in accordance with the contents of the layout instruction information. More specifically, the assigned display region storage unit 1031 stores the coordinate ID range of rectangular tiles which belong to its own assigned display region.

The assigned display region comparison unit 1032 determines if the position coordinate IDs stored in the tile coordinate ID fields 1095 of each incoming image data packet 1090a and image processing instruction data packet 1090b are included in the coordinate ID range stored in the assigned display region storage unit 1031. If the position coordinate IDs in the tile coordinate ID fields 1095 of the incoming packets 1090a and 1090b are included in the coordinate ID range stored in the assigned display region storage unit 1031, the fetch control unit 1033 fetches these incoming packets 1090a and 1090b. The fetch control unit 1033 writes the image data packet 1090a in the image buffer memory 1023, and the image processing instruction packet 1090b in the image processing instruction buffer 1117.

On the other hand, if the position coordinate IDs in the tile coordinate ID fields 1095 of the incoming packets 1090a and 1090b are not included in the coordinate ID range stored in the assigned display region storage unit 1031, the assigned display region comparison unit 1032 discards the incoming packets 1090a and 1090b without accepting them.

When the boundaries of the assigned display regions of the display units 71 to 79 are different from those of rectangular tile regions, both of the two display units on the two sides of the boundary extract only assigned display regions and discard unnecessary parts as in the fourth embodiment.

The packet analysis unit 1024 extracts the image content data (each payload 1092) of rectangular tiles from the image data packets 1090a. The packet analysis unit 1024 sorts processes for the extracted image content data of rectangular tiles in accordance with information in the packet header 1091.

The image processing unit 1115 receives image processing instruction commands corresponding to the image content data divided into rectangular tiles from the image processing instruction buffer memory 1117. The image processing unit 1115 applies image processing according to the image processing instruction commands to the image content data divided into rectangular tiles.

An enlargement/reduction unit 1113 applies enlargement processing or reduction processing to the image content data of rectangular tiles in accordance with the layout instruction information stored in the layout storage unit 1111. The image reconstruction unit 1025 reclaims a part of the original image content by combining the image content data of rectangular tiles. A screen layout unit 1114 generates display data so that the image content combined by the image reconstruction unit 1025 is laid out at the position according to the layout instruction information stored in the layout storage unit 1111. The display control unit 1026 displays the display data generated by the screen layout unit 1114 on the display panel 1028 under the control of the sync control unit 1027.

As for the operation of the display units 71 to 79, in the flowcharts shown in FIGS. 18A and 18B, the layout storage unit 1111 stores the layout instruction information transmitted from the layout control unit 1110 of the multi-display server 63 before step S1032. Furthermore, the assigned display region calculation unit 1112 calculates the coordinate ID range that represents its own assigned display region based on the layout instruction information stored in the layout storage unit 1111 and stores the calculation result in the assigned display region storage unit 1031 before step S1032. The assigned display region comparison unit 1032 determines in step S1032 if the position coordinate ID stored in the tile coordinate ID field 1095 of the image data packet 1090a which is determined to be input in step S1031 is included in the coordinate ID range calculated by the assigned display region calculation unit 1112.

Between steps S1028 and S1029, the enlargement/reduction unit 1113 applies enlargement or reduction processing to the image content data of a rectangular tile that has undergone the image processing in accordance with the layout instruction information stored in the layout storage unit 1111.

Furthermore, between steps S1029 and S1030, the screen layout unit 1114 executes processing for generating display data so that the image content combined by the image reconstruction unit 1025 is laid out at the position according to the layout instruction information stored in the layout storage unit 1111.

In step S1030, the display control unit 1026 displays the display data generated by the screen layout unit 1114 on the display panel 1028 under the control of the sync control unit 1027.

Other operations of the display units 71 to 79 are the same as those shown in FIGS. 18A and 18B, and a repetitive description thereof will be avoided.

By configuring the display units 71 to 79 as described above, each of the display units 71 to 79 can accept only image data packets 1090a and image processing instruction packets 1090b within its own assigned display region according to the designated layout, and can reclaim and display the image content.

In this embodiment, the multi-display server 63 generates layout instruction information that instructs a layout of the image content and transmits the generated information to the display units 71 to 79. Each of the display units 71 to 79 calculates the coordinate ID range that represents the assigned display region of the image content based on the layout instruction information. Each of the display units 71 to 79 accepts (receives) an image data packet 1090a and image processing instruction packet 1090b only when the position coordinate IDs included in these packets 1090a and 1090b are included in the calculated coordinate ID range. Each of the display units 71 to 79 displays an image corresponding to the assigned display region of the image content using the accepted (received) image data packets 1090a and image processing instruction packets 1090b.

Therefore, in addition to the effects described in the fourth embodiment, the layout upon displaying the image content can be freely set.

In the example described in this embodiment, the image content data transmitted from the contents server 60 is a single image stream. Alternatively, a plurality of image streams may be transmitted, and a plurality of image contents may be displayed on the single display screen 1100. In this case, the second to n-th image contents (n is a natural number equal to or larger than 2) can be laid out in the first image content (picture-in-picture display can be attained). Alternatively, the second to n-th image contents can be laid out around the first image content (side-by-side display can be attained).

This embodiment can also adopt various modifications described in the fourth embodiment.

### Sixth Embodiment

The sixth embodiment of the present invention will be described in detail hereinafter. The fifth embodiment has exemplified the case wherein the display units 71 to 79 display the image content after layout in accordance with the layout instruction information transmitted from the multi-display server 63. By contrast, this embodiment will exemplify a case wherein layout instruction information (layout instruction commands) is also packetized and the packets are transmitted from the multi-display server 63 to the display units 71 to 79.

Note that a layout instruction command packet that packetizes the layout instruction commands stores layout instruction commands together for respective coordinate regions (rectangular tile regions). A packet header of the layout instruction command packet includes a field indicating a range of regions to which the layout commands are to be applied.

Each of display units 71 to 79 determines if a region to which a layout instruction command packet transmitted from the multi-display server 63 is applied is included in its own assigned display region. Each of the display units 71 to 79 accepts (receives) only layout instruction command packets to be applied to its own assigned display region, and lays out the image content based on the accepted layout instruction command packets.

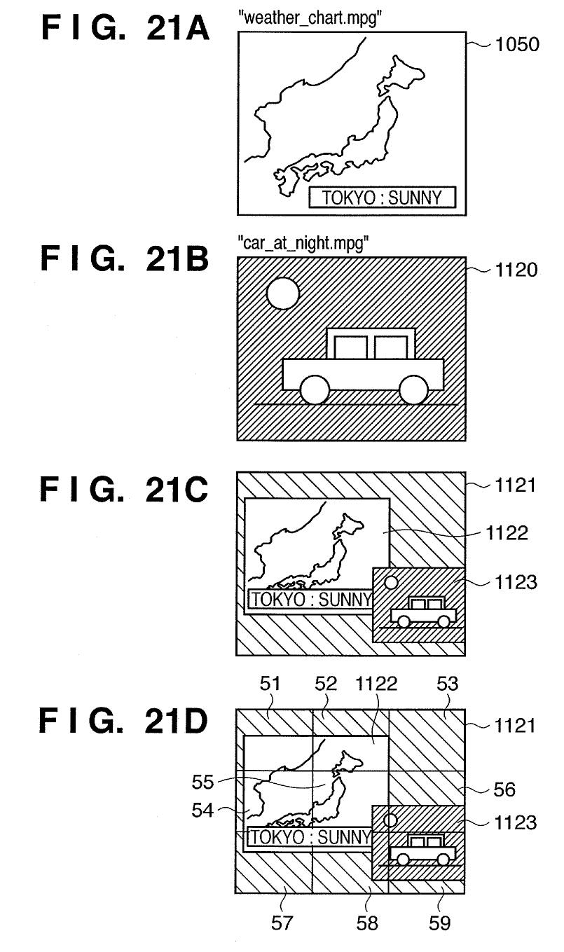

As described above, in this embodiment, some steps of software processing required to lay out the image content are mainly different from the fourth and fifth embodiments. Therefore, the same reference numerals denote the same components and processes as those in FIGS. 13A to 20 of the fourth and fifth embodiments, and a detailed description thereof will not be repeated.

<Display Example of Multi-Display System (FIGS. 21A to 21D)>

FIGS. 21A to 21D show a display example in the multi-display system 61 (display units 71 to 79). In this embodiment, a plurality of image contents are laid out and displayed at designated positions.

FIGS. 21A and 21B show examples of image contents. The image content 1050 shown in FIG. 21A is configured by a weather map object and a text data object for the weather map as in FIGS. 13A and 19A, and has a file name “weather_chart.mpg”. On the other hand, an image content 1120 shown in FIG. 21B is configured by a car object, road object, and moon object, and has a file name “car_at_night.mpg”.

FIG. 21C shows a layout example of the image contents 1050 and 1120. FIG. 21C exemplifies a case wherein contents windows 1122 and 1123 which respectively display the image contents 1050 and 1120 in a reduced scale are displayed on a display screen 1121.

FIG. 21D shows a display example when the image contents 1050 and 1120 are displayed using the display units 71 to 79. The display screens 51 to 59 are those of the display units 71 to 79, respectively. As in the fourth and fifth embodiments, in FIG. 21D, by combining the nine display units 71 to 79, a single display screen of a 3×3 matrix (3 rows×3 columns) is configured.

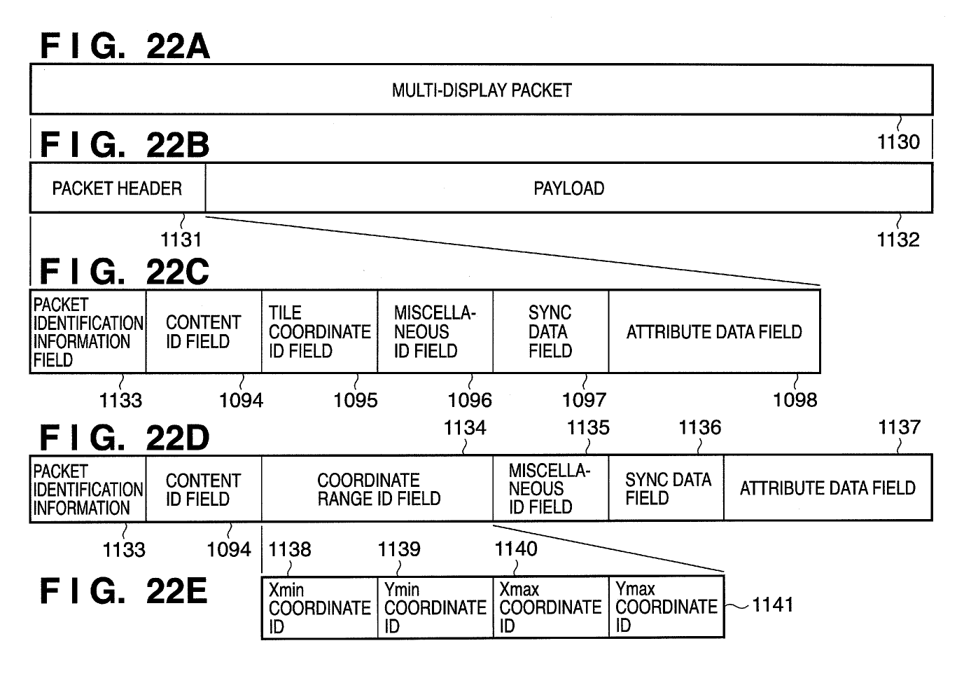

In this case, the assigned display regions of the display units 71 to 79 change depending on the layout designated by the multi-display server 63. For example, in FIG. 21D, only an upper left portion of the contents window 1122 is the assigned display region of the display unit 71.

<Configuration of Multi-Display Packet (FIGS. 22A to 22E)>

FIGS. 22A to 22E show an example of the configuration of a multi-display packet. The configuration of a packet used in transmission in the multi-display system 61 will be described below with reference to FIGS. 22A to 22E. The multi-display packet of this embodiment is configured by three types of packets, i.e., an image data packet, image processing instruction packet, layout instruction command packet. The layout instruction command packet stores layout instruction information for respective coordinate regions (rectangular tile regions). A packet header of this packet includes a field indicating the range of rectangular tile regions which undergo layout based on the layout instruction information.

FIG. 22A shows a multi-display packet 1130. FIG. 22B is a view for explaining the configuration of the multi-display packet 1130. As shown in FIG. 22B, the multi-display packet 1130 has a packet header 1131 and payload 1132. The payload 1132 stores image data of a rectangular tile or layout commands.

FIG. 22C shows an example of the header configuration of the image data packet. In this header configuration, the contents of the packet identification information field are different from the image data packet 1090a described in the fourth and fifth embodiments. Referring to FIG. 22C, a packet identification information field 1133 stores ID information required to identify whether or not a packet of interest is a multi-display packet, version information, and the like. Furthermore, the packet identification information field 1133 also stores ID information required to identify whether a packet of interest is an image data packet, image processing instruction packet, or layout instruction command packet. Since FIG. 22C shows the header configuration of an image data packet, the packet identification information field 1133 shown in FIG. 22C stores ID information used to identify that the packet of interest is an image data packet. Note that the image processing instruction packet also has the same header information as in FIG. 22C.

FIG. 22D shows an example of the header configuration of a layout instruction command packet. A packet identification information field 1133 shown in FIG. 22D stores ID information used to identify that the packet of interest is a layout instruction command packet.

The content ID field 1094 stores ID information required to identify the image content. A coordinate range ID field 1134 stores ID information required to identify the range of target rectangular tile regions of the layout instruction information. A miscellaneous ID field 1135 stores miscellaneous IDs required to identify the range of the rectangular tile regions. For example, the miscellaneous ID field 1135 stores a frame number and the like. A sync data field 1136 stores various time stamps indicating time information such as the processing start time, processing end time, and the like of the image content 1050 or 1120 identified by the ID information stored in the content ID field 1094. An attribute data field 1137 stores various kinds of attribute information required to process the range of the rectangular tile regions.

FIG. 22E shows an example of the configuration of the coordinate range ID field 1134. As shown in FIG. 22E, the coordinate range ID field 1134 is configured by four fields; an Xmin coordinate ID field 1138, Ymin coordinate ID field 1139, Xmax coordinate ID field 1140, and Ymax coordinate ID field 1141, which respectively store the IDs of corresponding rectangular tile regions. In this way, a plurality of rectangular tile regions can be designated.

A simple practical example of the layout instruction command packet will be described below. For example, the multi-display system 61 is configured using the nine display units 71 to 79, as shown in FIG. 21D. Then, assume that the image content 1050 or 1020 is displayed on the 3×3 display screens 51 to 59 at a resolution (1920×1080 pixels) of a high-resolution image, as shown in FIG. 21D. Furthermore, assume that an instruction to lay out the contents window 1122 on pixels (50, 100) to (1250, 800), and the contents window 1123 on pixels (1000, 500) to (1919, 900) is issued as layout instruction commands.

The layout instruction command packet combines commands for respective rectangular tile regions, and is divided into, e.g., two packets. The divided first layout instruction command packet is generated to include a layout instruction of the contents window 1122, and the second layout instruction command packet is generated to include a layout instruction of the contents window 1123.

The coordinate range IDs are determined as follows. If the size of each rectangular tile region is 16×16 pixels, the image content data (frame) is divided into 120×68 rectangular tile regions. The contents window 1122 includes the range of rectangular tile regions (3, 6) to (78, 50), and the contents window 1123 includes the range of rectangular tile regions (62, 31) to (119, 56). Therefore, as ID information values to be stored in the coordinate range ID field 1134 of the first layout instruction command packet, the Xmin coordinate ID field 1138 stores “3”, the Ymin coordinate ID field 1139 stores “6”, the Xmax coordinate ID field 1140 stores “78”, and the Ymax coordinate ID field 1141 stores “50”.

As a result, parameters of the layout instruction command packets can be generated as follows.

First layout instruction command packet:

Packet header:
Coordinate range IDs:
Xmin coordinate ID: 3
Ymin coordinate ID: 6
Xmax coordinate ID: 78
Ymax coordinate ID: 50
Payload:
<video x =“50” y=“100” width=“1200” height=“700”

xlink:href=“weather_chart.mpg”/>

Second layout instruction command packet:

Packet header:
Coordinate range IDs:
Xmin coordinate ID: 62
Ymin coordinate ID: 31
Xmax coordinate ID: 119
Ymax coordinate ID: 56
Payload:
<video x =“1000” y=“500” width=“920” height=“400”

xlink:href=“car_at_night.mpg”/>

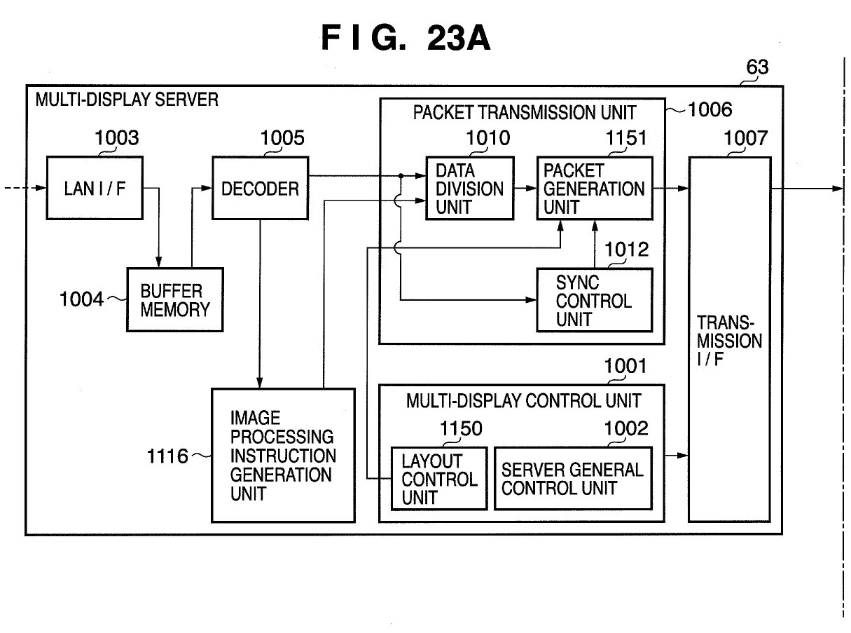

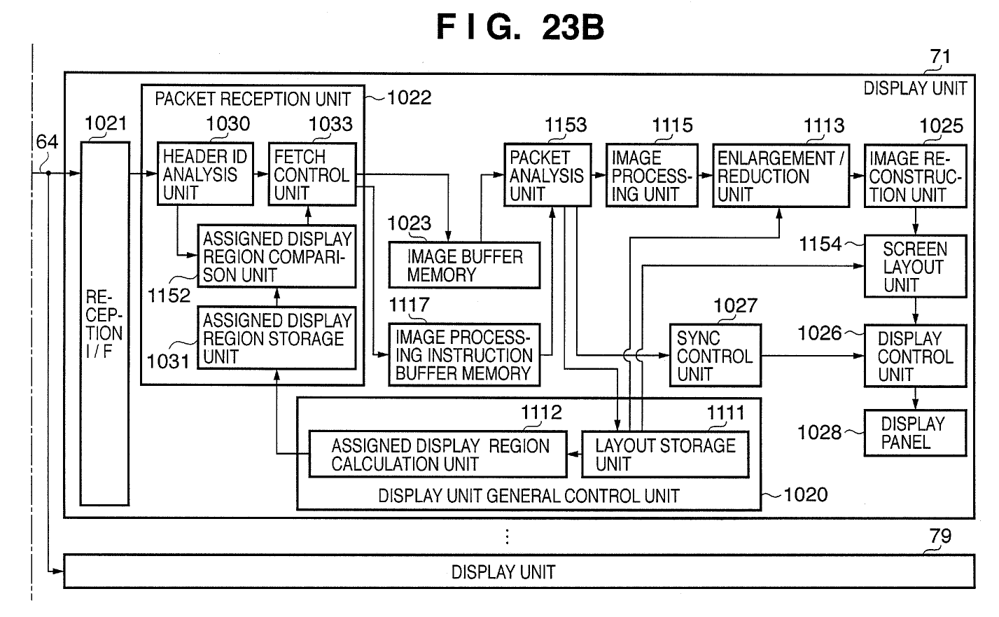

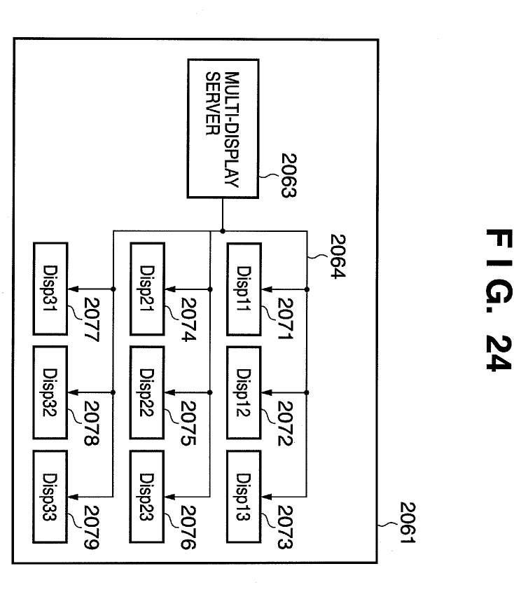

By configuring the layout instruction command packets as described above, each of the display units 71 to 79 can determine if the layout instruction command packet corresponds to its own assigned display region by referring to only the coordinate range IDs. That is, each of the display units 71 to 79 need only receive the layout instruction command packet of the assigned display region and execute layout processing.

<Internal Arrangement and Operation of Multi-Display Server (FIG. 23A)>

FIGS. 23A and 23B are block diagrams showing an example of the detailed arrangement of the multi-display system 61. The arrangement of the multi-display server 63 will be described below with reference to FIG. 23A.

Referring to FIG. 23A, the multi-display server 63 divides the layout instruction information into those for respective coordinate regions (rectangular tile regions), and packetizes and transmits them. In this embodiment, the operations of the layout control unit 1150 and a packet generation unit 1151 are different from the fifth embodiment shown in FIG. 20A. The layout control unit 1150 combines layout instruction information for respective coordinate regions (rectangular tile regions), and outputs the combined information to the packet generation unit 1151. A coordinate region (rectangular tile region) is set to be an arbitrary size.

The packet generation unit 1151 generates a multi-display packet 1130 with the configuration shown in FIGS. 22A to 22E. The packet generation unit 1151 generates image data packets in case of image content data, and layout instruction command packets in case of layout commands.

Upon transmitting multi-display packets 1130 from the multi-display server 63 to the display units 71 to 79, the packet generation unit 1151 generates multi-display packets 1130 associated with layout commands first, and transmits them to the display units 71 to 79. After that, after layout settings are executed in the display units 71 to 79, the packet generation unit 1151 begins to transmit multi-display packets 1130 associated with data of image contents.

As for the operation of the multi-display server 63, the following processes are executed before the process of step S1010 or S1016 (e.g., before the process of step S1001) in the flowchart shown in FIG. 17. The layout control unit 1150 inputs the layout instruction information (layout instruction commands) of image contents, and combines them for respective coordinate regions (rectangular tile regions). The packet generation unit 1151 packetizes the layout instruction information combined for respective coordinate regions (rectangular tile regions) by the layout control unit 1150 to generate multi-display packets 1130 associated with the layout instruction information. The transmission interface 1007 then transmits the multi-display packets 1130 associated with the layout instruction information to the display units 71 to 79. Then, the processes in steps S1001 to S1011 in FIG. 17 are executed to transmit multi-display packets 1130 associated with the data of the image contents to the display units 71 to 79.

<Internal Arrangement and Operation of Display Unit (FIG. 23B)>

The arrangement of each of the display units 71 to 79 will be described below with reference to FIG. 23B. Note that the display units 71 to 79 have the same arrangement. Hence, the arrangement of only the display unit 71 will be explained, and a description of the arrangement of the remaining display units 72 to 79 will not be given.

Referring to FIG. 23B, the display unit 71 inputs layout instruction information (layout instruction command) as layout instruction command packets, and executes the layout processing of the display screen based on the input layout instruction command packets. Upon input of the layout instruction command packets, the display unit 71 determines if the target region of each layout instruction command packet falls within its own assigned display region, and accepts (receives) only the layout instruction command packets within its own assigned display region.

In FIG. 23B, in the display unit 71 of this embodiment, the operations of an assigned display region comparison unit 1152, packet analysis unit 1153, and screen layout unit 1154 are different compared to the display unit 71 of the fifth embodiment.

The assigned display region comparison unit 1152 determines if each layout instruction command packet, image data packet, and image processing instruction packet belong to its own assigned display region. As for the layout instruction command packet, the assigned display region comparison unit 1152 determines if the application target region of the layout instruction command packet is included in the assigned display region assigned to its own unit. That is, the assigned display region comparison unit 1152 determines if the value of the coordinate range ID field 1134 in the layout instruction command packet is included in the coordinate ID range set in the assigned display region storage unit 1031, as described in the fourth embodiment. On the other hand, as for the image data packet and image processing instruction packet, the assigned display region comparison unit 1152 determines if the position coordinate ID stored in the tile coordinate ID field 1095 of each of these packets is included in the coordinate ID range calculated (corrected) by the assigned display region calculation unit 1112 based on the layout instruction command packet.

The packet analysis unit 1153 extracts data of the multi-display packet 1130 from the image buffer memory 1023. The packet analysis unit 1153 sorts the processes for the extracted data of the multi-display packet 1130 in accordance with the information in the packet header 1131. If the multi-display packet 1130 is a layout instruction command packet, the packet analysis unit 1153 outputs the data of the multi-display packet 1130 to the layout storage unit 1111. The layout storage unit 1111 stores layout instruction information based on the layout instruction command packet.

On the other hand, if the multi-display packet 1130 is an image data packet, the packet analysis unit 1153 outputs the data of the multi-display packet 1130 to the image processing unit 1115.

The screen layout unit 1154 generates display data that lays out the contents windows 1122 and 1123 at the positions according to the layout instruction information stored in the layout storage unit 1111. In this case, when the contents windows 1122 and 1123 overlap each other, the screen layout unit 1154 executes overlapping or overwrite processing with a transparency or the like in accordance with the layout instruction commands stored in the layout storage unit 1111.

The image processing unit 1115, enlargement/reduction unit 1113, image reconstruction unit 1025, display unit general control unit 1020, and packet reception unit 1022 are configured to parallelly execute the processes for the plurality of contents windows 1122 and 1123. In this case, the image processing unit 1115, enlargement/reduction unit 1113, image reconstruction unit 1025, display unit general control unit 1020, and packet reception unit 1022 may time-divisionally process the contents windows 1122 and 1123. Furthermore, a plurality of image processing units 1115, enlargement/reduction units 1113, image reconstruction units 1025, display unit general control units 1020, and packet reception units 1022 may be equipped to execute parallel processes.

With the above arrangement, each of the display units 71 to 79 receives only the layout instruction command packets within it own assigned display region, and can lay out and display the screen based on the received layout instruction command packets.

As for the operations of the display units 71 to 79, the reception interface 1021 receives layout instruction command packets before step S1032 in the flowcharts shown in FIGS. 18A and 18B. The assigned display region comparison unit 1152 determines if the application target region of each input layout instruction command packet is included in its own assigned display region. This determining process is attained based on the value of the coordinate range ID field 1134 in the layout instruction command packet, and the coordinate ID range stored in the assigned display region storage unit 1031.

The fetch control unit 1033 accepts (receives) only layout instruction command packets to be applied to its own assigned display region, and discards other layout instruction command packets. After that, the packet analysis unit 1153 analyzes the accepted (received) layout instruction command packets, and stores layout instruction commands in the layout storage unit 1111 based on the analysis result. Furthermore, the assigned display region calculation unit 1112 calculates its own assigned display region based on the layout instruction commands stored in the layout storage unit 1111, and rewrites the coordinate IDs of rectangular tiles stored in the assigned display region storage unit 1031.

The assigned display region comparison unit 1152 determines in step S1032 if the position coordinate ID stored in the tile coordinate ID field 1095 of the image data packet determined to be input in step S1031 is included in the rewritten coordinate IDs of the rectangular tiles.

Between steps S1028 and S1029, the enlargement/reduction unit 1113 applies enlargement processing or reduction processing to image content data of rectangular tiles in accordance with the layout instruction information stored in the layout storage unit 1111.

Furthermore, between steps S1029 and S1030, the screen layout unit 1154 executes processing for generating display data that lays out the image content combined by the image reconstruction unit 1025 at the position according to the layout instruction commands stored in the layout storage unit 1111.

In step S1030, the display control unit 1026 displays the display data generated by the screen layout unit 1154 on the display panel 1028 under the control of the sync control unit 1027.

Other operations of the display units 71 to 79 are the same as those shown in FIGS. 18A and 18B, and a repetitive description thereof will be avoided.

In this embodiment, the multi-display server 63 generates layout instruction command packets by packetizing the layout instruction information that instructs the layout of image contents, and transmits them to the display units 71 to 79. Each of the display units 71 to 79 calculates the assigned display region of the image contents based on the layout instruction command packets. Each of the display units 71 to 79 accepts (receives) a given image data packet only when the position coordinate ID included in that image data packet is included in the calculated assigned display region of the image contents. Each of the display units 71 to 79 displays an image corresponding to the assigned display region of the image content using the accepted (received) image data packets.

As described above, since the image content data and layout instruction information (layout instruction commands) are transmitted using packet communications of the same communication scheme, the image content data and layout instruction commands can be handled by the same packet processing system. Therefore, in addition to the effects described in the fifth embodiment, the interface can be simplified.

In this embodiment, layout instruction command packets are divisionally generated for respective contents. However, layout instruction commands may be packetized without being divided. In such case, each of the display units 71 to 79 may accept (receive) all layout instruction command packets, and may extract and process only commands corresponding to its own assigned display region.

Also, each image data packet may include layout instruction commands. For example, the layout instruction commands may be described in the miscellaneous ID field 1096 in the image data packet. In this way, a reception failure of image data packets can be prevented when the multi-display packets associated with layout instruction commands are delayed.

This embodiment can also adopt various modifications described in the fourth and fifth embodiments.

### Seventh Embodiment

The seventh embodiment of the present invention will be described in detail hereinafter.

In this embodiment, a multi-display system includes a multi-display server which supplies a rendering command of an image content, and a plurality of display units each of which displays a part of the image content, and which display the entire contents as a whole. The rendering command is divided into a plurality of commands, and is supplied from the multi-display server to the display units in the form of packet data. Each display unit determines if the rendering command included in the packet data corresponds to its own assigned display region. Each display unit accepts only the rendering command for its own assigned display region, performs rendering according to the accepted rendering command, and displays an image of its own assigned display region on a screen. This embodiment will explain such multi-display system.

<Description of Schematic Arrangement of Multi-Display System (FIG. 24)>

FIG. 24 is a schematic block diagram showing an example of the overall arrangement of the multi-display system.

Referring to FIG. 24, a multi-display system 2061 inputs image content data from a external contents server, and displays the input image content data. A display is made on a screen defined by combining display units (Displ1 to Disp33) 2071 to 2079 of 3 rows×3 columns.

In the multi-display system 2061, a multi-display server 2063 generates a rendering command of an image content, packetizes the generated rendering command, and supplies image data packets including the packetized rendering commands to respective display units 2071 to 2079. A communication path 2064 is used to supply the image data packets to the respective display units 2071 to 2079. The communication path 2064 includes, for example, a LAN (Local Area Network) WAN (Wide Area Network), or a network such as the Internet or the like.

The display units 2071 to 2079 receive the image data packets including the packetized rendering commands supplied from the multi-display server 2063. At this time, each of the respective display units 2071 to 2079 accepts only an image data packet including the rendering command corresponding to its own assigned display region. Each of the display units 2071 to 2079 displays a part of the image content by executing rendering according to the rendering command included in the accepted image data packet. The display units 2071 to 2079 include display panels of various systems such as an LCD (Liquid Crystal Display), plasma display, or the like. Note that at least one of the display units 2071 to 2079 may include a display panel of a system different from the remaining display units. By increasing the display screen size of the display units 2071 to 2079 or increasing the number of display units to be combined, a display on a larger screen size can be attained.

Various methods of setting the display assigned regions of the display units 2071 to 2079 are available, and an arbitrary method may be used. As the simplest method, a method of explicitly setting these regions by the user is available. When the user operates switches and the like provided to the display units 2071 to 2079, the user can set the assigned display region of the display unit having the corresponding switch. Alternatively, for example, an external client terminal may transmit information used to instruct the assigned display regions of the display units 2071 to 2079 to the multi-display server 2063, which may set the assigned display regions of the display units 2071 to 2079.

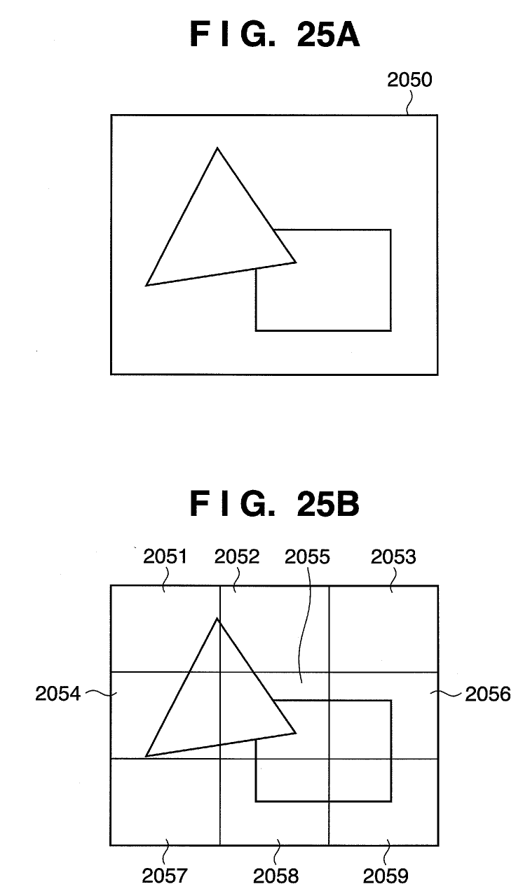

The display units 2071 to 2079 can be attached to a frame-like guide member. The user fits the display units 2071 to 2079 into a guide member which can support the display units 2071 to 2079 arranged in a 3×3 matrix (3 rows×3 columns). Furthermore, the user connects power cables and signal cables to these display units 2071 to 2079. In this way, the display units 2071 to 2079 configure a large screen. By assigning identifiers unique to the display units 2071 to 2079 according to their attached positions, identification of the display units 2071 to 2079 and specification of their positions can be made. Sensors may be provided to the coupled surfaces of the display units 2071 to 2079, and the positions of the display units 2071 to 2079 may be specified based on the detection results of the sensors. For example, sensors are provided in four directions (e.g., top surface, bottom surface, and two side surfaces) where the display units 2071 to 2079 can be coupled. After the display units 2071 to 2079 are coupled, they exchange IDs with coupled partners using the sensors. In this manner, by making up the IDs held by the display units 2071 to 2079, their positions can be specified.

<Display Example of Multi-Display System (FIGS. 25A and 25B)>

FIGS. 25A and 25B show a display example in the multi-display system 2061 (display units 2071 to 2079).

FIG. 25A shows an example of an image content obtained by rendering the rendering command. An image content 2050 is obtained by rendering a rendering command required to render a rectangle, and that required to render a triangle. That is, the image content 2050 is configured by a rectangle object and triangle object.

FIG. 25B shows a display example when the image content 2050 is displayed using the display units 2071 to 2079. Display screens 2051 to 2059 are those of the display units 2071 to 2079, respectively. In FIG. 25B, by combining the nine display units 2071 to 2079, a single display screen of a 3×3 matrix (3 rows×3 columns) is configured.

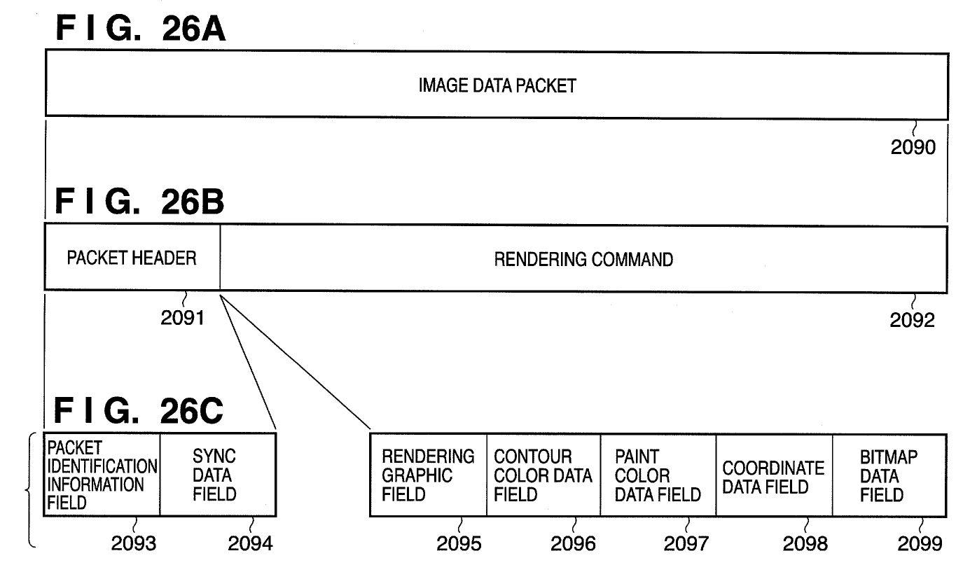

In this manner, FIG. 25B shows an example in which the image content 2050 shown in FIG. 25A is displayed on the display screen configured by combining the nine display units 2071 to 2079. Each of the display units 2071 to 2079 renders the rendering command according to its own assigned display region, and displays a part of the original image content 2050 according to the rendering result. For example, the display unit 2079 displays a lower right part of the rectangle object on the display screen 2059, and the display unit 2073 displays no graphic on the display screen 2053 since its own assigned display region does not include any rendering command. Upon combining the display screens 2051 to 2059 of the display units 2071 to 2079, as shown in FIG. 25B, the whole rendering command of the original image content 2050 can be rendered, and the entire original image content 2050 can be displayed on one screen.

<Configuration of Image Data Packet (FIGS. 26A to 26C)>

The configuration of an image data packet used in transmission in the multi-display system 2061 will be described below. FIGS. 26A to 26C show an example of the configuration of an image data packet.

FIG. 26A shows an image data packet 2090. FIG. 26B shows the configuration of the image data packet 2090. As shown in FIG. 26B, the image data packet 2090 has a packet header 2091 and rendering command 2092.

FIG. 26C shows the configurations of the packet header 2091 and rendering command 2092. A packet identification information field 2093 indicates the type of packet. The packet identification information field 2093 stores ID information required to identify whether or not the image data packet 2090 of interest is obtained by packetizing the rendering command, version information, and the like. Furthermore, the packet identification information field 2093 may also store information required for packet processing such as a packet length, check sum, and the like.

A sync data field 2094 stores various time stamps indicating a display time of the rendering result of the rendering command 2092, and the like.

A rendering graphic field 2095 stores the type of graphic to be rendered. The rendering graphic field 2095 stores the type of graphic as one of a straight line, triangle, rectangle, and ellipse. A contour color data field 2096 stores data associated with a contour color. The contour color is a color of a contour of the graphic. The contour color data field 2096 stores, for example, a total of 24-bit data obtained by expressing R, G, and B colors each by 8 bits.

A paint color data field 2097 stores data associated with a paint color. The paint color is, for example, a color of a closed region in a closed graphic such as a triangle, rectangle, or ellipse. The point color data field 2097 stores, for example, a total of 24-bit data obtained by expressing R, G, and B colors each by 8 bits. A coordinate data field 2098 stores coordinate data indicating the position of a graphic. For example, if the graphic is a straight line, triangle, or rectangle, the coordinate data field 2098 stores coordinates (X-coordinates, Y-coordinates) of vertices as many as the number of vertices of a corresponding part of the graphic. If the graphic is an ellipse, the coordinate data field 2098 stores coordinates (X-coordinates, Y-coordinates) of a corresponding part of a rectangular region (bounding box) that circumscribes the ellipse.

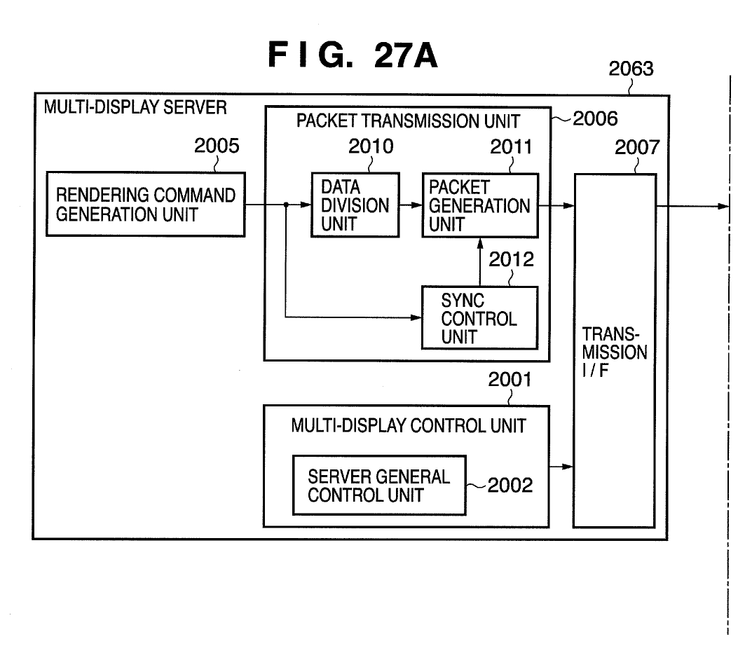

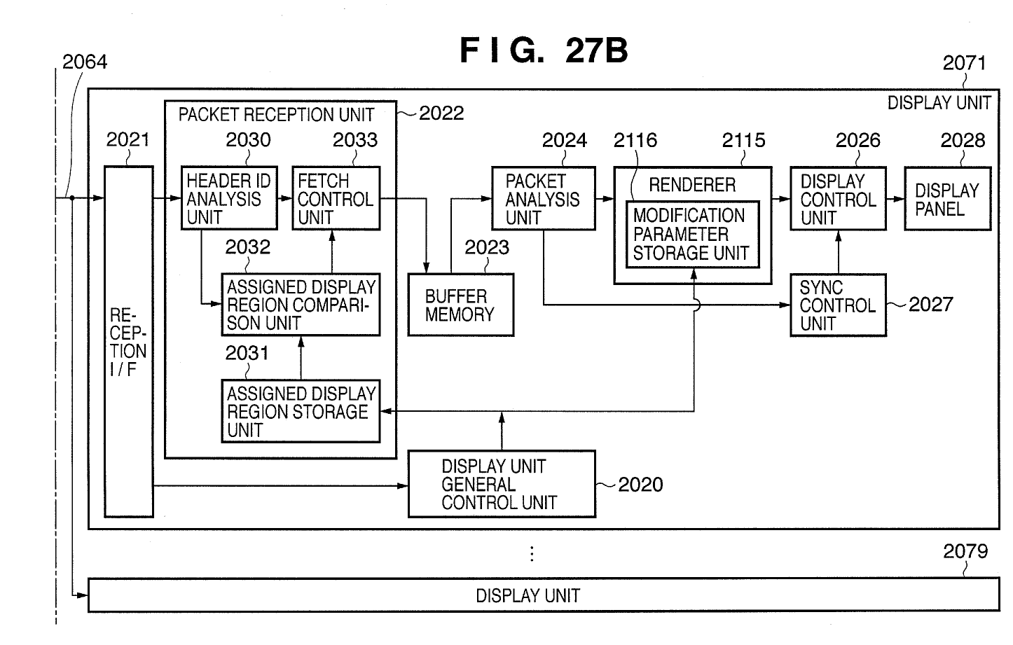

A bitmap data field 2099 stores bitmap data to be displayed within the rectangular region. In this embodiment, the bitmap data field 2099 stores, for example, non-compressed bitmap data. However, the bitmap data may be either compressed data or non-compressed pixel data.

<Internal Arrangement and Operation of Multi-Display Server (FIGS. 27A and 28)>

FIGS. 27A and 27B are block diagrams showing an example of the detailed arrangement of the multi-display system 2061. The arrangement of the multi-display server 2063 will be described below with reference to FIG. 27A.

Referring to FIG. 27A, the multi-display server 2063 generates a rendering command. The multi-display server 2063 then packetizes the generated rendering command. Furthermore, the multi-display server 2063 transmits the rendering command packets to the display units 2071 to 2079.

A multi-display control unit 2001 controls the overall multi-display system 2061. The multi-display control unit 2001 includes a CPU, memories such as a ROM, RAM, and the like, a bus, various interfaces, and the like. The multi-display control unit 2001 controls the overall system when the CPU executes programs stored in the ROM using the RAM and the like. A server general control unit 2002 controls respective elements which form the multi-display server 2063.

A rendering command generation unit 2005 generates contents to be displayed on the display units 2071 to 2079 as a rendering command. The rendering command generation unit 2005 generates time stamp information indicating the display timing of an image based on the rendering command simultaneously with or before or after generation of the rendering command. The rendering command generation unit 2005 supplies the generated time stamp information to a sync control unit 2012.

A packet transmission unit 2006 divides the rendering command in accordance with its data size (data amount), and packetizes the divided rendering commands to generate image data packets 2090. Details of the packet transmission unit 2006 will be described later. A transmission interface (transmission I/F) 2007 transmits the image data packets 2090 to the display units 2071 to 2079. The image data packets 2090 are broadcast to the display units 2071 to 2079 which are connected to the multi-display server 2063. The transmission interface 2007 independently transmits various control data generated by the multi-display control unit 2001 to the display units 2071 to 2079.

In the packet transmission unit 2006, a data division unit 2010 divides a rendering command into a plurality of commands according to its data size (data amount). A sync control unit 2012 generates internal sync control data based on time stamp information generated by the rendering command generation unit 2005. This sync control data includes time information such as transmission times to the display units 2071 to 2079, processing start times of the display units 2071 to 2079, display times of the display units 2071 to 2079, and the like. The sync control data generated by the sync control unit 2012 is stored as time stamps in the sync data field 2094 shown in FIG. 26C. Note that the sync control data is not limited to the aforementioned one, and any other kinds of information may be used as the sync control data as long as it is time information that can specify the processing start timings, display timings, and the like in the display units 2071 to 2079.

A packet generation unit 2011 generates an image data packet 2090 with the structure shown in FIGS. 26A to 26C for each of the rendering commands divided by the data division unit 2010 using the time stamps and the like generated by the sync control unit 2012.

With the aforementioned arrangement of the multi-display server 2063, a rendering command is generated and divided, the divided commands are packetized, and the rendering command packets can be transmitted to the display units 2071 to 2079.

An example of the operation of the multi-display server 2063 will be described below with reference to the flowchart of FIG. 28.

In step S2001, the rendering command generation unit 2005 waits until image content data to be displayed is input from, e.g., an external contents server via a network. Upon input of the image content data, the process advances to step S2002. After the process reaches step S2002, the rendering command generation unit 2005 generates a rendering command based on the input image content data, and time stamp information for the rendering command.

In step S2003, the data division unit 2010 divides the rendering command into a plurality of commands according to its data size (data amount).

In step S2004, the sync control unit 2012 generates internal sync control data based on the time stamp information generated by the rendering command generation unit 2005 in step S2002.

In step S2005, the packet generation unit 2011 generates image data packets 2090 with the structure shown in FIGS. 26A to 26C for respective rendering commands divided by the data division unit 2010. In this step, the packet generation unit 2011 generates data to be stored in the rendering graphic field 2095, contour color data field 2096, paint color data field 2097, coordinate data field 2098, bitmap data field 2099 based on the contents of the rendering command generated in step S2002. Furthermore, the packet generation unit 2011 generates data to be stored in the sync data field 2094 based on the sync control data generated in step S2004.

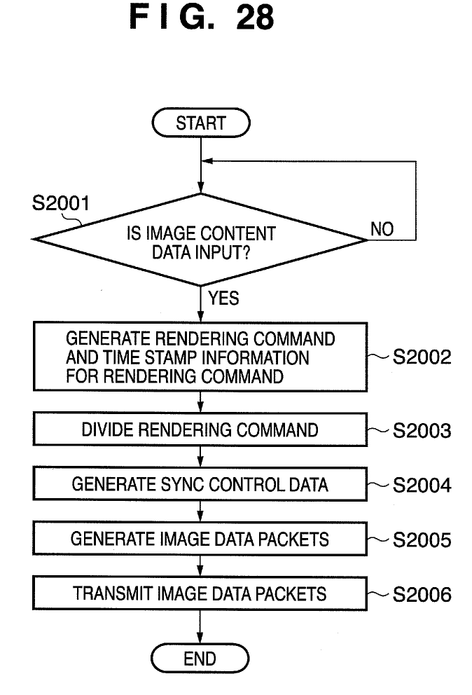

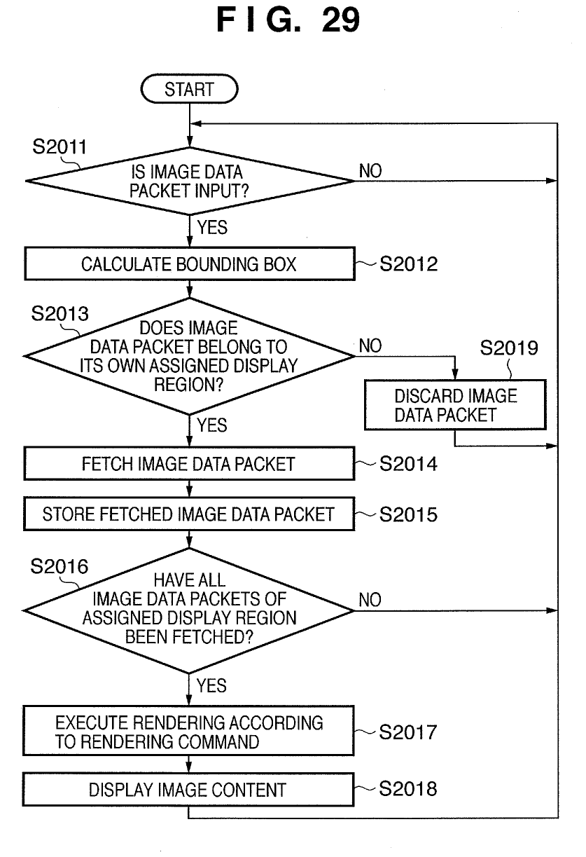

In step S2006, the server general control unit 2002 instructs the transmission interface 2007 to transmit the image data packets 2090 generated in step S2005. In this way, the image data packets 2090 are transmitted to the display units 2071 to 2079.

<Internal Arrangement and Operation of Display Unit (FIGS. 27B and 29)>

The arrangement of each of the display units 2071 to 2079 will be described below with reference to FIG. 27B. Note that the display units 2071 to 2079 have the same arrangement. Hence, the arrangement of only the display unit 2071 will be explained, and a description of the arrangement of the remaining display units 2072 to 2079 will not be given.

Referring to FIG. 27B, the display unit 2071 determines if the image data packets 2090 transmitted from the display server 2063 correspond to its own assigned display region. The display unit 2071 accepts the image data packets 2090 of its own assigned display region, and displays an image by rendering the accepted rendering command of its own assigned display region.

A display unit general control unit 2020 controls components which form the display unit 2071. The display unit general control unit 2020 includes, e.g., a CPU, memories such as a ROM, RAM, and the like, various interfaces, and so forth. The display unit general control unit 2020 controls the overall display unit 2071 when the CPU executes programs recorded in the ROM using the RAM and the like.

A reception interface (reception I/F) 2021 inputs the image data packets 2090 transmitted from the multi-display server 2063. The reception interface (reception I/F) 2021 inputs not only the image data packets 2090 but also control data and the like generated by the multi-display control unit 2001.

A packet reception unit 2022 determines if the image data packets 2090 are likely to belong to its own assigned display region. If the image data packets 2090 are likely to belong to its own assigned display region, the packet reception unit 2022 stores these packets in a buffer memory 2023. Details of the packet reception unit 2022 will be described later.

The buffer memory 2023 temporarily stores the image data packet 2090 (rendering command packet) received by the packet reception unit 2022. A packet analysis unit 2024 sorts processes in accordance with information in the packet header 2091 included in each image data packet 2090 received by the packet reception unit 2022.

A renderer 2115 generates display image data by executing rendering according to the rendering command 2092 included in each image data packet 2090 received by the packet reception unit 2022. Note that the renderer 2115 executes enlargement/reduction/translation, etc. of a graphic to be rendered according to modification parameters stored in a modification parameter storage unit 2116. The display unit general control unit 2020 sets these modification parameters according to its own assigned display region.

Note that the boundaries of the assigned display regions of the display units 2071 to 2079 are often different from those of the display image data rendered according to the rendering command 2092 included in the image data packets 2090 received by the packet reception unit 2022. That is, the renderer 2115 often renders a part other than the assigned display region of each of the display units 2071 to 2079. In this case, both of the two display units on the two sides of the boundary receive the image data packets 2090 of the boundary part of their assigned display regions. In such case, the renderers 2115 of these two display units discard parts other than their assigned display regions of the rendered display image data.

A display control unit 2026 performs drive control of a display panel 2028. The display control unit 2026 outputs the display image data generated by the renderer 2115 to the display panel 2028 in synchronism with, e.g., drive signals such as a horizontal sync signal, vertical sync signal, data transfer clocks, and the like. Note that the display image data is stored in a VRAM (not shown), is read out in synchronism with the drive signal timings, and is output to the display panel 2028.

A sync control unit 2027 controls the display control unit 2026 based on the sync control data (time stamps) stored in the sync data field 2094 of each image data packet 2090 so that the display image data generated by the renderer 2115 is displayed at the designated time. As the display panel 2028, as described above, for example, a display device of an arbitrary system such as an LCD, plasma display, projection type display, and the like may be used. The display panel 2028 displays an image based on the display image data generated by the renderer 2115 (i.e., a part corresponding to its own assigned display region of the image content). The display panel 2028 can be a display device of an arbitrary scheme such as an LCD, plasma display, or projection display, as described above.

The arrangement of the packet reception unit 2022 will be described in detail below. As described above, the packet reception unit 2022 determines if the image data packets 2090 are likely to belong to its own assigned display region. The packet reception unit 2022 accepts (receives) only the image data packets 2090 which are likely to belong to the assigned display region, and stores them in the buffer memory 2023.

An assigned display region storage unit 2031 stores the coordinate range which belongs to its own assigned display region so as to identify its own assigned display region. The assigned display region can be set by an arbitrary method, as described above.

A header ID analysis unit 2030 extracts ID information stored in the packet header 2091 of each incoming image data packet 2090 to confirm information of the packet header 2091, and then extracts coordinate data stored in the coordinate data field 2098.

An assigned display region comparison unit 2032 determines if the coordinate data stored in the coordinate data field 2098 of each incoming image data packet 2090 is likely to be included in its own assigned display region (the coordinate range stored in the assigned display region storage unit 2031). If the coordinate data stored in the coordinate data field 2098 of the incoming image data packet 2090 is likely to be included in the assigned display region, the assigned display region comparison unit 2032 instructs a fetch control unit 2033 to fetch that image data packet 2090. On the other hand, if the coordinate data stored in the coordinate data field 2098 of the incoming image data packet 2090 is unlikely to be included in the assigned display region, the assigned display region comparison unit 2032 discards that image data packet 2090 without accepting it.

The fetch control unit 2033 receives (fetches) the image data packets 2090 designated by the fetch instruction from the assigned display region comparison unit 2032, and writes them in the buffer memory 2023.

A simple practical example of control in the display unit 2071 will be described below. For example, the multi-display system 2061 is configured using the nine display units 2071 to 2079, as shown in FIG. 24. Then, assume that the image content 2050 is displayed on the 3×3 display screens 2051 to 2059 at a resolution (1920×1080 pixels) of a high-resolution image, as shown in FIG. 25B. That is, assume that the display units 2071 to 2079 can display a high-resolution image (1920×1080 pixels).

In this case, the display units 2071 to 2079 respectively display nine regions each having (640×360) pixels.

The assigned display region of the display unit 2071 corresponds to a region of pixel positions equal to or larger than (0, 0) and less than (640, 360). The assigned display region of the display unit 2072 corresponds to a region of pixel positions equal to or larger than (640, 0) and less than (1280, 360). The assigned display region of the display unit 2075 corresponds to a region of pixel positions equal to or larger than (640, 360) and less than (1280, 720). The renderers 2115 of the display units 2071 to 2079 render the divided rendering commands 2092 of these assigned display regions. For example, the assigned display region storage unit 2031 of the display unit 2072 stores that its own assigned display region corresponds to a region of pixel positions equal to or larger than (640, 0) and less than (1280, 360). The modification parameter storage unit 2116 of the display unit 2072 stores modification parameters which instruct to subtract −640 from the x-coordinates and to multiply both x- and y-coordinates by 3.

The assigned display region storage unit 2031 of the display unit 2075 stores that its own assigned display region corresponds to a region of pixel positions equal to or larger than (640, 360) and less than (1280, 720). The modification parameter storage unit 2116 of the display unit 2075 stores modification parameters which instruct to subtract −640 from the x-coordinates and −360 from y-coordinates, and to multiply both x- and y-coordinates by 3.

The assigned display region comparison unit 2032 determines if the coordinates of a bounding box calculated from the coordinate data stored in the coordinate data field 2098 of the rendering command 2092 overlap the assigned display region stored in the assigned display region storage unit 2031. Note that the bounding box is obtained as follows. That is, minimum and maximum values on the X- and Y-axes of a graphic to be rendered are calculated. A rectangular region defined from coordinates specified by the minimum values on the X- and Y-axes (i.e., the minimum values on the X- and Y-axes) calculated in this way to coordinates specified by maximum values on the X- and Y-axes (i.e., the maximum values on the X- and Y-axes) corresponds to a bounding box.

For example, if the coordinates of the vertices of a triangle included in the image content 2050 are respectively (600, 300), (200, 700), and (1000, 600), the bounding box is a rectangular region from (200, 300) to (1000, 700). Therefore, the assigned display region comparison units 2032 of the display units 2072 and 2075 determine that its own assigned display regions include this triangle.

For example, if the coordinates of the upper left and lower right vertices of a rectangle object included in the image content 2050 are respectively (800, 500) and (1600, 900), the bounding box is a rectangular region from (800, 500) and (1600, 900). Therefore, at this time, the assigned display region comparison unit 2032 of the display unit 2072 determines that its own assigned display region does not include this rectangle object. On the other hand, the assigned display region comparison unit 2032 of the display unit 2075 determines that its own assigned display region includes this rectangle object.

By configuring the display units 2071 to 2079, as described above, they can reclaim and display the image content 2050 by selecting and rendering the corresponding divided rendering commands 2092 corresponding to their assigned display regions.

An example of the operation of the display unit 2071 will be described below with reference to the flowchart of FIG. 29.

In step S2011, the display unit general control unit 2020 waits until the reception interface 2021 inputs an image data packet 2090 transmitted from the multi-display server 2063. If the reception interface 2021 inputs the image data packet 2090, the process advances to step S2012. After the process reaches step S2012, the assigned display region comparison unit 2032 calculates a bounding box using coordinate data stored in the coordinate data field 2098 of the image data packet 2090 determined to be input in step S2011.

The assigned display region comparison unit 2032 determines in step S2013 if the coordinates of the bounding box calculated in step S2012 overlap the coordinate range stored in the assigned display region storage unit 2031. In other words, the assigned display region comparison unit 2032 determines if the input image data packet 2090 belongs to its own assigned display region. As a result of determining, if the coordinates of the bounding box calculated in step S2012 do not overlap the coordinate range stored in the assigned display region storage unit 2031, and the input image data packet 2090 does not belong to its own assigned display region, the process advances to step S2019 (to be described later). On the other hand, if the coordinates of the bounding box calculated in step S2012 overlap the coordinate range stored in the assigned display region storage unit 2031, and the input image data packet 2090 belongs to its own assigned display region, the process advances to step S2014.

After the process reaches step S2014, the assigned display region comparison unit 2032 instructs the fetch control unit 2033 to fetch that image data packet 2090. In response to this instruction, the fetch control unit 2033 fetches the image data packet 2090 determined to be input in step S2011.

In step S2015, the fetch control unit 2033 temporarily stores the image data packet 2090 fetched in step S2014 in the buffer memory 2023.

Next, the display unit general control unit 2020 determines in step S2016 if the fetch control unit 2033 has fetched all image data packets 2090 which belong to its own assigned display region. As a result of determining, if the fetch control unit 2033 has not fetched all image data packets which belong to its own assigned display region yet, the process returns to step S2011 to wait until the next image data packet 2090 is input.

On the other hand, if the fetch control unit 2033 has fetched all image data packets 2090 which belong to its own assigned display region, the process advances to step S2017. The renderer 2115 executes rendering based on the divided rendering commands 2092 included in the image data packets 2090 stored in the buffer memory 2023 in step S2015 in accordance with the modification parameters stored in the modification parameter storage unit 2116. In this way, display image data is generated. As described above, upon rendering a part other than the assigned display region of each of the display units 2071 to 2079, the renderer 2115 discards the part other than its own assigned display region.

In step S2018, the display control unit 2026 displays, on the display panel 2028, the display image data generated in step S2017 under the control of the display timings by the sync control unit 2027.

If it is determined in step S2013 that the coordinates of the bounding box calculated in step S2012 do not overlap the coordinate range stored in the assigned display region storage unit 2031, and the input image data packet 2090 does not belong to its own assigned display region, the process advances to step S2019. After the process reaches step S2019, the assigned display region comparison unit 2032 discards the image data packet 2090 which is determined to be input in step S2011 without accepting (receiving) it.

In this embodiment, the multi-display server 2063 divides a rendering command into a plurality of rendering commands according to its data size, generates image data packets 2090 for these divided rendering commands, and transmits the packets to the display units 2071 to 2079. The multi-display server 2063 stores, in respective image data packets 2090, coordinate data indicating the positions of objects instructed to be rendered by the divided rendering commands in the image content. Each of the display units 2071 to 2079 accepts (receives) an image data packet 2090 only when the coordinate data included in that image data packet 2090 is included in the coordinate range indicating its own assigned display region. Each of the display units 2071 to 2079 renders according to the divided rendering commands included in the received (accepted) image data packets 2090 and displays an image of the image content 2050 corresponding to its own assigned display region.

As described above, according to this embodiment, each of the display units 2071 to 2079 selects the rendering command 2092 which belongs to its own assigned display region, and executes rendering. Therefore, the multi-display server 2063 as a sending device need not execute any processing that considers the layout and the like of the display units 2071 to 2079. Furthermore, each of the display units 2071 to 2079 need not clip an image of its own assigned display region from the entire image content, it need not receive a large-capacity rendering command. As a result, a large-screen display can be attained by hardware resources fewer than the conventional system. Since the sending device need not sort the destinations of the rendering command, the arrangements (the number, layout, and the like) of the display units 2071 to 2079 can be easily changed.

In the example described in this embodiment, the communication path 2064 which interconnects the display units 2071 to 2079 comprises a wired network. Alternatively, the communication path 2064 may interconnect the display units 2071 to 2079 in a bus format. Also, the communication path 2064 can adopt arbitrary transmission systems. Furthermore, the communication path 2064 may comprise a wireless communication path as long as the bandwidth required to display the image content can be assured.

In the example described in this embodiment, the display units 2071 to 2079 are physically coupled. However, the display units 2071 to 2079 need not be physically coupled. The display units 2071 to 2079 may be equipped at neighboring positions, and may transmit data via wireless communications.

Moreover, in this embodiment, the multi-display server 2063 internally generates a rendering command. Alternatively, the rendering command may be input from an external apparatus to the multi-display server 2063. When the rendering command is input from an external apparatus, the multi-display server 2063 may convert the input rendering command into a rendering command that can be processed in the display units 2071 to 2079.

### Eighth Embodiment

The eighth embodiment of the present invention will be described in detail hereinafter.

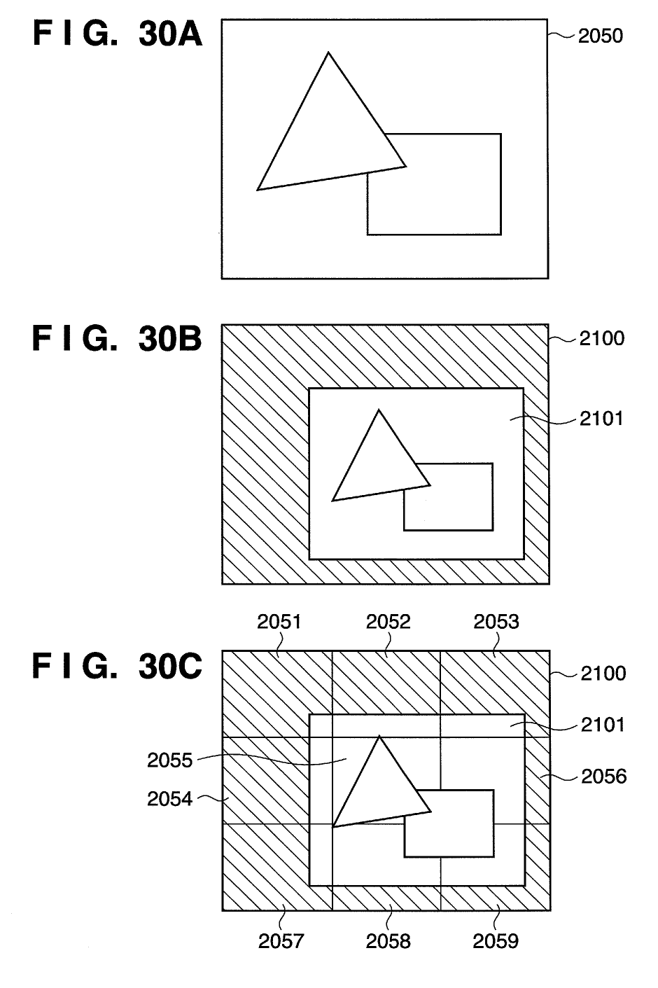

In the seventh embodiment, the case has been explained wherein the image content 2050 rendered according to the rendering command is displayed on the entire screen defined by the display screens 2051 to 2059 of the display units 2071 to 2079. By contrast, this embodiment will explain a case wherein the image content 2050 is displayed on some of the display screens 2051 to 2059 of the display units 2071 to 2079. More specifically, in this embodiment, the multi-display server 2063 designates a layout of an image content. Each of the display units 2071 to 2079 calculates its own assigned display region using the designated layout, and determines if an image data packet 2090 belongs to the calculated assigned display region. In this manner, in this embodiment, some steps of the software processing required to display the image contents are different from the seventh embodiment. Therefore, the same reference numerals denote the same components and processes as those in FIGS. 24 to 29 of the seventh embodiment, and a detailed description thereof will not be repeated.

<Display Example of Multi-Display System (FIGS. 30A to 30C)>

FIGS. 30A to 30C show a display example in the multi-display system 2061 (display units 2071 to 2079). In this embodiment, the image content is laid out and displayed at a position designated by the multi-display server 2063 based on a user's instruction.

FIG. 30A shows an example of an image content. As in FIG. 25A, the image content 2050 is configured by a rectangle object and triangle object.

FIG. 30B shows a layout example of the image content 2050. FIG. 30B exemplifies a case wherein a contents window 2101 that displays the image content 2050 in a reduced scale is laid out near the lower right corner of a display screen 2100.

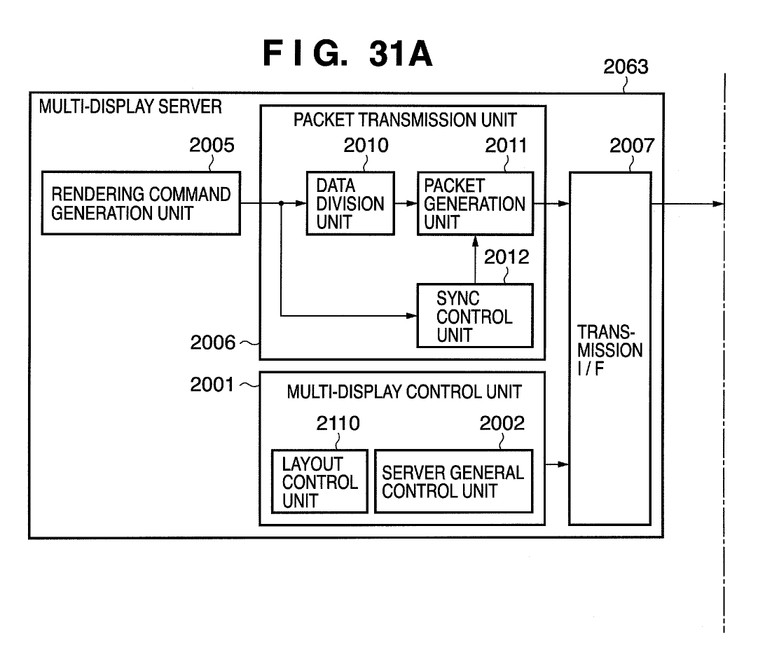

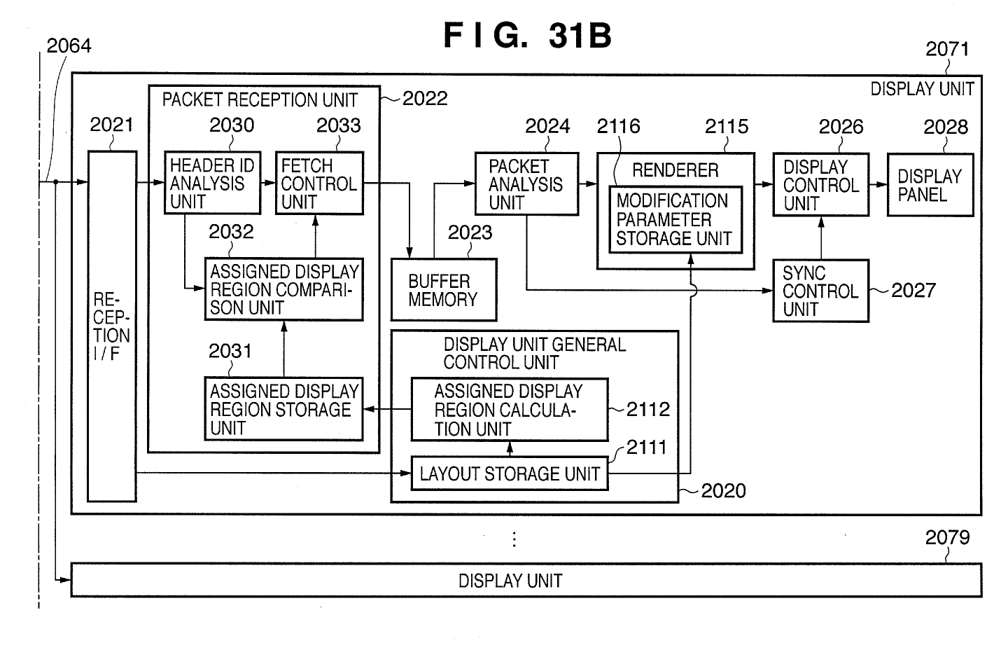

FIG. 30C shows a display example when the image content 2050 is displayed using the display units 2071 to 2079. The display screens 2051 to 2059 are those of the display units 2071 to 2079, respectively. As in the seventh embodiment, in FIG. 30C, by combining the display screens 2051 to 2059 of the nine display units 2071 to 2079, a single display screen of a 3×3 matrix (3 rows×3 columns) is configured. Each of the display units 2071 to 2079 displays a part of the original image content 2050 according to its own assigned display region. In this case, the assigned display regions of the display units 2071 to 2079 change depending on the layout designated by the multi-display server 2063. For example, in FIG. 30C, only an upper left portion of the contents window 2101 is the assigned display region of the display unit 2071. In this manner, by combining the display screens 2051 to 2059 of the display units 2071 to 2079, as shown in FIG. 30C, and laying out and displaying the image content 2050 according to the layout, the entire original image content 2050 is displayed.

<Internal Arrangement and Operation of Multi-Display Server (FIG. 31A)>

FIGS. 31A and 31B are block diagrams showing an example of the detailed arrangement of the multi-display system 2061. The arrangement of the multi-display server 2063 will be described below with reference to FIG. 31.

The multi-display control unit 2001 which controls the overall multi-display system 2061 includes a layout control unit 2110 in addition to the server general control unit 2002 shown in FIG. 27A. The layout control unit 2110 inputs and stores layout instruction information of the image content (layout command) from the user (e.g., an external client terminal or contents server). The layout control unit 2110 transmits the layout instruction information to the display units 2071 to 2079 using the transmission interface 2007. The layout instruction information of the image content includes, e.g., the position coordinates of a region where the image content is laid out. In this case, the layout control unit 2110 can set upper left coordinates (Xmin, Ymin) and lower right coordinates (Xmax, Ymax) of the reduced-scale image of the contents window 2101 displayed on the display screen 2100 shown in FIGS. 30B and 30C as the layout instruction information of the image content. Also, the layout control unit 2110 may set the upper left coordinates and size of the contents window 2101 displayed on the display screen 2100 in FIGS. 30B and 30C as the layout instruction information of the image content.

When laying out the image content 2050 after rotation or deformation, the layout control unit 2110 transmits parameters required to attain such rotation or deformation to the display units 2071 to 2079 as the layout instruction information of the image content. When rotating the image content 2050, the layout control unit 2110 can set, e.g., a rotation angle as the layout instruction information of the image content. When deforming the image content 2050, the layout control unit 2110 can set, e.g., vertical and horizontal reduction scales or a matrix of Affine transformation as the layout instruction information of the image content 2050.

As for the operation of the multi-display server 2063, in the flowchart shown in FIG. 28, the layout control unit 2110 inputs and stores layout instruction information of the image content before the process of step S2006 (e.g., before the process of step S2001). The layout control unit 2110 then transmits the stored layout instruction information of the image content to the display units 2071 to 2079 before the process of step S2006 (e.g., before step S2001). The example of other operations of the multi-display server 2063 is the same as that shown in FIG. 28, and a repetitive description thereof will be avoided.

In the following description, the instruction information for a layout of the image content will be referred to as layout instruction information as needed.

<Internal Arrangement and Operation of Display Unit (FIG. 31B)>

The arrangement of each of the display units 2071 to 2079 will be described below with reference to FIG. 31B. Note that the display units 2071 to 2079 have the same arrangement. Hence, the arrangement of only the display unit 2071 will be explained, and a description of the arrangement of the remaining display units 2072 to 2079 will not be given.

Referring to FIG. 31B, the display unit 2071 calculates the coordinate range of the rendering command which serves as its own assigned display region based on the layout instruction information transmitted from the multi-display server 2063. After that, the display unit 2071 determines if coordinate data stored in the coordinate data field 2098 of an image data packet 2090 transmitted from the multi-display server 2063 overlaps the calculated coordinate range. Based on this determining result, the display unit 2071 accepts (receives) only image data packets 2090 which are likely to belong to its own assigned display region. The display unit 2071 then reclaims and displays a part of the image content by executing rendering according to the divided rendering commands 2092 included in the accepted image data packets 2090.

The display unit general control unit 2020 newly includes a layout storage unit 2111 and assigned display region calculation unit 2112.

The layout storage unit 2111 stores the layout instruction information transmitted from the layout control unit 2110 of the multi-display server 2063. The assigned display region calculation unit 2112 calculates the coordinate range indicating its own assigned display region based on the layout instruction information stored in the layout storage unit 2111, and stores the calculated coordinate range in the assigned display region storage unit 2031. In this way, the assigned display region calculated by the assigned display region calculation unit 2112 is obtained by correcting that stored in the assigned display region storage unit 2031 of the seventh embodiment in accordance with the contents of the layout instruction information.

The packet reception unit 2022 determines using the coordinate range indicating its own assigned display region if an image data packet 2090 transmitted from the multi-display server 2063 is likely to belong to its own assigned display region. This determining processing is executed using a bounding box as in the seventh embodiment. More specifically, the assigned display region comparison unit 2032 calculates a bounding box using the coordinate data stored in the coordinate data field 2098 of an image data packet 2090 transmitted from the multi-display server 2063. The assigned display region comparison unit 2032 determines if the coordinates of the calculated bounding box overlap the coordinate range which is calculated by the assigned display region calculation unit 2112 and is stored in the assigned display region storage unit 2031.

If the coordinates of the bounding box overlap the coordinate range stored in the assigned display region storage unit 2031, and the image data packet 2090 transmitted from the multi-display server 2063 is likely to belong to its own assigned display region, that image data packet 2090 is accepted. On the other hand, if the coordinates of the bounding box do not overlap the coordinate range stored in the assigned display region storage unit 2031, and the image data packet 2090 transmitted from the multi-display server 2063 is unlikely to belong to its own assigned display region, that image data packet 2090 is discarded.

The buffer memory 2023 temporarily stores the image data packet 2090 received by the packet reception unit 2022. The packet analysis unit 2024 extracts the rendering command (rendering command 2092) from the image data packets 2090. The packet analysis unit 2024 sorts processes for the rendering command in accordance with information in the packet header 2091.

The renderer 2115 generates display image data by executing rendering according to the rendering command 2092 included in each image data packet 2090 received by the packet reception unit 2022. Note that the renderer 2115 executes enlargement/reduction/translation, etc. of a graphic to be rendered in correspondence with its own assigned display region according to modification parameters stored in the modification parameter storage unit 2116. The display unit general control unit 2020 sets these modification parameters according to its own assigned display region. Especially, in this embodiment, modification parameters that reflect the contents of a layout based on the layout instruction information stored in the layout storage unit 2111 are stored in the modification parameter storage unit 2116.

The display control unit 2026 outputs the display image data to the display panel 2028 in synchronism with sync signals output from the sync control unit 2027. In this way, an image rendered according to the rendering commands is laid out and displayed based on the layout instruction information.

As for the operation of the display units 2071 to 2079, in the flowchart shown in FIG. 29, the layout storage unit 2111 stores the layout instruction information transmitted from the multi-display server 2063 before step S2013. Furthermore, the assigned display region calculation unit 2112 calculates a coordinate range representing its own assigned display region based on the layout instruction information stored in the layout storage unit 2111 and stores the calculation result in the assigned display region storage unit 2031 before step S2013. The assigned display region comparison unit 2032 determines in step S2013 if the coordinates of the bounding box calculated in step S2012 overlap the coordinate range calculated by the assigned display region calculation unit 2112.

In step S2017, the renderer 2115 executes rendering based on the divided rendering commands 2092 contained in the image data packets 2090 stored in the buffer memory 2023 according to the modification parameters stored in the modification parameter storage unit 2116. In this embodiment, since the modification parameters are set based on the layout information stored in the layout storage unit 2111, rendering is done to have a layout based on the layout instruction information.

Other operations of the display units 2071 to 2079 are the same as those shown in FIG. 29, and a repetitive description thereof will be avoided.

By configuring the display units 2071 to 2079 as described above, each of the display units 2071 to 2079 can accept only image data packets 2090 which are likely to be located within the assigned display region according to the designated layout, and can reclaim and display the image content according to the designated layout.

In this embodiment, the multi-display server 2063 generates layout instruction information that instructs a layout of the image content and transmits the generated information to the display units 2071 to 2079. Each of the display units 2071 to 2079 calculates the coordinate range that represents the assigned display region based on the layout instruction information. Each of the display units 2071 to 2079 accepts (receives) an image data packet 2090 of interest only when a bounding box based on the coordinate data included in that image data packet 2090 overlap the calculated coordinate data. Each of the display units 2071 to 2079 performs rendering according to the rendering commands included in the accepted (received) image data packets 2090 and the layout instruction information. As a result, the display unit displays an image corresponding to the assigned display region of the image content in a layout based on the layout instruction information.

Therefore, in addition to the effects described in the seventh embodiment, the layout upon displaying the image content can be freely set.

In the example described in this embodiment, one image content 2050 is displayed. Alternatively, a plurality of image contents can be simultaneously displayed.

This embodiment can also adopt various modifications described in the seventh embodiment.

### Ninth Embodiment

The ninth embodiment of the present invention will be described in detail hereinafter. The eighth embodiment has exemplified the case wherein the display units 2071 to 2079 display the image content after layout in accordance with the layout instruction information transmitted from the multi-display server 2063. By contrast, this embodiment will exemplify a case wherein layout instruction information is also packetized and packets including the layout instruction information are transmitted from the multi-display server 2063 to the display units 2071 to 2079.

Note that a payload of a layout command packet that packetizes the layout instruction information stores layout commands. A packet header of the layout command packet includes a field indicating a region range to which the layout commands are to be applied.

Each of display units 2071 to 2079 checks if a region to which a layout command packet transmitted from the multi-display server 2063 is applied is included in its own assigned display region. Each of the display units 2071 to 2079 accepts (receives) only layout command packets to be applied to its own assigned display region, and lays out the image content based on the accepted layout command packets.

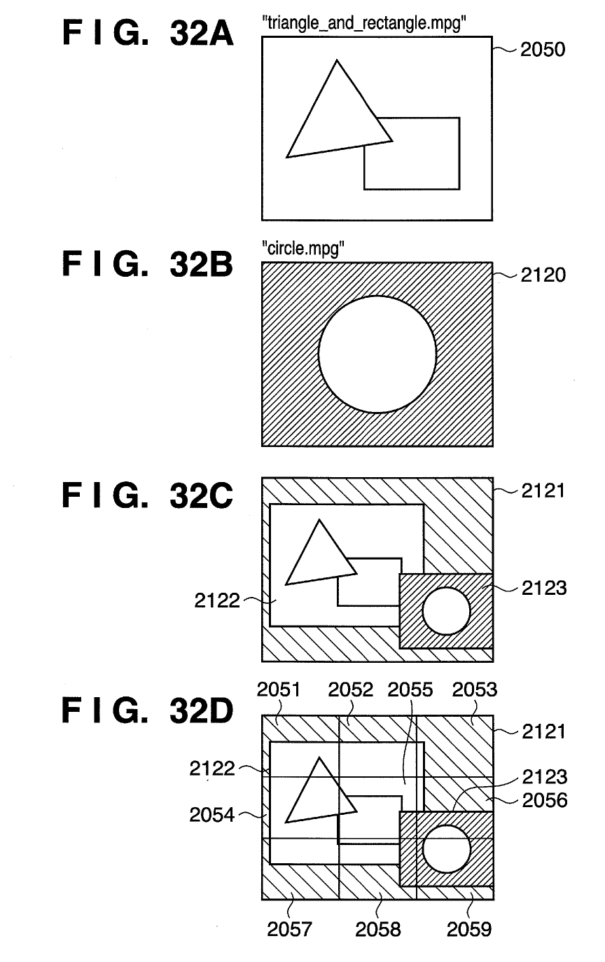

As described above, in this embodiment, some steps of software processing required to lay out the image content are mainly different from the seventh and eighth embodiments. Therefore, the same reference numerals denote the same components and processes as those in FIGS. 24 to 31 of the seventh and eighth embodiments, and a detailed description thereof will not be repeated.

<Display Example of Multi-Display System (FIGS. 32A to 32D)>

FIGS. 32A to 32D show a display example in the multi-display system 2061 (display units 2071 to 2079). In this embodiment, a plurality of image contents are laid out and displayed at designated positions.

FIGS. 32A and 32B show examples of image contents. The image content 2050 shown in FIG. 32A is configured by a rectangle object and triangle object as in FIGS. 25A and 30A, and has a file name “triangle_and_rectangle.mpg”. On the other hand, an image content 2120 shown in FIG. 32B is configured by a circle object, and has a file name “circle.mpg”.

FIG. 32C shows a layout example of the image contents 2050 and 2120. FIG. 32C exemplifies a case wherein contents windows 2122 and 2123 which respectively display the image contents 2050 and 2120 in a reduced scale are displayed on a display screen 2121.

FIG. 32D shows a display example when the image contents 2050 and 2120 are displayed using the display units 2071 to 2079. The display screens 2051 to 2059 are those of the display units 2071 to 2079, respectively. As in the seventh and eighth embodiments, in FIG. 32D, by combining the nine display units 2071 to 2079, a single display screen of a 3×3 matrix (3 rows×3 columns) is configured.

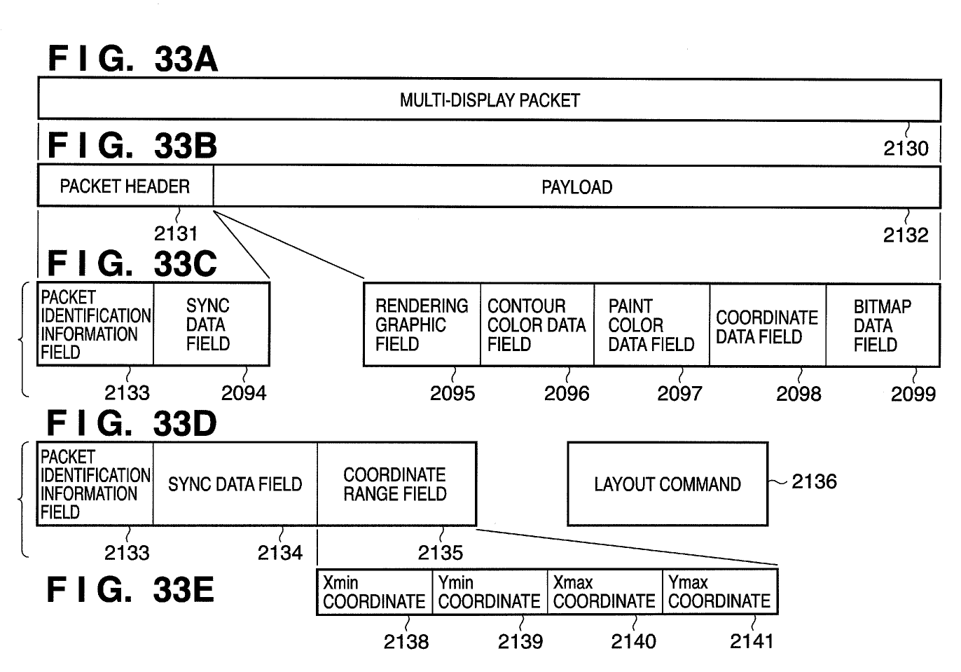

In this case, the assigned display regions of the display units 2071 to 2079 change depending on the layout designated by the multi-display server 2063. For example, in FIG. 32D, only an upper left portion of the contents window 2122 is the assigned display region of the display unit 2071.

<Configuration of Multi-Display Packet (FIGS. 33A to 33E)>

FIGS. 33A to 33E show an example of the configuration of a multi-display packet. The configuration of a packet used in transmission in the multi-display system 2061 will be described below with reference to FIGS. 33A to 33E. The multi-display packet of this embodiment is configured by two types of packets, i.e., an image data packet and layout command packet. A payload 2132 of the layout command packet stores layout commands. A packet header 2131 of this packet includes a field indicating a coordinate range which is to undergo layout based on the layout commands.

FIG. 33A shows a multi-display packet 2130. FIG. 33B is a view for explaining the configuration of the multi-display packet 2130. As shown in FIG. 33B, the multi-display packet 2130 has the packet header 2131 and payload 2132. The payload 2132 stores the rendering graphic field 2095 to bitmap data field 2099 as the rendering command or layout commands 2136.

FIG. 33C shows an example of the header configuration of the image data packet. The contents of the packet identification information field are different from the image data packet 2090 described in the seventh and eighth embodiments. Referring to FIG. 33C, a packet identification information field 2133 stores ID information required to identify whether or not a packet of interest is a multi-display packet, version information, and the like. Furthermore, the packet identification information field 2133 also stores ID information required to identify whether a packet of interest is an image data packet or layout command packet. Since FIG. 33C shows the header configuration of an image data packet, the packet identification information field 2133 shown in FIG. 33C stores ID information used to identify that the packet of interest is an image data packet.

FIG. 33D shows an example of the header configuration of a layout command packet. A packet identification information field 2133 shown in FIG. 33D stores ID information used to identify that the packet of interest is a layout command packet.

A sync data field 2134 stores various time stamps indicating time information such as the processing start time, processing end time, and the like of the rendering command.

FIG. 33E shows an example of the configuration of a coordinate range field 2135. As shown in FIG. 33E, the coordinate range field 2135 is configured by four fields; an Xmin coordinate field 2138, Ymin coordinate field 2139, Xmax coordinate field 2140, and Ymax coordinate field 2141, which respectively store corresponding coordinates. In this embodiment, the layout command packet is divided into a first layout command packet including layout commands for the contents window 2122, and a second layout command packet including layout commands for the contents window 2123.

Therefore, the Xmin coordinate field 2138 of the first layout command packet stores a minimum value in the X-axis direction of the contents window 2122, and the Ymin coordinate field 2139 stores a minimum value in the Y-axis direction of the contents window 2122. Also, the Xmax coordinate field 2140 of the first layout command packet stores a maximum value in the X-axis direction of the contents window 2122, and the Ymax coordinate field 2141 stores a maximum value in the Y-axis direction of the contents window 2122.

Likewise, the Xmin coordinate field 2138 of the second layout command packet stores a minimum value in the X-axis direction of the contents window 2123, and the Ymin coordinate field 2139 stores a minimum value in the Y-axis direction of the contents window 2123. Also, the Xmax coordinate field 2140 of the second layout command packet stores a maximum value in the X-axis direction of the contents window 2123, and the Ymax coordinate field 2141 stores a maximum value in the Y-axis direction of the contents window 2123.

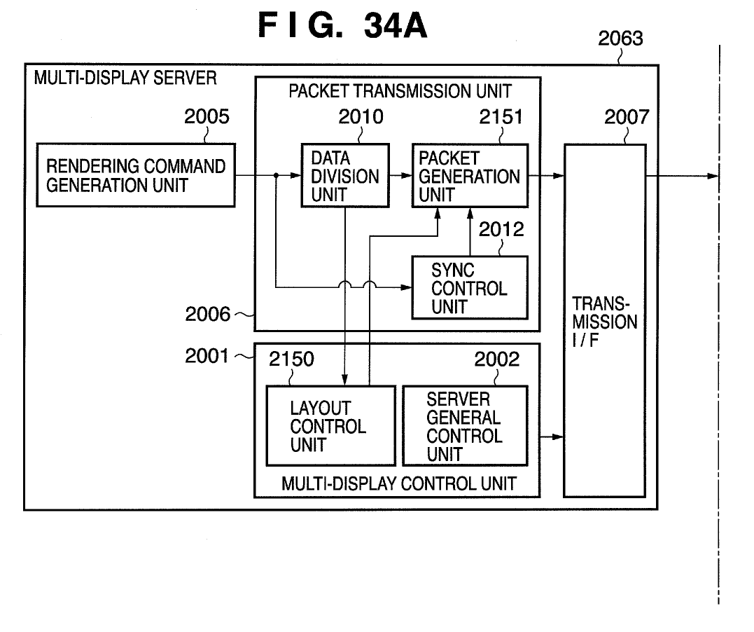

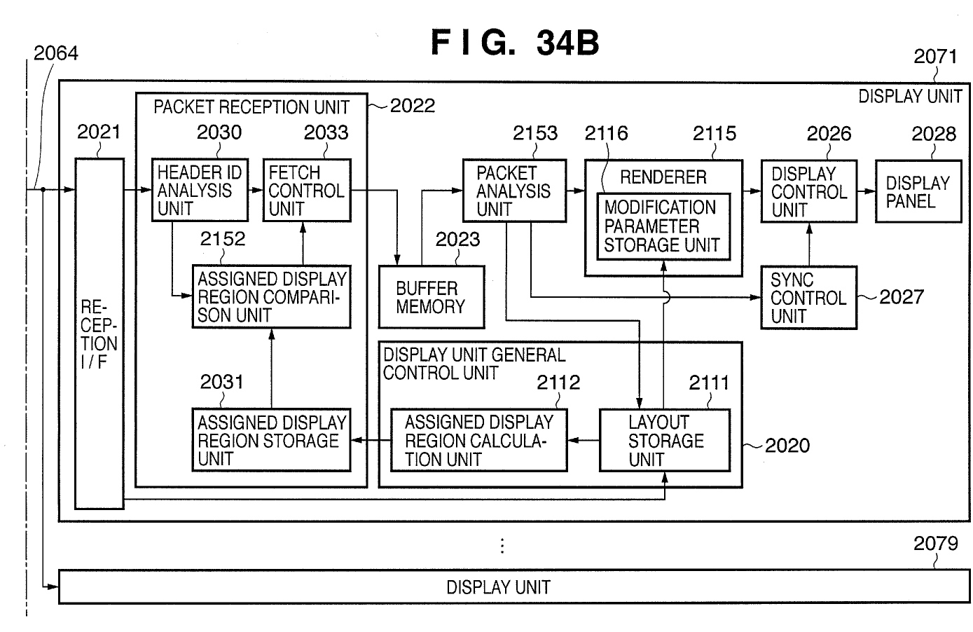

By configuring the layout command packets as described above, each of the display units 2071 to 2079 can determine if the layout command packet corresponds to its own assigned display region by referring to only the coordinate range field 2135. That is, each of the display units 2071 to 2079 need only receive the layout command packet of the assigned display region and execute layout processing.

<Internal Arrangement and Operation of Multi-Display Server (FIG. 34A)>

FIGS. 34A and 34B are block diagrams showing an example of the detailed arrangement of the multi-display system 2061. The arrangement of the multi-display server 2063 will be described below with reference to FIG. 34A.

Referring to FIG. 34A, the multi-display server 2063 packetizes and transmits layout instruction information (layout commands). In this embodiment, the operations of a layout control unit 2150 and packet generation unit 2151 are different from the eighth embodiment. The layout control unit 2150 outputs layout commands to the packet generation unit 2151.

The packet generation unit 2151 generates a multi-display packet 2130 with the configuration shown in FIGS. 33A to 33E. The packet generation unit 2151 generates image data packets in case of image content data, and layout command packets in case of layout commands. The packet transmission unit 2006 is configured to parallelly process a plurality of image contents. In this case, the packet transmission unit 2006 may time-divisionally process respective image contents, or a plurality of packet transmission units 2006 may be equipped to execute parallel processes.

Upon transmitting multi-display packets 2130 from the multi-display server 2063 to the display units 2071 to 2079, the packet generation unit 2151 generates multi-display packets 2130 associated with layout commands first, and transmits them to the display units 2071 to 2079. After that, after layout settings are executed in the display units 2071 to 2079, the packet generation unit 2151 begins to transmit multi-display packets 2130 associated with data of image contents.

As for the operation of the multi-display server 2063, the following processes are executed before the process of step S2006 (e.g., before the process of step S2001) in the flowchart shown in FIG. 28. The layout control unit 2150 inputs layout commands of image contents. The packet generation unit 2151 packetizes the layout commands to generate multi-display packets 2130 associated with the layout commands. The transmission interface 2007 then transmits the multi-display packets 2130 associated with the layout commands to the display units 2071 to 2079. Then, the processes in steps S2001 to S2006 in FIG. 28 are executed to transmit multi-display packets 2130 associated with the data of the image contents to the display units 2071 to 2079.

<Internal Arrangement and Operation of Display Unit (FIG. 34B)>

The arrangement of each of the display units 2071 to 2079 will be described below with reference to FIG. 34B. Note that the display units 2071 to 2079 have the same arrangement. Hence, the arrangement of only the display unit 2071 will be explained, and a description of the arrangement of the remaining display units 2072 to 2079 will not be given.

Referring to FIG. 34B, the display unit 2071 inputs a layout instruction as layout command packets, and executes the layout processing of the display screen based on the input layout command packets. Upon input of the layout command packets, the display unit 2071 determines if the target region of each layout command packet falls within its own assigned display region, and accepts (receives) only the layout command packets within its own assigned display region.

In FIG. 34B, in the display unit 2071 of this embodiment, the operations of an assigned display region comparison unit 2152 and packet analysis unit 2153 are different compared to the display unit 2071 of the eighth embodiment.

The assigned display region comparison unit 2152 determines if each layout command packet and image data packet belong to its own assigned display region. As for the layout command packet, the assigned display region comparison unit 2152 determines if the application target region of the layout command packet falls within the assigned display region assigned to its own unit. That is, the assigned display region comparison unit 2152 determines if the values of the coordinate range field 2135 in the layout command packet overlap the coordinate range set in the assigned display region storage unit 2031, as described in the seventh embodiment.

On the other hand, the assigned display region comparison unit 2152 determines if the coordinates of a bounding box calculated based on the coordinate data stored in the coordinate data field 2098 of the image data packet overlap the coordinate range calculated (corrected) by the assigned display region calculation unit 2112 based on the layout command packet. Note that the coordinates of the bounding box can be calculated in the same manner as in the seventh and eighth embodiments.

The packet analysis unit 2153 extracts data of the multi-display packet 2130 from the buffer memory 2023. The packet analysis unit 2153 sorts the processes for the extracted data of the multi-display packet 2130 in accordance with the information in the packet header 2131. If the multi-display packet 2130 is a layout command packet, the packet analysis unit 2153 outputs the data of the multi-display packet 2130 to the layout storage unit 2111. The layout storage unit 2111 stores layout commands based on the layout command packet.

On the other hand, if the multi-display packet 2130 is an image data packet, the packet analysis unit 2153 outputs the data of the multi-display packet 2130 to the renderer 2115.

The renderer 2115, display unit general control unit 2020, and packet reception unit 2022 are configured to parallelly execute the processes for the plurality of contents windows 2122 and 2123. In this case, the renderer 2115, display unit general control unit 2020, and packet reception unit 2022 may time-divisionally process the contents windows 2122 and 2123. Furthermore, a plurality of renderers 2115, display unit general control units 2020, and packet reception units 2022 may be equipped to execute parallel processes.

With the above arrangement, each of the display units 2071 to 2079 receives only the layout command packets within its own assigned display region, and can lay out and display the image content 2050 based on the received layout command packets.

As for the operations of the display units 2071 to 2079, the reception interface 2021 inputs layout command packets before step S2034 in the flowchart shown in FIG. 29. The assigned display region comparison unit 2152 determines if the application target region of each input layout command packet is included in its own assigned display region. This determining process is attained by comparing the values stored in the coordinate range field 2135 in the layout command packet, and the coordinate range stored in the assigned display region storage unit 2031.

The fetch control unit 2033 accepts (receives) only layout command packets to be applied to its own assigned display region, and discards other layout command packets. After that, the packet analysis unit 2153 analyzes the accepted (received) layout command packets, and stores layout instruction information (layout commands) in the layout storage unit 2111 based on the analysis result. Furthermore, the assigned display region calculation unit 2112 calculates its own assigned display region based on the layout commands stored in the layout storage unit 2111, and rewrites the coordinate range stored in the assigned display region storage unit 2031.

The assigned display region comparison unit 2032 determines in step S2013 if the coordinates of the bounding box calculated in step S2012 overlap the coordinate range calculated by the assigned display region calculation unit 2112.

In step S2017, the renderer 2115 executes rendering based on the divided rendering commands 2092 stored in the buffer memory 2023 according to the modification parameters stored in the modification parameter storage unit 2116. In this embodiment, since the modification parameters are set based on the layout information stored in the layout storage unit 2111, rendering is executed to have a layout based on the layout instruction information.

Other operations of the display units 2071 to 2079 are the same as those shown in FIG. 29, and a repetitive description thereof will be avoided.

In this embodiment, the multi-display server 2063 generates layout command packets that packetize layout instruction information (layout commands) required to instruct a layout of the image contents and transmits the generated packets to the display units 2071 to 2079. Each of the display units 2071 to 2079 calculates the coordinate range that represents the assigned display region based on the layout command packets. Each of the display units 2071 to 2079 accepts (receives) an image data packet 2090 of interest only when a bounding box based on the coordinate data included in that image data packet 2090 overlap the calculated coordinate data. Each of the display units 2071 to 2079 performs rendering according to the rendering commands included in the accepted (received) image data packets 2090 and the layout instruction information. As a result, the display unit displays an image corresponding to the assigned display region of the image content in a layout based on the layout commands.

As described above, since the image content data and layout commands are transmitted using packet communications of the same communication scheme, the image content data and layout commands can be handled by the same packet processing system. Therefore, in addition to the effects described in the eighth embodiment, the interface can be simplified.

In this embodiment, layout command packets are divisionally generated for respective contents. However, layout commands may be packetized without being divided. In such case, each of the display units 2071 to 2079 may accept (receive) all layout command packets, and may extract and process only commands corresponding to its own assigned display region.

Also, each image data packet may include layout commands. For example, the layout commands may be described in a miscellaneous ID field (not shown) in the image data packet. In this way, a reception failure of image data packets can be prevented when the multi-display packets associated with layout commands are delayed.

This embodiment can also adopt various modifications described in the seventh and eighth embodiments.

### Other Embodiments of Present Invention

A program code of software required to implement the functions of the above embodiments may be applied to a computer in an apparatus or system connected to various devices so as to operate these devices to implement the functions of the aforementioned embodiments. The scope of the present invention includes the invention practiced by operating such devices in accordance with a program stored in the computer (a CPU or MPU) in the system or apparatus.

In this case, the program code itself of software implements the functions of the above embodiments. The program code itself, and means for supplying the program code to the computer (e.g., a recording medium which stores the program code) constitutes the present invention. As the recording medium for storing the program code, for example, a flexible disk, hard disk, optical disk, magneto-optical disk, CD-ROM, magnetic tape, nonvolatile memory card, ROM, and the like may be used.

The present invention is not limited to a case wherein the functions of the above embodiments are implemented when the computer executes the supplied program code. For example, the functions of the above embodiments may be implemented by collaboration of the program code and an operating system running on the computer, another application software, or the like. In such case, the program code is included in the embodiments of the present invention.

Furthermore, the supplied program code may be stored in a memory equipped on a function expansion board of the computer connected to the computer, and a CPU or the like equipped on the function expansion board then executes some or all of actual processes on the basis of the instruction of that program code. A case wherein the functions of the above embodiments are implemented by those processes is also included in the present invention.

Moreover, the supplied program code may be stored in a memory equipped on a function expansion unit connected to the computer connected to the computer, and a CPU or the like equipped on the function expansion unit then executes some or all of actual processes on the basis of the instruction of that program code. A case wherein the functions of the above embodiments are implemented by those processes is also included in the present invention.

Note that the aforementioned embodiments merely indicate practical examples upon practicing the present invention, and the technical scope of the present invention should not be limitedly interpreted based on these embodiments. That is, the present invention can be practiced in various modes without departing from its technical scope or its principal features.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application Nos. 2006-279196 filed on Oct. 12, 2006, 2006-279197 filed on Oct. 12, 2006 and 2006-279198 filed on Oct. 12, 2006, which are hereby incorporated by reference herein in their entirety.

What is claimed is:

1. A display control apparatus comprising:
a division unit configured to divide image data into a plurality of image data;
a position information generation unit configured to generate position identification information required to identify positions of the plurality of image data divided by said division unit; and
an image data transmission unit configured to transmit, in association with each other, the image data divided by said division unit and the position identification information generated by said position information generation unit for the image data to each of a plurality of display apparatuses configuring a single display screen.

2. The apparatus according to claim 1, further comprising a time information generation unit configured to generate time information associated with processes of the image data divided by said division unit,
wherein said image data transmission unit transmits, in association with each other, the image data divided by said division unit, the position identification information generated by said position information generation unit for the image data, and the time information generated by said time information generation unit for the image data to each of the plurality of display apparatuses configuring the single display screen.

3. The apparatus according to claim 1, further comprising a layout information transmission unit configured to transmit layout information associated with a layout of the image data on the display screen configured by the plurality of display apparatuses to each of the plurality of display apparatuses.

4. The apparatus according to claim 3, wherein said layout information transmission unit transmits, in association with each other, the layout information and layout position identification information required to identify the positions of the image data whose layout has been changed based on the layout information to each of the plurality of display apparatuses.

5. The apparatus according to claim 3, wherein said image data transmission unit transmits the image data using the same communication scheme as the layout information transmitted by said layout information transmission unit.

6. The apparatus according to claim 1, further comprising:
an instruction information generation unit configured to generate instruction information required to instruct contents of image processes to be applied to the image data for each of the plurality of image data divided by said division unit; and
an instruction information transmission unit configured to transmit the instruction information generated by said instruction information generation unit to each of the plurality of display apparatuses.

7. The apparatus according to claim 6, wherein said instruction information generation unit generates the instruction information and processing position identification information required to identify the image data to which the instruction information instructs to apply the image processes, and
said instruction information transmission unit transmits, in association with each other, the instruction information generated by said instruction information generation unit, and the processing position identification information generated by said instruction information generation unit for the instruction information to each of the plurality of display apparatuses.

8. The apparatus according to claim 1, wherein said division unit divides the image data into the plurality of image data each having a data size that can be processed by each of the plurality of display apparatuses configuring the single display screen.

9. A display apparatus comprising:
a storage unit configured to store an assigned display region of image data for one frame in a storage medium;
an image data input unit configured to input a part of the image data for one frame and position identification information required to identify a position of the part of the image data for one frame from a display control apparatus;
a position determination unit configured to determine, based on the position identification information input by said image data input unit, whether or not the part of the image data for one frame input by said image data input unit is included in the assigned display region stored by said storage unit;
an image data acceptance unit configured to accept, when said position determination unit determines that the part of the image data for one frame input by said image data input unit is included in the assigned display region stored by said storage unit, the part of the image data for one frame input by said image data input unit; and
a display unit configured to display an image of the assigned display region using the part of the image data for one frame accepted by said image data acceptance unit.

10. The apparatus according to claim 9, wherein said image data input unit inputs, from the display control apparatus, the part of the image data for one frame generated by the display control apparatus, the position identification information required to identify the position of the part of the image data for one frame, and time information associated with processes of the part of the image data for one frame, and
said display unit displays the image of the assigned display region using the part of the image data for one frame accepted by said image data acceptance unit at a timing according to the time information.

11. The apparatus according to claim 9, further comprising:
a layout information input unit configured to input layout information associated with a layout of the image data for one frame from the display control apparatus; and
a layout change unit configured to change, based on the layout information input by said layout information input unit, a layout of the part of the image data for one frame accepted by said image data acceptance unit,
wherein said display unit displays the image of the assigned display region using the part of the image data for one frame, whose layout has been changed by said layout information change unit.

12. The apparatus according to claim 11, further comprising:
a region calculation unit configured to calculate an assigned display region of the image data for one frame using the layout information input by said layout information input unit; and
a region change unit configured to change the assigned display region stored by said storage unit to the assigned display region calculated by said region calculation unit,
wherein said position determination unit determines, based on the position identification information input by said image data input unit, whether or not the part of the image data for one frame input by said image data input unit is included in the assigned display region changed by said region change unit.

13. The apparatus according to claim 12, further comprising:
a layout information determination unit configured to determine whether or not the layout information input by said layout information input unit is layout information of the assigned display region stored by said storage unit; and
a layout information acceptance unit configured to accept, when said layout information determination unit determines that the layout information input by said layout information input unit is layout information of the assigned display region stored by said storage unit, the layout information input by said layout information input unit,
wherein said region calculation unit calculates the assigned display region of the image data for one frame using the layout information accepted by said layout information acceptance unit,
said layout information input unit inputs the layout information and layout position identification information required to identify a position of the image data whose layout has been changed based on the layout information,
said layout information determination unit determines, based on the layout position identification information, whether or not the layout information input by said layout information input unit is layout information of the assigned display region stored by said storage unit, and
when said layout information determination unit determines that the layout information input by said layout information input unit is layout information of the assigned display region stored by said storage unit, said layout information acceptance unit accepts the layout information input by said layout information input unit.

14. The apparatus according to claim 13, further comprising a discard unit configured to discard, when said layout information determination unit determines that the layout information input by said layout information input unit is not layout information of the assigned display region stored by said storage unit, the layout information input by said layout information input unit.

15. The apparatus according to claim 9, further comprising a discard unit configured to discard, when said position determination unit determines that the part of the image data for one frame input by said image data input unit is not included in the assigned display region stored by said storage unit, the part of the image data for one frame input by said image data input unit.

16. The apparatus according to claim 9, further comprising:
an instruction information input unit configured to input, from said display control apparatus, instruction information required to instruct contents of image processes to be applied to the part of the image data for one frame accepted by said image data acceptance unit; and
an image processing unit configured to apply the image processes of the part of the image data for one frame accepted by said image data acceptance unit based on the instruction information for the part of the image data for one frame,
wherein said display unit displays the image of the assigned display region by combining the part of the image data for one frame, which has undergone the image processes by said image processing unit.

17. The apparatus according to claim 16, further comprising:
a processing position determination unit configured to determine whether or not the image data to which the instruction information input by said instruction information input unit instructs to apply the image processes is included in the assigned display region stored in said storage unit; and
an instruction information acceptance unit configured to accept, when said processing position determination unit determines that the image data to which the instruction information input by said instruction information input unit instructs to apply the image processes is included in the assigned display region stored by said storage unit, the instruction information input by said instruction information input unit,
wherein said instruction information input unit inputs, from the display control apparatus, the instruction information and processing position identification information required to identify a position of the image data to which the instruction information instructs to apply the image processes, and
said processing position determination unit determines, based on the processing position identification information input by said instruction information input unit, whether or not the image data to which the instruction information instructs to apply the image processes is included in the assigned display region stored by said storage unit.

18. The apparatus according to claim 17, further comprising an instruction information discard unit configured to discard, when said processing position determination unit determines that the image data to which the instruction information instructs to apply the image processes is not included in the assigned display region stored by said storage unit, the instruction information input by said instruction information input unit.

19. The apparatus according to claim 16, further comprising:
a layout information input unit configured to input layout information associated with a layout of the image data for one frame from the display control apparatus; and
a region change unit configured to change, based on the layout information input by said layout information input unit, the assigned display region stored by said storage unit,
wherein said position determination unit determines based on the position identification information input by said image data input unit whether or not the part of the image data for one frame input by said image data input unit is included in the assigned display region changed by said region change unit, and
said display unit combines the part of the image data for one frame which have undergone the image processes by said image processing unit, changes a layout of the combined image data based on the layout information input by said layout information input unit, and displays the image of the assigned display region using the image data whose layout has been changed.

20. A display control method comprising the steps of:
dividing image data into a plurality of image data;
generating position identification information required to identify positions of the plurality of image data divided in the dividing step; and
transmitting, in association with each other, the image data divided in the dividing step and the position identification information generated in the position identification information generating step for the image data to each of a plurality of display apparatuses configuring a single display screen.

21. The method according to claim 20, further comprising the steps of:
generating instruction information required to instruct contents of image processes to be applied to the image data for each of the plurality of image data divided in the dividing step; and
transmitting the instruction information generated in the instruction information generating step to each of the plurality of display apparatuses.

22. A display processing method comprising the steps of:
storing an assigned display region of image data for one frame in a storage medium;
inputting a part of the image data for one frame and position identification information required to identify a position of the part of the image data for one frame from a display control apparatus;
determining, based on the position identification information input in the image data inputting step, whether or not the part of the image data for one frame input in the image data inputting step is included in the assigned display region stored in the storing step;
accepting, when it is determined in the position determining step that the part of the image data for one frame input in the image data inputting step is included in the assigned display region stored in the storing step, the part of the image data for one frame input in the image data inputting step; and
displaying an image of the assigned display region using the part of the image data for one frame accepted in the image data accepting step.

23. The method according to claim 22, further comprising the steps of:
inputting, from the display control apparatus, instruction information required to instruct contents of image processes to be applied to the part of the image data for one frame accepted in the image data accepting step; and
applying the image processes of the part of the image data for one frame accepted in the image data accepting step based on the instruction information for the part of the image data for one frame,
wherein the displaying step displays the image of the assigned display region by combining the part of the image data for one frame, which has undergone the image processes in the image processing step.
